(19) United States
(12) Patent Application Publication
(10) Pub. No.: US 2006/0223012 A1
(43) Pub. Date: Oct. 5, 2006

(54) Thermal processing method of silver salt photothermographic dry imaging material

(75) Inventor: Hideki Komatsu, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/388,427

(22) Filed: Mar. 24, 2006

(30) Foreign Application Priority Data
Mar. 30, 2005 (JP) JP2005-097713

(51) Int. Cl. G03C 5/16

(52) U.S. Cl. 430/348

(57) ABSTRACT

A thermal processing method of a photothermographic material comprising light-insensitive aliphatic carboxylic acid silver salt particles, light-sensitive silver halide grains, a reducing agent for silver ions and a binder is disclosed, comprising (a) exposing the photothermographic material, and (b) developing the exposed photothermographic material at a development temperature of at 110 to 150° C. to form an image, wherein the aliphatic carboxylic acid silver salt particles are comprised of 70 to 99 mol % of silver behenate and exhibit an average sphere equivalent diameter of 0.05 to 0.5 μm and a standard deviation of particle size of 0.3 μm or less, and the method further comprising (c) heating the photothermographic material at a temperature lower than the development temperature.

This application claims priority from Japanese Patent Application No. JP2005-097713, filed on Mar. 30, 2005, which is incorporated hereinto by reference.

### FIELD OF THE INVENTION

The present invention relates to a thermal processing method of a silver salt photothermographic dry imaging material (hereinafter, also denoted simply as silver salt photothermographic material of photothermographic material) comprising a light-insensitive organic silver salt, light-sensitive silver halide grains, a binder and a reducing agent for silver ions.

### BACKGROUND OF THE INVENTION

In the fields of medical diagnosis and graphic arts, there have been concerns in processing of photographic film with respect to effluent produced from wet-processing of image forming materials, and recently, reduction of the processing effluent has been strongly demanded in terms of environmental protection and space saving. Accordingly, thermally developable silver salt photothermographic dry imaging materials which can form images only upon heating were put into practical use and have rapidly spread in the foregoing fields.

Thermally developable silver salt photothermographic dry imaging materials (hereinafter, also denoted photothermographic dry imaging material or simply as photothermographic material) has been proposed over a long time, as disclosed, for example, in U.S. Pat. Nos. 3,152,904 and 3,457,075.

Photothermographic material is usually processed by a thermal-developing apparatus (also called a thermal processor) which stably heats the photothermographic material to form images. Along with this recent rapid spread, a large number of thermal-developing apparatuses have become available on the market. Further, a compact laser imager and shortening of processing time have been desired.

Accordingly, enhancement of characteristics of photothermographic materials are essential. To achieve sufficiently high densities of a photothermographic material even when subjected to rapid processing, it is effective to employ silver halide grains of a relatively small average grain size to increase the number of development initiating points, thereby enhancing covering power, as disclosed in JP-A Nos. 11-295844. and 11-352627 (hereinafter, the term, JP-A refers to Japanese Patent Application Publication), to use high-active reducing agents containing a secondary or tertiary alkyl group, as disclosed in JP-A No. 2001-209145 and to use development accelerators such as hydrazine compounds, vinyl compounds, phenol derivatives and naphthol derivatives, as disclosed in JP-A Nos. 2002-6443 and 2003-66558. These photothermographic materials generally contain an organic silver salt, light-sensitive silver halide grains and a reducing agent before and after being thermally developed, producing problems that fogging is easily caused during raw stock before being thermally processed. In order to achieve rapid access of photothermographic material, attempts to overcome the foregoing problems have been made so far, for instance, as disclosed in JP-A 6-208192 but have not reached a level sufficiently satisfying requirements on the market.

There was also disclosed a technique of performing thermal development with conveying at a rate of 23 mm/sec or more or concurrently with exposure, as a correspond to rapid access from the side of devices, as described in U.S. Patent Application Publication 2004/0058281 and JP-A No. 2004-85763.

### SUMMARY OF THE INVENTION

In view of the foregoing, the present invention has come into being. Thus, it is an object of this invention to provide a thermal processing method of a photothermographic material which is compatible between rapid processability and raw stock stability.

Thus, one aspect of the invention is directed to method of processing a photothermographic material comprising light-insensitive aliphatic carboxylic acid silver salt particles, light-sensitive silver halide grains, a reducing agent for silver ions and a binder, the method comprising the steps of (a) exposing the photothermographic material, and (b) developing the exposed photothermographic material at a development temperature of at 110 to 150° C. to form an image, wherein the aliphatic carboxylic acid silver salt particles are comprised of 70 to 99 mol % of silver behenate and exhibit an average sphere equivalent diameter of 0.05 to 0.5 μm and a standard deviation of particle size of 0.3 μm or less, and the method further comprising (c) heating the photothermographic material at a temperature lower than the development temperature.

In one preferred embodiment of the invention, the method comprises the steps of (a) exposing the photothermographic material, (b) developing the exposed photothermographic material at a development temperature of at 110 to 150° C. or more to form an image, and (c1) heating the exposed photothermographic material at a temperature of 70 to 100° C. immediately before step (b).

In one preferred embodiment of the invention, the method comprises the steps of (a) exposing the photothermographic material, (b) developing the exposed photothermographic material at a development temperature of at 110 to 150° C. or more to form an image, and (c2) heating the developed photothermographic material at a temperature lower than the development temperature by 10 to 20° C. immediately after step (b).

### BRIEF EXPLANATION OF THE DRAWINGS

FIG. 1 illustrates a side-view of the main portion of a thermal processing apparatus relating to the invention.

FIG. 2 illustrates a mixing apparatus relating to the invention.

FIG. 3 illustrates a mixing apparatus relating to the invention.

### DETAILED DESCRIPTION OF THE INVENTION

Light-insensitive aliphatic carboxylic acid silver salts (also called silver aliphatic carboxylates) usable in this invention are relatively stable to light but are capable of functioning as a silver ion supplier upon being heated at a temperature of more than 100° C. in the presence of light-sensitive silver halide grains and a reducing agent to form a silver image. The light-insensitive aliphatic carboxylic acid silver salts may be may be any aliphatic carboxylic acid salt capable of supplying silver ions which are reducible by a reducing agent. Aliphatic carboxylic acid silver salts are preferably long chain aliphatic carboxylic acid silver salts having 10 to 30) preferably 15 to 28) carbon atoms. Preferred examples of a long chain aliphatic carboxylic acid silver salt include silver lignocerate, silver behenate, silver arachidate, silver stearate, silver oleate, silver laurate, silver capronate, silver myristate, silver palmitate, and erucic acid silver salt. Aliphatic carboxylic acid silver salt used in this invention contains 70-99 mol % silver behenate, and preferably 80-90 mol % silver behenate. An aliphatic carboxylic acid silver salt preferably contains erucic acid silver salt at not more than 2 mol %, more preferably not more than 1 mol %, and still more preferably 0.1 mol %.

The average sphere equivalent diameter of light-insensitive aliphatic carboxylic acid silver salt particles is 0.05 to 0.5 μm, and preferably 0.10 to 0.5 μm. The particle size distribution thereof is preferably monodisperse. Monodispersibility (or degree of dispersion) can be represented by a standard deviation of average diameter. In one feature of the invention, the standard deviation of aliphatic carboxylic acid silver salt particles used in this invention is 0.3 or less and preferably 0.2 or less. The standard deviation is a barometer of particle size distribution, in combination with the average particle size. Two particle groups differing in average particle size are different in their value of standard deviation, even if the two particle groups are the same in particle size distribution. The standard deviation defined in the invention falls within a range less than that of the maximum of average particle size, i.e., 0.5 μm. Thus, a smaller average particle size leads to a less standard deviation.

The particle size and the particle size distribution can be determined by several conventional methods for measurement of particle size distribution, such as laser diffractometry, a centrifugal sedimentation light transmission method, an X-ray transmission method, an electric detector band method, a masking method, an ultrasonic attenuation spectroscopy and a method of calculation from images. Of these, laser diffractometry and the method of calculation from images are preferred for microparticles, and laser diffractometry is more preferred. Aliphatic carboxylic acid silver salt particles dispersed in liquid can be measured using a commercially available laser diffraction apparatus for particle size distribution determination.

Measurement of particle size and particle size distribution can be carried out as follows. Into a 100 ml beaker is placed 0.01 g of an aliphatic carboxylic acid silver salt particle sample. Further thereto, 0.1 g of a nonionic surfactant (NS-210, produced by Nippon Yushi Co., Ltd.) and 40 ml of water were added and dispersed at room temperature using an ultrasonic homogenizer to obtain a dispersion. The obtained dispersion is measured using a laser diffraction apparatus for particle size distribution measurement (SALD-2000, produced by Shimazu Seisakusho Co., Ltd.) to determine the average particle size and the standard deviation.

To prepare a dispersion of light-insensitive aliphatic carboxylic acid silver salt particles exhibiting an average sphere equivalent diameter of 0.05 to 0.5 μm and a standard deviation of sphere equivalent diameter, as afore-described, reaction is performed preferably by the following mixing method.

Aliphatic carboxylic acid silver salt particles of the invention are prepared preferably by allowing a silver ion-containing solution to react with a solution or suspension of an aliphatic carboxylic acid alkali metal salt. Such a silver ion-containing solution is preferably an aqueous silver nitrate solution and a solution (or suspension) of an aliphatic carboxylic acid alkali metal salt is preferably an aqueous solution or suspension thereof. Both solutions are mixed preferably by double-jet addition using a transfer means (e.g., pump) with controlling the flow rate of the respective solutions. The solutions may be added onto the surface or into the interior of the mother liquid. In the invention, however, mixing via a transfer means is preferred. Mixing in a transfer means signifies line mixing (or line blending). Thus, a silver ion containing solution and a solution or suspension of an aliphatic carboxylic acid alkali metal salt are mixed before being introduced into a batch for stocking a reaction mixture containing products. Any stirring means of the mixing section may be applicable, for example, mechanical stirring such as a homomixer, static mixer or a turbulent-flow mixing, but it is preferred not to use mechanical stirring. In the foregoing mixing in a transfer means, there may be mixed a third liquid, such as water or a reaction mixture stocked in the batch, in addition to a silver ion containing solution and a solution or suspension of an aliphatic carboxylic acid alkali metal salt.

The concentration of an aqueous silver nitrate solution is preferably 1 to 15% by weight and that of an aqueous solution or suspension of an aliphatic carboxylic acid alkali metal salt is preferably 1 to 5% by weight. A lower concentration than the foregoing lower limit results in deteriorated productivity and a higher concentration than the upper limit renders it difficult to control the particle size and the particle size distribution falling within the required region of this invention. The molar ratio of silver nitrate to an aliphatic carboxylic acid alkali metal salt is preferably 0.9 to 1.1. A molar ratio falling outside the foregoing region not only renders it difficult to control the particle size and the particle size distribution falling within the region required in this invention but also leads to a reduced yield of the aliphatic carboxylic acid silver salt or formation of silver oxide, causing fogging.

The thus prepared aliphatic carboxylic acid silver salt is preferably washed and then dried. Washing is performed mainly for the purpose of removing unreacted ions. Taking into account the subsequent drying stage, organic solvents may be used for washing. Washing is carried out preferably at a temperature of 50° C. or lower, and more preferably 30° C. or lower. Washing at a temperature higher than 50° C. renders it difficult to control the particle size and the particle size distribution falling within the region required in this invention. Drying is carried out preferably at a temperature lower than the phase transition temperature of an aliphatic carboxylic acid silver salt, and more preferably at a temperature of 50° C. or lower. Drying at a temperature higher than the phase transition temperature renders it difficult to control the particle size and the particle size distribution falling within the region required in this invention.

The aliphatic carboxylic acid silver salt of this invention is prepared preferably in the absence of light-sensitive silver halide grains. Preparation in the presence of light-sensitive silver halide renders it difficult to control the particle size and the particle size distribution falling within the region required in this invention, in compatibility with reduced fogging.

The aliphatic carboxylic acid silver salt may be used in any amount but the total silver amount of an aliphatic carboxylic acid silver salt and silver halide is preferably 0.8 to 1.5 g/m², and more preferably 1.0 to 1.3 g/m².

Alkali metal salts usable in this invention include, for example, sodium hydroxide, potassium hydroxide and lithium hydroxide. It is preferred to use a single alkali metal salt of these, for example, potassium hydroxide. The combined use of sodium hydroxide and potassium hydroxide is also preferred. The molar ratio of sodium hydroxide to potassium hydroxide is preferably in the range of 10:90 to 75:25. The foregoing range can suitably control the viscosity of a reaction mixture when reacted with an aliphatic carboxylic acid to form its alkali metal salt.

An emulsion containing aliphatic carboxylic acid silver salt particles according to the present invention is a mixture consisting of free aliphatic carboxylic acids which do not form silver salts, and aliphatic carboxylic acid silver salts. In view of storage stability of images, it is preferable that the ratio of the former is lower than the latter. Namely, the aforesaid emulsion according to the present intention preferably contains aliphatic carboxylic acids in an amount of 3 to 10 mol percent with respect to the aforesaid aliphatic carboxylic acid silver salt particles, and most preferably from 4 to 8 mol percent.

Incidentally, in practice, each of the amount of total aliphatic carboxylic acids and the amount of free aliphatic carboxylic acids is determined employing the methods described below. Whereby, the amount of aliphatic carboxylic acid silver salts and free aliphatic carboxylic acids, and each ratio, or the ratio of free carboxylic acids to total aliphatic carboxylic acids, are calculated.

Quantitative analysis of the amount of total aliphatic carboxylic acids (the total amount of these being due to both of the aforesaid aliphatic carboxylic acid silver salts and free acids is conducted according to the following procedure:
(1) A sample in an amount (the weight when peeled from a photosensitive material) of approximately 10 mg is accurately weighed and placed in a 200 ml eggplant type flask;
(2) Subsequently, 15 ml of methanol and 3 ml of 4 mol/L hydrochloric acid are added and the resulting mixture is subjected to ultrasonic dispersion for one minute;
(3) Boiling stones made of Teflon (registered trade name) are placed and refluxing is performed for 60 minutes;
(4) After cooling, 5 ml of methanol is added from the upper part of the cooling pipe and those adhered to the cooling pipe are washed into the ovoid flask (this is repeated twice);,
(5) The resulting liquid reaction composition is subjected to extraction employing ethyl acetate (separation extraction is performed twice by adding 100 ml of ethyl acetate and 70 ml of water);
(6) Vacuum drying is then performed at normal temperature for 30 minutes;
(7) Placed in a 10 ml measuring flask is 1 ml of a benzanthorone solution as an internal standard (approximately 100 mg of benzanthrone is dissolved in toluene and the total volume is made to 100 ml by the addition of toluene);
(8) The sample is dissolved in toluene and placed in the measuring flask described in (7) and the total volume is adjusted by the addition of toluene;
(9) Gas chromatography (GC) measurements are performed under the measurement conditions below.
Apparatus: HP-5890+HP-Chemistation

Column: HP-1 30 m×0.32 mm×0.25 μm

(manufactured by Hewlett-Packard)

Injection inlet: 250° C.

Detector: 280° C.

Oven: maintained at 250° C.

Carrier gas: He

Head pressure: 80 kPa

Quantitative analysis of free aliphatic carboxylic acids is conducted according to the following procedure:

(1) A sample in an amount of approximately 20 mg is accurately weighed and placed in a 200 ml ovoid flask. Subsequently, 100 ml of methanol was added and the resulting mixture is subjected to ultrasonic dispersion (free organic carboxylic acids are extracted);
(2) The resulting dispersion is filtered. The filtrate is placed in a 200 ml ovoid flask and then dried up (free organic carboxylic acids are separated);
(3) Subsequently, 15 ml of methanol and 3 ml of 4 mol/L hydrochloric acid are added and the resulting mixture is subjected to ultrasonic dispersion for one minute;
(4) Boiling stones made of Teflon (registered trade mark) were added, and refluxing is performed for 60 minutes;
(5) Added to the resulting liquid reaction composition are 60 ml of water and 60 ml of ethyl acetate, and a methyl-esterificated product of organic carboxylic acids is then extracted to an ethyl acetate phase. Ethyl acetate extraction is performed twice;
(6) The ethyl acetate phase is dried, followed by vacuum drying for 30 minutes;
(7) Placed in a 10 ml measuring flask is 1 ml of a benzanthorone solution (being an internal standard and prepared in such a manner that approximately 100 mg of benzanthrone is dissolved in toluene and the total volume is made to 100 ml by the addition of toluene);
(8) The product obtained in (6) is dissolved in toluene and placed in the measuring flask described in (7) and the total volume is adjusted by the addition of more toluene;
(9) GC measurement is carried out using the conditions described below.
   Apparatus: HP-5890+HP-Chemistation

Column: HP-1 30 m×0.32 mm×0.25 μm
(manufactured by Hewlett-Packard)

Injection inlet: 250° C.

Detector: 280° C.

Oven: maintained at 250° C.

Carrier gas: He

Head pressure: 80 kPa

Aliphatic carboxylic acid silver salts according to the invention may be crystalline grains which have the core/shell structure disclosed in European Patent No. 1168069A1 and also Japanese Patent Application Open to Public Inspection No. 2002-023303. Incidentally, when the core/shell structure is formed, organic silver salts, except for aliphatic carboxylic acid silver, such as silver salts of phthalic acid and benzimidazole may be employed wholly or partially in the core portion or in the shell portion as a constitution component of the aforesaid crystalline grains.

Aliphatic carboxylic acid silver salts usable in this invention may be in any form, such as a needle form, bar form, tabular form, or scale form. Specifically, aliphatic carboxylic acid silver salts which are in a scale form or in rectangular form exhibiting a ratio of a major axis to a minor axis of 5 or less, are preferred in the invention.

A scale-form aliphatic carboxylic acid silver salt is defined as follows. Observing aliphatic carboxylic acid silver salts by an electron microscope, an aliphatic carboxylic acid silver salt particle is approximated to be a rectangular parallelepiped having edges a, b and c in a shorter order (in which b and c may be equal to each other). “x” is defined as below:
x=b/a.
Approximately 200 random particles are measured with respect to x and when the average value thereof is designated as “x(mean)”, particles meeting the requirement of x(mean)≧1.5 are defined to be a scale form. The foregoing requirement is preferably 30≧x(mean)≧1.5, and more preferably 20≧x(mean)≧2.0. In the invention, the needle form is defined to be 1.5. x(mean)≧1.0.

In a scale-form particle, “a” is regarded as a thickness of a tabular grain with the major face comprised of edges “b” and “c”. The average of “a” is preferably not less than 0.01 μm and not more than 0.23 μm, and more preferably not less than 0.1 μm and not more than 0.20 μm. The average of c/b is preferably not less than 1 and not more than 6, more preferably not less than 1.05 and not-more than 4, still more preferably not less than 1.1 and not more than 2.

Aliphatic carboxylic acid silver salts according to the invention may be crystalline grains which have the core/shell structure disclosed in European Patent No. 1168069A1 and Japanese Patent Application Open to Public Inspection No. 2002-023303. Incidentally, when the core/shell structure is formed, organic silver salts, except for aliphatic carboxylic acid silver, such as silver salts of phthalic acid and benzimidazole may be employed wholly or partly in the core portion or the shell portion as a constitution component of the aforesaid crystalline grains.

It is preferable that, if desired, the planar aliphatic carboxylic acid silver salt particles are preliminarily dispersed together with binders as well as surface active agents, and thereafter, the resultant mixture is dispersed employing a media homogenizer or a high pressure homogenizer. The preliminary dispersion may be carried out employing a common anchor type or propeller type stirrer, a high-speed rotation centrifugal radial type stirrer (being a dissolver), and a high-speed rotation shearing type stirrer (being a homomixer).

Further, employed as the aforesaid media homogenizers may be rotation mills such as a ball mill, a planet ball mill, and a vibration ball mill, media stirring mills such as a bead mill and an attritor, and still others such as a basket mill. Employed as high pressure homogenizers may be various types such as a type in which collision against walls and plugs occurs, a type in which a liquid is divided into a plurality of portions which are collided with each other at high speed, and a type in which a liquid is passed through narrow orifices.

Preferably employed as ceramics, which are used in ceramic beads employed during media dispersion are, for example, yttrium-stabilized zirconia, and zirconia-reinforced alumina (hereafter ceramics containing zirconia are abbreviated to as zirconia). The reason of the preference is that impurity formation due to friction with beads as well as the homogenizer during dispersion is minimized.

In apparatuses which are employed to disperse the planar aliphatic carboxylic acid silver salt particles of the present invention, preferably employed as materials of the members which come into contact with the aliphatic carboxylic acid silver salt particles are ceramics such as zirconia, alumina, silicon nitride, and boron nitride, or diamond. Of these, zirconia is preferably employed. During the dispersion, the concentration of added binders is preferably from 0.1 to 10.0 percent by weight with respect to the weight of aliphatic carboxylic acid silver salts. Further, temperature of the dispersion during the preliminary and main dispersion is preferably maintained at less than or equal to 45° C. The examples of the preferable operation conditions for the main dispersion are as follows. When a high-pressure homogenizer is employed as a dispersion means, preferable operation conditions are from 29 to 100 MPa, and at least double operation frequency. Further, when the media homogenizer is employed as a dispersion means, the peripheral rate of 6 to 13 m/second is cited as the preferable condition.

In the present invention, light-insensitive aliphatic carboxylic acid silver salt particles are preferably formed in the presence of compounds which function as a crystal growth retarding agent or a dispersing agent. Further, the compounds which function as a crystal growth retarding agent or a dispersing agent are preferably organic compounds having a hydroxyl group or a carboxyl group.

In the present invention, compounds, which are described herein as crystal growth retarding agents or dispersing agents for aliphatic carboxylic acid silver salt particles, refer to compounds which, in the production process of aliphatic carboxylic acid silver salts, exhibit more functions and greater effects to decrease the grain diameter, and to enhance monodispersibility when the aliphatic carboxylic acid silver salts are prepared in the presence of the compounds, compared to the case in which the compounds are not employed. Listed as examples are monohydric alcohols having 10 or fewer carbon atoms, such as preferably secondary alcohol and tertiary alcohol; glycols such as ethylene glycol and propylene glycol; polyethers such as polyethylene glycol; and glycerin. The preferable addition amount is from 10 to 200 percent by weight with respect to aliphatic carboxylic acid silver salts.

On the other hands, preferred are branched aliphatic carboxylic acids, each containing an isomer, such as isoheptanic acid, isodecanoic acid, isotridecanoic acid, isomyristic acid, isopalmitic acid, isostearic acid, isoarachidinic acid, isobehenic acid, or isohexaconic acid. Preferable side chains include an alkyl group and an alkenyl group having 4 or fewer carbon atoms. Further, there are included aliphatic unsaturated carboxylic acids such as palmitoleic acid, oleic acid, linoleic acid, linolenic acid, moroctic acid, eicosenoic acid, arachidonic acid, eicosapentaenoic acid, erucic acid, docosapentaenoic acid, and selacholeic acid. The preferable addition amount is from 0.5 to 10.0 mol percent of aliphatic carboxylic acid silver salts.

Preferable compounds include glycosides such as glucoside, galactoside, and fructoside; trehalose type disaccharides such as trehalose and sucrose; polysaccharides such as glycogen, dextrin, dextran, and alginic acid; cellosolves such as methyl cellosolve and ethyl cellosolve; water-soluble organic solvents such as sorbitan, sorbitol, ethyl acetate, methyl acetate, and dimethylformamide; and water-soluble polymers such as polyvinyl alcohol, polyacrylic acid, acrylic acid copolymers, maleic acid copolymers, carboxymethyl cellulose, hydroxypropyl cellulose, hydroxypropyl methyl cellulose, polyvinylpyrrolidone, and gelatin. The preferable addition amount is from 0.1 to 20.0 percent by weight with respect to aliphatic carboxylic acid silver salts.

Alcohols having 10 or fewer carbon atoms, being preferably secondary alcohols and tertiary alcohols, increase the solubility of sodium aliphatic carboxylates in the emulsion preparation process, whereby the viscosity is lowered so as to enhance the stirring efficiency and to enhance monodispersibility as well as to decrease particle size. Branched aliphatic carboxylic acids, as well as aliphatic unsaturated carboxylic acids, result in higher steric hindrance than straight chain aliphatic carboxylic acid silver salts as a main component during crystallization of aliphatic carboxylic acid silver salts to increase the distortion of crystal lattices whereby the particle size decreases due to non-formation of over-sized crystals.

In one embodiment of the invention, a photothermographic thermographic material is imagewise exposed and thermally developed to form an image by heating the exposed photothermographic material at a desired temperature using a thermal processor. The thermally development temperature is preferably 110 to 150° C., and more preferably 115 to 135° C. A heating temperature of less than 80° C. cannot obtain a sufficient image density. A higher temperature (specifically, more than 200° C.) often causes transfer onto rollers due to melting of the binder, adversely affecting transferability or the processor. Heating promotes the oxidation reduction reaction between an aliphatic carboxylic acid silver salt (functioning as an oxidizing agent) and a reducing agent to form a silver image. This reaction proceeds without supplying a processing solution such as water from the exterior.

There are usable any heating means, for instance, contact heating with a heating drum or a heating plate, or non-contact heating such as radiation, but contact heating with a heating plate is preferred. The heated surface may be the light-sensitive layer side or the light-insensitive layer side (that is opposite the light-sensitive layer) but is preferably the light-insensitive side in terms of stability to a processing environment. The developing section is preferably composed of a combination of a plurality of independently temperature-controlled zones and plural means, and more preferably having a temperature-retaining zone maintaining a specific development temperature. In a thermal developing apparatus preferably used in the invention, a temperature-raising section and a temperature-retaining section can independently constitute the thermal development process. In the temperature-raising section, a heating means such as a heating member is brought into close contact with a photothermographic sheet film to prevent occurrence of unevenness in density and the temperature-raising section does not need to perform such close contact. Accordingly, the temperature-raising section and the temperature-retaining section can each independently employ an appropriate heating system, thereby achieving more rapid access, a compact apparatus and lowering the cost of the thermal development process, while maintaining high image quality without causing unevenness in density.

In the thermal developing apparatus, the temperature-raising section performs heating, while compressing the photothermographic sheet film onto a plate heater by an opposed roller to bring into contact with the plate heater and the temperature-retaining section heats the sheet film within a slit formed between guides having a heater on at least one side thereof. While compression of a photothermographic sheet film onto a plate heater by an opposed roller can achieve close contact of the sheet film with the plate, the temperature-retaining section can convey the sheet film by conveying force of the opposed roller of the temperature-raising section with heating within the slit, which needs no driving part of a conveying system and requires no high accuracy in slit size, rendering it feasible to achieve a compact apparatus and lowering the cost.

The thermal developing apparatus performs heating-up the sheet film in the first zone while securing close contact of a heating means such as a heating member with the sheet film to prevent unevenness of density, and performs temperature-retaining between guides in a second zone, thereby becoming feasible to achieve rapid access of the thermal development process, a compact apparatus and lowering the cost, while maintaining high image quality without causing uneven density. A clearance between guide surfaces of not more than 3 mm has little influence on temperature-retaining performance in the second zone irrespective of the conveying attitude of the sheet film and requires no high accuracy for arrangement of fixed guides or other guides, increasing allowance for curvature error in manufacturing both guides or also installation accuracy thereof, resulting in an increased degree of freedom in design and leading to lowering the cost.

In the thermal developing apparatus, the clearance between guides in the second zone is preferably 1 to 3 mm. A clearance of at least 1 mm makes it difficult for the coating side of the photothermographic material to be in contact with the guide surface, leading to reduced occurrence of abrasion marks.

The curvature of the fixed guide in the second zone preferably is approximately the same as that of the other guide. Allowing the guides of the second zone to have a curvature can constitute a guide having nearly constant guide clearance.

The sheet film can engage in the temperature-raising section and the temperature-retaining section within 10 sec., enabling shortening of the period over the temperature-raising step and the temperature-retaining step, leading to more rapid access of thermal development.

There may be provided a recess between the temperature-raising section and the temperature-retaining section so as to allow any foreign matter coming out of the temperature-raising section to enter the recess, preventing the foreign matter from being carried in the temperature-retaining section, reducing minimized jamming, abrasion and unevenness of density.

The mechanism of the temperature-retaining zone may only be a function of maintaining the temperature of the heated film and is not limited to the foregoing. The thermal developing time is preferably 5 to 10 sec.

In one preferred embodiment of the invention, a photothermographic material is heated at a temperature of 70 to 100° C. (preferably 90 to 100° C.) immediately before the step of developing the photothermographic material at a prescribed development temperature. The precision of heating temperature is preferably ±1° C., and more preferably ±0.5° C. The heating time, the optimum value of which depends on the preheating mechanism, is preferably 0.5 to 7 sec, and more preferably 1 to 3 sec. In one of the preferred embodiments of the invention, a photothermographic material is processed by a processing machine having a pre-heating zone to heat exposed photothermographic material at a temperature of 70 to 100° C. (preferably 90 to 100° C.) prior to the thermal developing step of heating at a desired development temperature. The heating mechanism of the preheating zone is not specifically limited but preferably is a contact-heating with a heating plate. The precision of the heating temperature of the pre-heating zone is preferably ±1° C., and more preferably ±0.5° C. The pre-heating time, optimum value of which depends on the preheating mechanism, is preferably 0.5 to 7 sec, and more preferably 1 to 3 sec.

In one preferred embodiment of the invention, a photothermographic material is imagewise exposed, thermally developed at a prescribed development temperature to form an image and then kept at a temperature lower than the development temperature by 10 to 20° C. (preferably 10 to 15° C.) to stop development over a period of at least 0.25 (preferably 0.25 to 1.0) times the development time. The precision of cooling temperature in the slow-cooling zone is preferably ±1° C., and more preferably +0.5° C. A photothermographic material is processed by a processing machine having a slow-cooling zone immediately after the step of thermal development. The slow-cooling mechanism in the slow-cooling zone is not specifically limited but preferably is a contact-cooling with a plate adjusted to a desired temperature.

A laser imager (thermal development apparatus) relating to this invention is composed of a film supplying unit section, a laser image recording unit section, a thermal-developing unit section for providing heat homogeneously and stably to the whole surface of a photothermographic material, and a transporting unit section for conveying the photothermographic material from the film supplying unit section, via laser recording and thermal developing, till discharging the photothermographic material having formed images.

Exposure used in the photothermographic material or the image forming method of this invention can employ various conditions with respect to a light source, exposure time and the like suitable for obtaining an intended appropriate images.

The silver salt photothermographic material of the present invention is preferably exposed using laser light to perform image recording. It is preferable to employ an optimal light source for the spectral sensitivity provided to the aforesaid photosensitive material. For example, when the aforesaid photosensitive material is sensitive to infrared radiation, it is possible to use any radiation source which emits radiation in the infrared region. However, infrared semiconductor lasers (at 780 nm and 820 nm) are preferably employed due to their high power, as well as ability to make photosensitive materials transparent.

The photothermographic material exhibits its characteristics when exposed to high illumination intensity light at an amount of at least 1 mW/mm² for a short period of time. The illumination intensity refers to one which gives an optical density of 3.0. When exposed tat a high intensity, an intended density can be obtained at a less mount of light i.e., (intensity)×(exposure time), whereby a high-speed system can be designed. The amount of light is preferably 2 mW/mm² to 50 W/mm², and more preferably 10 mW/mm² to 50 W/mm². Any light source meeting the foregoing is usable in this invention but laser light is preferred. Examples of preferred laser light include a gas laser (Ar⁺, Kr⁺, He—Ne), YAG laser, dye laser, and a semiconductor laser. There are also usable semiconductor lasers exhibiting emission in the region of blue to violet (for example, exhibiting a peak intensity at a wavelength of 350 to 440 nm). NLH3000E semiconductor laser, available from Nichia Kagaku Co., Ltd., is cited as a high power semiconductor laser.

In the present invention, it is preferable that exposure is carried out utilizing laser scanning. Employed as the exposure methods are various ones. For example, listed as a preferable method is the method utilizing a laser scanning exposure apparatus in which the angle between the scanning surface of a photosensitive material and the scanning laser beam does not substantially become vertical. “Does not substantially become vertical”, as described herein, means that during laser scanning, the nearest vertical angle is preferably from 55 to 88 degrees, is more preferably from 60 to 86 degrees, and is most preferably from 70 to 82 degrees.

When the laser beam scans photosensitive materials, the beam spot diameter on the exposed surface of the photosensitive material is preferably at most 200 μm, and is more preferably at most 100 mm, and is more preferably at most 100 μm. It is preferable to decrease the spot diameter due to the fact that it is possible to decrease the deviated angle from the verticality of laser beam incident angle. Incidentally, the lower limit of the laser beam spot diameter is 10 μm. By performing the laser beam scanning exposure, it is possible to minimize degradation of image quality according to reflection light such as generation of unevenness analogous to interference fringes.

Further, as the second method, exposure in the present invention is also preferably carried out employing a laser scanning exposure apparatus which generates a scanning laser beam in a longitudinal multiple mode, which minimizes degradation of image quality such as generation of unevenness analogous to interference fringes, compared to the scanning laser beam in a longitudinal single mode. The longitudinal multiple mode is achieved utilizing methods in which return light due to integrated wave is employed, or high frequency superposition is applied. The longitudinal multiple mode, as described herein, means that the wavelength of radiation employed for exposure is not single. The wavelength distribution of the radiation is commonly at least 5 nm, and is preferably at least 10 nm. The upper limit of the wavelength of the radiation is not particularly limited, but is commonly about 60 nm.

In the third preferred embodiment of the invention, it is preferred to form images by scanning exposure using at least two laser beams. The image recording method using such plural laser beams is a technique used in image-writing means of a laser printer or a digital copying machine for writing images with plural lines in a single scanning to meet requirements for higher definition and higher speed, as described in JP-A 60-166916. This is a method in which laser light emitted from a light source unit is deflection-scanned with a polygon mirror and an image is formed on the photoreceptor through an fθ lens, and a laser scanning optical apparatus similar in principle to an laser imager.

In the image-writing means of laser printers and digital copying machines, image formation with laser light on the photoreceptor is conducted in such a manner that displacing one line from the image forming position of the first laser light, the second laser light forms an image from the desire of writing images with plural lines in a single scanning. Concretely, two laser light beams are close to each other at a spacing of an order of some ten μm in the sub-scanning direction on the image surface; and the pitch of the two beams in the sub-scanning direction is 63.5 μm at a printing density of 400 dpi and 42.3 μm at 600 dpi (in which the printing density is represented by “dpi”, i.e., the number of dots per inch). As is distinct from such a method of displacing one resolution in the sub-scanning direction, one feature of the invention is that at least two laser beams are converged on the exposed surface at different incident angles to form images. In this case, when exposed with N laser beams, the following requirement is preferably met: when the exposure energy of a single laser beam (of a wavelength of λ nm) is represented by E, writing with N laser beam preferably meets the following requirement:
0.9×E≦En×N≦1.1×E
in which E is the exposure energy of a laser beam of a wavelength of λ nm on the exposed surface when the laser beam is singly exposed, and N laser beams each are assumed to have an identical wavelength and an identical exposure energy (En). Thereby, the exposure energy on the exposed surface can be obtained and reflection of each laser light onto the image forming layer is reduced, minimizing occurrence of an interference fringe.

In the foregoing, plural laser beams having a single wavelength are employed but lasers having different wavelengths may also be employed. In such a case, the wavelengths preferably fall within the following range:
(λ−30)<λ₁, λ₂, . . . λₙ<(λ+30).

In the first, second and third preferred embodiments of the image recording method of the invention, lasers for scanning exposure used in the invention include, for example, solid-state lasers such as ruby laser, YAG laser, and glass laser; gas lasers such as He—Ne laser, Ar laser, Kr ion laser, CO₂ laser, Co laser, He—Cd laser, N₂ laser and eximer laser; semiconductor lasers such as InGa laser, AlGaAs laser, GaAsP laser, InGaAs laser, InAsP laser, CdSnP₂ laser, and GSb laser; chemical lasers; and dye lasers. Of these, semiconductor lasers of wavelengths of 600 to 1200 nm are preferred in terms of maintenance and the size of the light source. When exposed onto the photothermographic imaging material in the laser imager or laser image-setter, the beam spot diameter on the exposed surface is 5 to 75 μm as a minor axis diameter and 5 to 100 μm as a major axis diameter. The laser scanning speed is set optimally for each photothermographic material, according to its sensitivity at the laser oscillation wavelength and the laser power.

From the view of rapid access, it is necessary to respond to the embodiment of performing exposure and thermal development concurrently. The distance between an exposure section and a thermal-developing section is preferably within a range from 0 to 50 cm to perform thermal development concurrently with exposure, i.e., to start development of an exposed portion of a sheet while simultaneously exposing an unexposed portion of the sheet. Thereby, the processing time for exposure and development is extremely reduced. The distance is more preferably 3 to 40 cm, and still more preferably 5 to 30 cm. The exposure section refers to the region in which light from a light source exposes a photothermographic material, and the thermal developing section refers to a region in which a photothermographic material is heated to perform thermal development.

The rate of conveying a photothermographic material in the thermal developing section is preferably 20 to 200 mm/sec, and more preferably 30 to 150 mm/sec. A conveying rate falling within the foregoing range can improve unevenness of density and shorten the processing time, enabling to respond to urgent diagnosis.

There will be described preferred embodiments of a thermal development apparatus used in the invention, based on drawings.

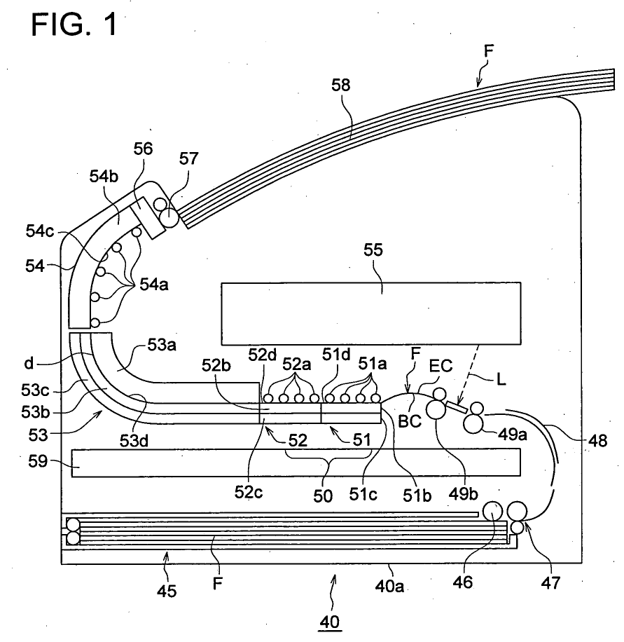

FIG. 1 is a side-view illustrating the main part of a thermal development apparatus according to one preferred embodiment. In thermal development apparatus 40, as shown in FIG. 1, film F comprising a EC-face having a photothermographic material coating on one side of a sheet support comprised of PET or the like and a BC-face on the side opposite the EC-face is exposed to laser light from light scanning exposure section 55 to form a latent image, while conveyed in the sub-scanning direction. Subsequently, the film F is heated from the BC-face side to develop the latent image to form a visible image, then, conveyed through a transport route having a curvature to the upper portion of the apparatus and discharged.

As shown in FIG. 1, the thermal development apparatus 40 is provided with film enclosure section 45 enclosing unexposed film (F) stock, installed near the bottom of apparatus frame 40a, pickup roller 46 to pick up the uppermost sheet of film F in the film enclosure section 45, paired transport rollers 47 to convey the film F from the pickup roller 46, to curved guide 48 which is arranged in a curved form so as to guide the film F conveyed by the transport roller 47 and to convey the film F in a nearly reversed direction, paired transport rollerss 49a and 49b to convey the film F from the curved guide 48, and light scanning exposure section 55 to expose laser light L by light-scanning onto the film F, based on image data, between paired transport rollerss 49a and 49b to form a latent image on the EC face.

The thermal development apparatus 40 is further provided with temperature-raising section 50 to raise the temperature of the exposed film F having formed a latent image to a prescribed development temperature by heating the film from the BC-face size, temperature-retaining section 53 to heat the heated film F to maintain the film F at a prescribed temperature, cooling section 54 to cool the heated film F from the BC-face side, densitometer 56 arranged in the exit side of the cooling section 54 to measure the density of the film, paired transport rollers 57 to discharge the film from the densitometer, and film storage section 58 to stack the film F discharged by the paired transport rollers 57 and installed on upper surface of the apparatus frame with being inclined upward.

In thermal development apparatus 40, as shown in FIG. 1, the film enclosure section 45, base plate section 59, the paired transport rollers 49a and 49b, the temperature-raising section 50 and the temperature-retaining section 53, are arranged in the order from the bottom of the apparatus frame 40a to the above, and the film enclosure section 45 is not subject to heating influence heating since it is located lowermost and has the base plate section 59 intervened under the temperature-raising section 50 and temperature-retaining section 53, is not subject to heating influence heating.

The transport route from the paired transport rollers 49a and 49b to the temperature-raising section 50 is arranged to be relatively short so that the top portion of a sheet of the film F is already thermally developed in the temperature-raising section 50 and the temperature-retaining section 53, while the end portion of the sheet of the film F is exposed by the light-scanning exposure section 55.

The temperature-raising section 50 and the temperature-retaining section 53 constitute a heating section, where the film F is heated to a thermal development temperature and maintained at the thermal development temperature. The temperature-raising section 50 is comprised of upstream first heating zone 51 to heat the film F and downstream second heating zone 52 to heat the film F.

The first heating zone 51 is composed of fixed planar heating guide 51b of metallic material such aluminum, planar heater 51c of silicone rubber heater or the like, tightly attached to the back face of the heating guide 51b, and plural opposed rollers 51a which are arranged so that a narrower clearance than the film thickness is kept to compress the film onto fixed guide surface 51d and the surface of which is formed of silicone rubber exhibiting a high heat-insulating capability as compared to metals or the like.

The first heating zone 52 is structured of fixed planar heating guide 52b and composed of metallic material such aluminum, while planar heater 52c composed of silicone rubber heater or the like, tightly attached to the back face of the heating guide 52b, and plural opposed rollers 52a which are arranged so that a clearance narrower than the film thickness is maintained to press the film onto fixed guide surface 52d and the surface of which is formed of silicone rubber exhibiting a higher heat-insulating capability as compared to metals or the like.

The temperature-retaining section 53 is structured of fixed planar heating guide 53b and composed of metallic material such aluminum, planar heater 53c composed of silicone rubber heater or the like, tightly attached to the back face of the heating guide 52b, and guide section 53a which is arranged facing fixed guide surface 53d constituted on the surface of the heating guide 53b with holding a prescribed clearance (slit) d and which is formed of a heat-insulating material. The heat-retaining section 53, in which a portion of the side of the temperature-raising section 50 is planarily arranged after the second heating zone 52, upward curves in the middle thereof at a prescribed curvature.

In the first heating zone 51 of the temperature-raising section 50, the film F which is conveyed by paired transport rollers 49a and 49b from upstream of the temperature-raising section 50, is conveyed, while heated on the BC-face (denoted as BC) being pressed onto the guide face 51d by driven opposed rollers 51a so as to be in close contact with the fixed guide surface 51d.

Similarly, in the second heating zone 52, the film F conveyed from the first heating zone 51 is conveyed, while heated on the BC-face being compressed onto the fixed guide face 51d by opposed rollers 52 a so as to be in close contact with the fixed guide surface 51d.

A recess, opening upward in a V-form may be provided between the second heating zone 52 of the temperature-raising section 50 and the temperature-retaining section 53. Foreign matter carried out of the temperature-raising section 50 can fall down into the interior of the recess, and thereby prevent the foreign matter from being carried in the temperature-retaining section 53.

In the temperature-retaining section 53, the film F conveyed from the second heating zone passes through clearance d between the fixed guide surface 53d and the guide section 53a by the conveying force of the opposed roller 52a on the side of the second heating zone 52, while heated (or temperature-maintained) in the clearance d by heat from the heating guide 53b. The film F is conveyed toward the cooling section 54, while gradually turned from the horizontal direction to the vertical direction.

In the cooling section 54, the film F vertically conveyed from the temperature-retaining section 53 is conveyed toward the film accumulation section 58, while cooled by bringing the film F into contact with the cooling guide surface 54c of the cooling plate 54b formed of a metallic material by the opposed roller 54a and turning the direction of the film from the vertical direction to an oblique. Cooling effects can be promoted by modifying the cooling plate 54b by a finned heat sink structure. A part of the cooling plate 54b may be modified by a finned heat sink structure.

The cooled film F conveyed from the cooling section is then subjected to densitometry by densitometer 56, conveyed by the paired transport rollers 57 and discharged onto the film storage section 58. The film storage section 58 can temporarily stack plural sheets of the film F.

In the thermal development apparatus 40 shown in FIG. 1, the film F is conveyed through the temperature-raising section 50 and the temperature-retaining section 53, while the BC-face faces the fixed guide surfaces 51d, 52d and 53d and the EC-face coated with photothermographic material is opened.

The film F is conveyed by opposed rollers 51a and 52a so as to pass through the temperature-raising section 50 and the temperature-retaining section 53 within 10 sec. Accordingly, the heating duration over the temperature-raising section and the temperature-retaining section is to be 10 sec. or less.

The film F is conveyed in the temperature-raising section 50 requiring uniform heat-transfer of the thermal development apparatus 40, as shown in FIG. 1, while securing contact heat-transfer by bringing t he film F into direct contact with the fixed guide surface 51d and 52d by the heating guide 51b and 52b, and plural opposed rollers 51a and 52a to press the film onto the heating guides 51b and 52b. Thereby, the film sheet is uniformly heated overall, resulting in homogeneous temperature-rise, leading to a finished film of high image quality without unevenness in density.

After heating to a thermal development temperature, the film is conveyed into clearance d between the fixed guide surface 53d of the heating guide 53b and the guide section 53a. Even if heated in the clearance d without being in contact with the fixed guide surface 53d (heat-transfer by direct contact with the fixed guide surface 53d and/or heat-transfer due to contact with surrounding hot air), the film temperature falls within the range (e.g., ±0.5° C.) of the thermal development temperature (e.g., 123° C.). Thus, even when the film sheet is conveyed within the clearance d along the surface of the heating guide 53d or the surface of the curved guide 53a. the difference in temperature is less than 0.5° C. and uniform temperature-retaining is maintained, causing no unevenness of density in the finished film. The temperature-retaining section 53 requires no driving part such as a roller i, realizing reduction of the number of parts of the apparatus.

As stated before, heating the film F is completed within 10 sec., achieving rapid thermal processing. The temperature-retaining section which extends horizontally from the temperature-raising section, is curved and becomes vertical on the way, and the film F almost reverses its direction in the cooling section 54 and is discharged to the film storage section 58. Thus, a compact apparatus and reduced setting area for the apparatus can be achieved by allowing the cooling section 54 to have a prescribed curvature in accordance with the layout of the apparatus.

In conventional large-side processing machine, a heating and transport mechanism is provided even in a section after having the film temperature raised to the development temperature, which is sufficient for a temperature-retaining function, resulting in unnecessary members, leading to an increase of the number of parts and cost. On the other hand, conventional compact machines cannot secure sufficient heat transfer, causing uneven density and making it difficult to attain the desired high image quality. On the contrary, in one preferred embodiment of the invention, the thermal development process is divided into the temperature-raising section 50 and the temperature-retaining section 53, each of which is performed separately, so that the foregoing problems can be overcome.

In the temperature-raising section 50, and the temperature-retaining section 53, the film F is heated on the BC-side, while the EC-side having coated with photothermographic material being opened. When thermal development is rapidly performed within 10 sec., volatile solvents contained in the film F (such as water or organic solvents) vaporizes from the opened EC-side, so that even when the heating time is shortened, little is subjected to such shortened time. Even when contact of the film F with the fixed guide surface 51d or 52d is somewhat insufficient, any difference in temperature from the portion having surface contact is mitigated, resulting in a reduced temperature difference, leading to stable image quality as well as stable density. Heating from the EC-side was considered to be better in terms of heating efficiency. However, taking into account that the thermal conductivity of a PET used as a support of the film F I 0.17 W/m·° C. and the thickness of the PET is approximately 170 μm, the time lag is small and can easily be compensated, for instance, by an increase of heater capacity. Mitigation of the foregoing uneven contact is thereby expected to be more effective.

Solvents (water, organic solvent) contained in the film F also vaporize in the course of from coming out of the temperature-retaining section 53 to reaching the cooling section 54 which is still maintained at a relatively high temperature. Since the EC-side is in the opened state even in the cooling section 54, the solvents vaporize, leading to stabilized image quality. Thus, the cooling time cannot be ignored in rapid processing process and is effective specifically for a rapid process including a heating time of 10 sec. or less.

In the following, there will be described silver halide relating to the invention (hereinafter, also denoted as light-sensitive silver halide grains or simply as silver halide grains). Light-sensitive silver halide grains used in this invention are those which are capable of absorbing light as an inherent property of silver halide crystal or capable of absorbing visible or infrared light by artificial physico-chemical methods, and which are treated or prepared so as to cause a physico-chemical change in the interior and/or on the surface of the silver halide crystal upon absorbing light within the region of ultraviolet to infrared.

The silver halide grains used in the invention can be prepared according to conventionally known methods. Any one of acidic precipitation, neutral precipitation and ammoniacal precipitation is applicable and the reaction mode of aqueous soluble silver salt and halide salt includes single jet addition, double jet addition and a combination thereof. Specifically, preparation of silver halide grains with controlling the grain formation condition, so-called controlled double-jet precipitation is preferred.

The grain forming process is usually classified into two stages of formation of silver halide seed crystal grains (nucleation) and grain growth. These stages-may continuously be conducted, or the nucleation (seed grain formation) and grain growth may be separately performed. The controlled double-jet precipitation, in which grain formation is undergone with controlling grain forming conditions such as pAg and pH, is preferred to control the grain form or grain size. In cases when nucleation and grain growth are separately conducted, for example, a soluble silver salt and a soluble halide salt are homogeneously and promptly mixed in an aqueous gelatin solution to form nucleus grains (seed grains), thereafter, grain growth is performed by supplying soluble silver and halide salts, while being controlled at a pAg and pH to prepare silver halide grains. After completion of grain formation, soluble salts are removed in the desalting stage, using commonly known desalting methods such as the noodle method, flocculation method, ultrafiltration method and electrodialysis method.

Silver halide grains are preferably monodisperse grains with respect to grain size. The monodisperse grains as described herein refer to grains having a coefficient of variation of grain size obtained by the formula described below of not more than 30%; more preferably not more than 20%, and still more preferably not more than 15%:

Coefficient of variation of grain size=standard deviation of grain diameter/average grain diameter×100(%)

The grain form can be of almost any one, including cubic, octahedral or tetradecahedral grains, tabular grains, spherical grains, bar-like grains, and potato-shaped grains. Of these, cubic grains, octahedral grains, tetradecahedral grains and tabular grains are specifically preferred.

The aspect ratio of tabular grains is preferably 1.5 to 100, and more preferably 2 to 50. These grains are described in U.S. Pat. Nos. 5,264,337, 5,314,798 and 5,320,958 and desired tabular grains can be readily obtained. Silver halide grains having rounded corners are also preferably employed.

Crystal habit of the outer surface of the silver halide grains is not specifically limited, but in cases when using a spectral sensitizing dye exhibiting crystal habit (face) selectivity in the adsorption reaction of the sensitizing dye onto the silver halide grain surface, it is preferred to use silver halide grains having a relatively high proportion of the crystal habit meeting the selectivity. In cases when using a sensitizing dye selectively adsorbing onto the crystal face of a Miller index of [100], for example, a high ratio accounted for by a Miller index [100] face is preferred. This ratio is preferably at least 50%; is more preferably at least 70%, and is most preferably at least 80%. The ratio accounted for by the Miller index [100] face can be obtained based on T. Tani, J. Imaging Sci., 29, 165 (1985) in which adsorption dependency of a [111] face or a [100] face is utilized.

It is preferred to use low molecular gelatin having an average molecular weight of not more than 50,000 in the preparation of silver halide grains used in the invention, specifically, in the stage of nucleation. Thus, the low molecular gelatin has an average molecular eight of not more than 50,000, preferably 2,000 to 40,000, and more preferably 5,000 to 25,000. The average molecular weight can be determined by means of gel permeation chromatography. The low molecular weight gelatin can be obtained by adding an enzyme to conventionally used gelatin having a molecular weight of ca. 100,000 to perform enzymatic degradation, by adding acid or alkali with heating to perform hydrolysis, by heating under atmospheric pressure or under high pressure to perform thermal degradation, or by exposure to ultrasonic.

The concentration of dispersion medium used in the nucleation stage is preferably not more than 5% by weight, and more preferably 0.05 to 3.0% by weight.

In the preparation of silver halide grains, it is preferred to use a compound represent by the following formula, specifically in the nucleation stage:
YO(CH₂CH₂O)ₘ(C(CH₃)CH₂O)ₚ(CH₂CH₂O)ₙY
where Y is a hydrogen atom, —SO₃M or —CO—B—COOM, in which M is a hydrogen atom, alkali metal atom, ammonium group or ammonium group substituted by an alkyl group having carbon atoms of not more than 5, and B is a chained or cyclic group forming an organic dibasic acid; m and n each are 0 to 50; and p is 1 to 100. Polyethylene oxide compounds represented by foregoing formula have been employed as a defoaming agent to inhibit marked foaming occurred when stirring or moving emulsion raw materials, specifically in the stage of preparing an aqueous gelatin solution, adding a water-soluble silver and halide salts to the aqueous gelatin solution or coating an emulsion on a support during the process of preparing silver halide photographic light sensitive materials. A technique of using these compounds as a defoaming agent is described in JP-A No. 44-9497. The polyethylene oxide compound represented by the foregoing formula also functions as a defoaming agent during nucleation. The compound represented by the foregoing formula is used preferably in an amount of not more than 1%, and more preferably 0.01 to 0.1% by weight, based on silver.

The compound is to be present at the stage of nucleation, and may be added to a dispersing medium prior to or during nucleation. Alternatively, the compound may be added to an aqueous silver salt solution or halide solution used for nucleation. It is preferred to add it to a halide solution or both silver salt and halide solutions in an amount of 0.01 to 2.0% by weight. It is also preferred to make the compound represented by formula [5] present over a period of at least 50% (more preferably, at least 70%) of the nucleation stage.

The temperature during the stage of nucleation is preferably 5 to 60° C., and more preferably. 15 to 50° C. Even when nucleation is conducted at a constant temperature, in a temperature-increasing pattern (e.g., in such a manner that nucleation starts at 25° C. and the temperature is gradually increased to reach 40° C. at the time of completion of nucleation) or its reverse pattern, it is preferred to control the temperature within the range described above.

Silver salt and halide salt solutions used for nucleation are preferably in a concentration of not more than 3.5 mol/l, and more preferably 0.01 to 2.5 mol/l. The flow rate of aqueous silver salt solution is preferably 1.5×10⁻³ to 3.0×10⁻¹ mol/min per liter of the solution, and more preferably 3.0×10⁻³ to 8.0×10⁻² mol/min. per liter of the solution. The pH during nucleation is within a range of 1.7 to 10, and since the pH at the alkaline side broadens the grain size distribution, the pH is preferably 2 to 6. The pBr during nucleation is 0.05 to 3.0, preferably 1.0 to 2.5, and more preferably 1.5 to 2.0.

The average grain size of silver halide of the invention is preferably 16 to 50 nm, more preferably 10 to 40 nm, and still more preferably 10 to 35 nm. An average grain size of less than 10 nm often lowers the image density or deteriorates image lightfastness. An average grain size of more than 50 nm results in lowered image density. In the invention, the grain size refers to a edge length of the grain in the case of regular grains such as cubic or octahedral grains. In the case of tabular grains, the grain size refers to a diameter of a circle equivalent to the projected area of the major face. In the case of irregular grains, such as spherical grains or bar-like grains, the diameter of a sphere having the same volume as the grain is defined as the grain size. Measurement is made using an electron microscope and grain size values of at least 300 grains are average and defined as an average grain size.

The combined use of silver halide grains having an average grain size of 55 to 100 nm and silver halide grains having an average grain size of 10 to 50 nm enhances the image density or improves (or reduces) lowering in image density during storage. The ratio (by weight) of silver halide grains having an average grain size of 10 to 50 nm to silver halide grains having an average grain size of 55 to 100 nm is preferably from 95:5 to 50:50, and more preferably form 90:10 to 60:40.

When two silver halide emulsions differing in average grain size, these emulsion may be blended and incorporated to the light-sensitive layer. To make adjustment of gradation, the light-sensitive layer divided to at least two layers and two silver halide emulsions differing in average grain size are contained in the respective layers.

Iodide containing silver halide grains are preferably used as silver halide grains used in this invention. With respect to halide composition, silver halide grains of the invention preferably have an iodide content of 5 to 10 mol % (more preferably 40 to 100 mo %, still more preferably 70 to 100 mol %). In the foregoing iodide content range, the halide composition within the grain may be homogeneous, or stepwise or continuously varied. Silver halide grains of a core/shell structure, exhibiting a higher iodide content in the interior and/or on the surface are preferably used. The structure is preferably 2-fold to 5-fold structure and core/shell grains having the 2-fold to 4-fold structure are more preferred.

Introduction of silver iodide into silver halide can be achieved by addition of an aqueous alkali iodide solution in the course of grain formation, addition of fine grains such as particulate silver iodide, particulate silver iodobromide, particulate silver iodochloride or silver iodochlorobromide, or- addition of an iodide ion-releasing agent as described in JP-A Nos. 5-323487 and 6-11780. The silver halide usable in the invention preferably exhibits a direct transition absorption attributed to the silver iodide crystal structure within the wavelength region of 350 to 440 nm. The direct transition absorption of silver halide can be readily distinguished by observation of an exciton absorption in the range of 400 to 430 nm, due to the direct transition.

Light-sensitive silver halide grains usable in this invention are preferably those which are capable of being converted from a surface image forming type to an internal image forming type upon thermal development, resulting in reduced surface sensitivity. Thus, the silver halide grains form latent images capable of acting as a catalyst in development (or reduction reaction of silver ions by a reducing agent) upon exposure to light prior to thermal development on the silver halide grain surface, and upon exposure after completion of thermal development, images are formed preferentially in the interior of the grains (i.e., internal latent image formation), thereby suppressing formation of latent images on the grain surface.

Similarly to the conventional surface latent image forming type silver halide grains, the foregoing thermally surface to internal latent image-convertible silver halide grains are used preferably in an amount of 0.001 to 0.7 mol per mol of aliphatic carboxylic acid silver salt, and more preferably 0.03 to 0.5 mol.

It is preferred to prevent aggregation of silver halide grains in the course of manufacturing photothermographic material to allow silver halide grains to be homogeneously dispersed and control developed silver in a desired form, thereby achieving improvements of photographic performance and image tone.

Gelatin in which a hydrophilic group such as amino or carboxyl group is chemically modified in accordance with the condition for use is preferred to achieve prevention of aggregation or homogeneous dispersion.

Modification of an amino group of gelatin to enhance hydrophobicity include, for example, phenylcarbamoyl-modification, phthalation, succinic acid-modification, acetylation, benzoyl-modification and nitrophenyl-modification, but is not limited these. The substitution factor is preferably at least 95%, and more preferably at least 99%. Hydrophobic modification of a carboxyl group may be combined and examples thereof include methyl-esterification and amide-formation. The substitution factor of a carboxyl group is preferably 50% to 90% and more preferably 70% to 90%. The hydrophobic modification means that substitution of an amino and/or carboxyl group with a hydrophobic group enhances hydrophobicity.

It is preferred to use a polymer soluble in water and an organic solvent in place of or together with gelatin to prepare a silver halide emulsion relating to the invention. For instance, it is specifically preferred in the case when a silver halide emulsion is dispersed in an organic solvent to be coated. Examples of such an organic solvent include alcoholic type, ester type and ketone type compounds. Of these are specifically preferred ketone type organic solvents such as acetone, methyl ethyl ketone and diethyl ketone.

A polymers soluble in water and an organic solvent may be a natural polymers, or a synthetic polymer or copolymer. For instance, gelatins or rubbers which are modified so as to be compatible with the invention, are usable in the invention. It is also feasible to introduce a functional group into polymer as below for prevention of aggregation or homogeneous dispersion. Examples of such a polymer include poly(vinyl alcohol), hydroxyethyl celluloses, cellulose acetates, cellulose acetate-butylates, poly(vinyl pyrrolidone), casein, starch, poly(acrylic acid or acrylic acid ester), poly(vinyl chloride), poly(methacrylic acid), copoly(styrene-maleic acid anhydride), copoly(styrene-acrylonitrile), copoly(styrene-butadiene), poly(vinyl acetal), poly(ester), poly(uretane), phenoxy resin, poly(vinylidene chloride), poly(epoxide), poly(carbonate), poly(vinyl acetate), poly(olefin), cellulose ester and poly(amide). These polymers may be their copolymers, and a polymer obtained by copolymerization of monomers of acrylic acid, methacrylic acid and their esters, is preferred.

The polymer relating to the invention may be one which is soluble in both water and an organic solvent but also one which becomes soluble or insoluble in water or an organic solvent by controlling a pH or temperature. A cloud point phenomenon is well known in surfactants. A polymer which becomes hydrophobic or organic solvent-soluble when heated and hydrophilic or water-soluble when cooled, is also usable in the invention. Even if not completely dissolved, it may be homogeneously emulsified to form micelles.

An appropriate combination of hydrophilic monomers and hydrophobic monomers can obtain a desired polymer used in the invention.

The polymer soluble in water and an organic solvent, of which solution conditions may be adjusted, preferably exhibits a solubility in water of at least 1% by weight (at 25° C.) and a solubility in methyl ethyl ketone of at least 5% by weight (at 25° C.).

A block polymer, graft polymer or comb-type polymer is suitable as a polymer soluble in water and an organic solvent, in terms of solubility, rather than a straight chain polymer, and a comb-type polymer is preferable. The isoelectric point of the polymer is preferably a pH of 6 or less.

A comb-type polymer can be manufactured by various methods but preferably by using a monomer capable of introducing a side chain having a molecular weight of 200 or more, and more preferably using ethylenically unsaturated monomers containing a polyoxyalkylene group, such as ethylene oxide or propylene oxide. Such an ethylenically unsaturated monomer containing a polyoxyalkylene group preferably contains a polyoxyalkylene group represented by the following formula:
(EO)k-(PO)m-(TO)n-R
wherein E represents an ethylene group, P represents a propylene group, T represents a butylenes group and R represents a substituent, the butylenes group include a tetramethylene and isobutylene groups, k is an integer of 1 to 300 (preferably 1 to 200 (, m is an integer of 0 to 60 (preferably 0 to 30) and n is an integer of 0 to 40 (preferably 0 to 20), provided that k+m+n≧2. Ethylenically unsaturated monomers containing a polyoxyalkylene group may be used singly or in combination thereof.

In the foregoing formula, the substituent of R is an alkyl group, an aryl group or a heterocyclic group. Examples of an alkyl group include methyl, ethyl, propyl, butyl, hexyl, octyl and dodecyl; examples of an aryl group include phenyl and naphthyl; examples of a heterocyclic group include thienyl and pyridyl. These groups may be substituted by a substituent, such as a halogen atom, an alkoxy group (e.g., methoxy, ethoxy, butoxy), an alkylthio group (e.g., methylthio, butylthio), an acyl group (e.g., acetyl, benzoyl)an alkaneamide group (e.g., acetoamide, propionamide), and an arylamide group (e.g., benzoylamide). These substituents may further be substituted.

The polyoxyalkylene group of the foregoing formula can be introduced into a polymer by using an ethylenically unsaturated monomer containing the polyoxyalkylene group. Examples of such an ethylenically unsaturated monomer include polyoxyalkylene-(meth)acrylate. A polyoxyalkylene-(meth)acrylate can be manufactured by allowing commercially available hydroxy-poly(oxyalkylene) material, for examples, trade name “Pluronic” (produced by Asahi Denka Kogyo Co., Ltd.) Adeka polyether (produced by Asahi Denka Kogyo Co., Ltd.), Carbowax (Glico Product), Toriton (produced by Rohm and Haas) or P.E.G. (produced by Daiich Kogyo Seiyaku Co., Ltd.) to react with acrylic acid, methacrylic acid, acrylonitrile, methacrylonitrile or acrylic acid anhydride. Alternatively, there may be used poly(oxyalkylene)diacrylate manufactured by the commonly known method.

Examples of a commercially available monomer, specifically polyalkylene glycol mono(meth)acrylate include polyalkylene glycol mono(meth)acrylate containing hydroxy end group, produced by Nippon Yushi Co., Ltd., such as Blenmer PE-90, Blenmer PE-200, Blenmer PE-350, Blenmer AE-90, Blenmer AE-200, Blenmer AE-400, Blenmer PP-1000, Blenmer PP-500, Blenmer PP-800, Blenmer AP-150, Blenmer AP-400, Blenmer AP-550, Blenmer AP-800, Blenmer 50PEP-300, Blenmer 70PEP-350B, Blenmer AEP-series, Blenmer 55PET-400, Blenmer 30PET-800, Blenmer 50PET-800, Blenmer AET series, Blenmer 30PPT-800, Blenmer 50PPT-800, Blenmer 70PPT-800, Blenmer ATP series, Blenmer 10PPB-500B, and Blenmer 10APB-500B. Similarly, examples of polyalkylene glycol mono(meth)acrylate containing hydroxy end group, produced by Nippon Yushi Co., Ltd. include Blenmer PME-100, Blenmer PME-200, Blenmer PME-400, Blenmer PME-1000, Blenmer AME-400, Blenmer 50POEP-800B, Blenmer 50AOEP-800B, BlenmerPLE-200, Blenmer ALE-200, Blenmer ALE-800, Blenmer PSE-400, Blenmer PSE-1300, Blenmer ASEP series, Blenmer PKEP series, Blenmer AKEP series, Blenmer ANE-300, Blenmer ANE-1300, Blenmer PNEP series, Blenmer PNPE series, Blenmer 43ANEP and Blenmer 70ANEP-550. Further examples thereof include Light Ester MC, Light Ester 130MA, Light Ester 041MA, Light Acrylate BO-A, Light Acrylate EC-A, Light Acrylate MTG-A, Light Acrylate 130A, Light Acrylate DPM-A, Light Acrylate P-200A, Light Acrylate NP-4EA, and Light Acrylate NP-8EA, each produced by Kyoei Kagaku Co., Ltd.

There are usable, as a polymer relating to the invention, a graft polymer using a so-called-macromer, described in “Shin-Kobunshi Jikkengaku 2, Kobunshi no Gosei•Hannou” edited by Kobushigakkai (Kyoritsu Shupan, 1995) and also detailed in Y. Yamashita “Macromonomer no Kagaku to Kogyo” (IPC). The effective range of molecular weight of a macromer is 10,000 to 100,000, preferably 10,000 to 50,000, and more preferably 10,000 to 20,000. A molecular weight of less than 10,000 cannot achieve cannot achieve effects, and a molecular weight of less than 10,000 cannot achieve advantageous effects of the invention. A molecular weight of more than 100,000 deteriorates polymerizability with a co-polymerizing with a copolymerizable monomer. Specific examples thereof include AA-6, AS6S and AN-6S.

The invention is not limited by the foregoing examples. A ethylenically unsaturated monomer containing a polyoxyalkylene group may be used alone or in combination thereof.

Examples of another monomer to be reacted with the monomer described above include acrylic acid esters, methacrylic acid esters, acrylamides, methacrylamides, allyl esters, allyloxyethanols, vinyl ethers, vinyl esters, itaconic acid dialkyl esters, fumaric acid dialkyl esters and monoalkylesters, and itaconic acid, acrylonitrile, methacrylonitrile, maleilonitrile, and styrene. Specific examples thereof are as follows:

acryloc acid esters: methyl acrylate, ethyl acrylate, propyl acrylate, chloroethyl acrylate, 2-hydroxyethyl acrylate, trimethylopropane monoacrylate, furfuryl acrylate, tetrahydrofurfuryl acrylate;

methacrylic acid esters: methyl methacrylate, ethyl methacrylate, propyl methacrylate, chloroethyl methacrylate, 2-hydroxyethyl methacrylate, trimethylolpropane monomethacrylate, benzyl methacrylate, methoxybenzyl methacrylate, furfuryl methacrylate, tetrahydrofurfuryl methacrylate;

acrylamides: acrylamide, N-alkylacrylamide (alkyl group having 1 to 3 carbon atoms, e.g., methyl, ethyl propyl), N,N-dialkylacrylamide, N-hydroxyethyl-N-methylacrylamide, N-2-acetoamidoethyl-N-acetylacrylamide, alkyloxyacrylamide such as methoxymethylacrylamide or butoxymethylacrylamide;

methacrylamides: methacrylamide, N-alkylmethacrylamide, N-hydroxyethyl-N-methylmethacrylamide, N-N-2-acetoamidoethyl-N-acetylmethacrylamide, methoxymethylmethacrylamide, and butoxymethylmethacrylamide;

allyl compounds: allyl esters (e.g., allyl acetate, allyl capronate, allyl laurate, allyl palmitate, allyl stearate, allyl benzoate, allyl acetoacetate, allyl lactate), allyloxyethanol;

vinyl ethers: alkyl vinyl ether (e.g., hexyl vinyl ether, octyl vinyl ether, decyl vinyl ether, ethylhexyl vinyl ether, methoxyethyl vinyl ether, ethoxyethyl vinyl ether, chloroethyl vinyl ether, 1-methyl-2,2-dimethylpropyl vinyl ether, 2-ethylbutyl vinyl ether, hydroxyethyl vinyl ether, diethylene glycol vinyl ether, dimethylaminoethyl vinyl ether, diethylaminoethyl vinyl ether, butylaminoethyl vinyl ether, benzyl vinyl ether, tetrahydrofurfuryl vinyl ether);

vinyl esters: vinyl butyrate, vinyl isobutyrate, vinyl trimethylacetate, vinyl diethylacetate, vinyl valeate, vinyl caproate, vinyl chloroacetate, vinyl methoxyacetate, vinyl butoxyacetate, vinyl lactate, vinyl-β-phenylbutyrate, and vinyl cyclohexylcarboxylate;

dialkyl itoconates: dimethyl itaconate, diethyl itaconate, and dibutyl itaconate;

mono- or di-alkyl fumarates: dibutyl fumarate.

Further, crotonic acid, itaconic acid, acrylonitrile, methacrylonitrile, maleironitrile and tyrene are also included.

When am amide group, a straight chain or branched alkyl group having 4 to 22 carbon atoms, an aromatic group or a 5- or more-membered heterocyclic group is introduced, a monomer containing these functional groups is chosen from the foregoing monomers and other monomers. For instance, 1-vinylimidazole or its derivatives is used for introduction of a 5- or more-membered heterocyclic group. Alternatively, a polymer which have introduced an isocyanate or epoxy group in advance, is reacted with an alcohol or amine containing a straight or branched alkyl group, an aromatic group or a 5- or more-membered aromatic group to introduce a functional group into the polymer. Introduction of an isocyanate or epoxy group can employ Karens MOI (produced by Showa Denkou Co., Ltd.) or Blenmer G (produced by Nippon Yushi Co., Ltd.). Introduction of a urethane group is preferred.

There are usable azobis type polymerization initiators or organic peroxides. Examples of an azobis type polymerization initiator include ABN-R2,2′-azobisisobutylonitrile, ABN-V 2,2′-azobis(2,4-dimethylvaleronitrile), and ABN-E 2,2′-azobis(2-methylbutylonitrile), each of which is produced by Nippon Hydrazine Kogyo. Co., Ltd. Examples of an organic peroxide include benzoyl peroxide, and dimetyl ethyl ketone peroxide, lauryl peroxide; and Pertetra A, Perhexa HC, Perhexa TMH, Perhexa V, Perhexa 22, Perhexa MC, Perbutyl H, Perkmil H, Perkmil P, Permenta H, Perocta H, Perbutyl C, Perbutyl D, Perhexyl D, Perloyl IB, Perloyl 355, Perloyl L, Perloyl S Perloyl SA, PerloylBW, Niper BW, Niper BMT-K40, Niper BMT-T40, Niper BMT-M, Perloyl IPP, Perloyl NPP, Perloyl TCP, Perloyl EEP, Perloyl MBP, Perloyl OPP<Perloyl SBP, Perkmil ND, Perocta ND, Percyclo ND, Perhexyl ND, Perbutyl ND, Perhexyl PV, Perhexa 250, Perocta O, Perhexyl O, Perbutyl O, Perbutyl IB, Perbutyl L, Perbutyl 355, Perhexyl I, Perbutyl I, Perbutyl ZT and Perbutyl Z, each produced by Nippon Yushi Co., Ltd.

Polymerization inhibitors usable in this invention include a quinone type inhibitor, such as hydroquinone and p-methoxyphenol. Examples thereof include phenothiazine produced by Seiko Chemical Co., Ltd., methoquinone, Nonflex Aluba, MH (methylhydroquinone), TBH (tert-butylhydroquinone), PBQ (p-benzoquinone), toluquinone, TBQ (tert-butyl-p-benzoquinone) and 2,5-diphenyl-p-benzoquinone.

A polymer usable in the invention preferably exhibits an isoelectric point of 6 or less. The use of a polymer exhibiting a higher isoelectric point promotes degradation of silver halide grains during desalting by flocculation, adversely affecting photographic performance. Dispersing silver halide grains in a solvent is difficult without raising a pH value, which is not preferable in terms of fogging. The isoelectric point of a polymer can be determined, for example, by an isoelectric focusing method or in such a manner that after being passed through a mixed bed column composed of cationic and anionic ion exchange resins, the pH is measured.

The isoelectric point of a polymer can be introduction of various acidic groups for example, a carboxylic acid group or a sulfonic acid group. Introduction of a carboxylic acid can achieved not only by using a acrylic acid or methacrylic acid monomer, but also by employment of partial hydrolysis of a polymer formed of at least methyl methacrylate. Introduction of sulfonic acid group can be achieved by using styrenesulfonic acid or 2-acrylamido-2-methylpropanesulfonic acid as a monomer, but it also can be introduced after forming a polymer, by employing various techniques for sulfonation. The use of a carboxylic acid results in relatively high solubility in a solvent in an unneutralized state and neutralization or half-neutralization can alter a solution property. Neutralization can be achieved by using sodium or potassium salts, or organic salts such as ammonia, monoethanolamine, diethanolamine, or triethanolamine. Imidazoles, triazoles or amidoamines are also usable.

Polymerization can be performed either in the presence or absence of a solvent, but the presence of a solvent is preferred in terms of workability. Examples of a preferred solvent include alcohols such as ethanol, isopropyl alcohol, n-butanol, isobutanol, and tert-butanol; ketones such as acetone, methyl ethyl ketone, methyl isobutyl ketone, and methyl amyl ketone; esters such as methyl acetate, ethyl acetate, butyl acetate, methyl lactate, ethyl lactate, and butyl lactate; monocarboxylic acid esters such as methyl 2-oxypropionate, ethyl 2-oxypropionate, propyl 2-oxypropionate, methyl 2-methoxypropionate, ethyl 2-methoxypropionate, propyl 2-methoxypropionate, and butyl 2-methoxypropionate polar solvents such as dimethylformamide, dimethylsulfoxide, and N-methylpyrrolidone; ethers such as methyl cellosolve, ethyl cellosolve, butyl cellosolve, butyl carbitol and ethyl cellosolve acetate; propylene glycols or their esters such as propylene glycol, propylene glycol monomethyl ether, propylene glycol monomethyl ether acetate, propylene glycol monoethyl ether acetate and propylene glycol monobutyl ether acetate; halogenated solvents such as 1,1,1-trichloroethane and chloroform; ethers such as tetrahydrofuran and dioxane; aromatic compounds such as benzene, toluene and xylene; and fluorinated inert liquid such as perfluorooctane and perfluorotri-n-butylamine.

Dropping polymerization in which a monomer and an initiator are dropwise added to a reaction vessel to perform polymerization is effective to obtain a polymer of a uniform composition. An unreacted monomer can be removed by columnar filtration, recrystallization purification or solvent extraction. A low boiling unreacted monomer cal also removed by stripping.

To prevent aggregation of or achieve uniform dispersion of silver halide grains, surfactants, specifically a nonionic surfactant may be added to a silver halide grain dispersion in the course of manufacturing a silver salt photothermographic material relating to the invention.

In accordance with Griffin, W. C. [J. Soc. Cosm. Chem., 1, 311 (1949)], the nonionic surfactant is chosen from nonionic hydrophilic compounds exhibiting a hydrophilic/lipophilic balance of from ˜18 to 18 (preferably from −15 to 0) which is defined as a HLB value reflecting the ratio of a hydrophilic group and a lipophilic group in the molecule.

Nonionic surfactants used for the photothermographic material relating to the invention are those represented by the following formula (NSA1) or (NSA2):
HO-(EO)ₐ-(AO)_{b}-(EO)_{c}-H formula (NSA1)
HO-(EO)_{d}-(AO)ₑ-(EO)_{f}-H formula (NSA2)
wherein EO represents an oxyethylene group and AO represents an oxyalkylene group having at least 3 carbon atoms; a, b, c, d, e and f are each an integer of 1 or more.

The foregoing surfactants are called a pluronic type surafactant. Examples of AO of an oxyalkylene group having at least 3 carbon atoms include oxypropylene, oxybutylene and a long oxyalkylene. Of these, oxypropylen is specifically preferred. Further, a, b and c, and d, e and f are each an integer of 1 or more; a and c are each preferably an integer of 1 to 200, and more preferably an integer of 10 to 100; b is preferably an integer of 1 to 300, and more preferably an integer of 10 to 200; d and f are each preferably an integer of 1 to 100, and more preferably an integer of 5 to 50; and e is preferably an integer of 1 to 100, and more preferably an integer of 2 to 50.

The average molecular weight of the pluronic surfactant of formula (NSA1) or (NSA2) is preferably 500 to 30,000, and more preferably 1,000 to 20,000. The pluronic surfactant of formula (NSA1) or (NSA2) is accounted for by 50% by weight or less of an oxyethylene group. These pluronic surfactants are commercially available, for example, as a trade name of Pluronic P94 or F68.

in the invention a nonionic surfactant is use at a concentration of 0.5% to 2%, preferably 0.9% to 1.5%.

Heteroatom-containing macrocyclic compounds are usable in the light-sensitive silver halide emulsion of this invention. The heterocyclic compounds are those of 9- or more membered (preferably 12- to 24-membered, and more preferably 15- to 21-membered) ring containing at least one heteroatom selected from nitrogen, oxygen, sulfur and selenium atoms.

Representative compounds are those known as a crown ether, which are detailed in C. J. Pederson, Journal of American Chemical Society, Vol. 86, (2495) 7017-7036 (1967); G. W. Gokel, S. H. Korzeniowski “Macrocyclic Polyether Synthesis” Verlag (1982); Oda, Shono, Obuse “Crown Ether no Kagaku” (Kagakudojin 1979); and Sasaki, Koga “Yuki Gosei Kagaku” Vol. 45 (6) 571-582 (1987).

Silver halide grains used in the invention can be subjected to chemical sensitization. In accordance with methods described in JP-A Nos. 2001-249428 and 2001-249426, for example, a chemical sensitization center (chemical sensitization speck) can be formed using compounds capable of releasing chalcogen such as sulfur or noble metal compounds capable of releasing a noble metal ion such as a gold ion. In this invention, it is preferred to conduct chemical sensitization with an organic sensitizer containing a chalcogen atom, as described below. Such a chalcogen atom-containing organic sensitizer is preferably a compound containing a group capable of being adsorbed onto silver halide and a labile chalcogen atom site. These organic sensitizers include, for example, those having various structures, as described in JP-A Nos. 60-150046,. 4-109240, 11-218874, 11-218875, 11-218876 and 11-194447. Specifically preferred of these is at least a compound having a structure in which a chalcogen atom is attacked to a carbon or phosphorus atom through a double-bond. Specifically, heterocycle-containing thiourea derivatives and triphenylphosphine sulfide derivatives are preferred. A variety of techniques for chemical sensitization employed in silver halide photographic material for use in wet processing are applicable to conduct chemical sensitization, as described, for example, in T. H. James, The Theory of the Photographic Process, 4th Ed. (Macmillan Publishing Co., Ltd., 1977 and Nippon Shashin Gakai Ed., “Shashin Kogaku no Kiso (Ginene Shashin)” (Corona Co., Ltd., 1998). The amount of a chalcogen compound added as an organic sensitizer is variable, depending on the chalcogen compound to be used, silver halide grains and a reaction environment when subjected to chemical sensitization and is preferably 10⁻⁸ to 10⁻² mol, and more preferably 10⁻⁷ to 10⁻³ mol per mol of silver halide. In the invention, the chemical sensitization environment is not specifically limited but it is preferred to conduct chemical sensitization in the presence of a compound capable of eliminating a silver chalcogenide or silver specks formed on the silver halide grain or reducing the size thereof, or specifically in the presence of an oxidizing agent capable of oxidizing the silver specks, using a chalcogen atom-containing organic sensitizer. To conduct chemical sensitization under preferred conditions, the pAg is preferably 6 to 11, and more preferably 7 to 10, the pH is preferably 4 to 10 and more preferably 5 to 8, and the temperature is preferably not more than 30° C.

Chemical sensitization using the foregoing organic sensitizer is also preferably conducted in the presence of a spectral sensitizing dye or a heteroatom-containing compound capable of being adsorbed onto silver halide grains. Thus, chemical sensitization in the present of such a silver halide-adsorptive compound results in prevention of dispersion of chemical sensitization center specks, thereby achieving enhanced sensitivity and minimized fogging. Although there will be described spectral sensitizing dyes used in the invention, preferred examples of the silver halide-adsorptive, heteroatom-containing compound include nitrogen containing heterocyclic compounds described in JP-A No. 3-24537. In the heteroatom-containing compound, examples of the heterocyclic ring include a pyrazolo ring, pyrimidine ring, 1,2,4-triazole ring, 1,2,3-triazole ring, 1,3,4-thiazole ring, 1,2,3-thiadiazole ring, 1,2,4-thiadiazole ring, 1,2,5-thiadiazole ring, 1,2,3,4-tetrazole ring, pyridazine ring, 1,2,3-triazine ring, and a condensed ring of two or three of these rings, such as triazolotriazole ring, diazaindene ring, triazaindene ring and pentazaindene ring. Condensed heterocyclic ring comprised of a monocyclic hetero-ring and an aromatic ring include, for example, a phthalazine ring, benzimidazole ring indazole ring, and benzthiazole ring. Of these, an azaindene ring is preferred and hydroxy-substituted azaindene compounds, such as hydroxytriazaindene, tetrahydroxyazaindene and hydroxypentazaundene compound are more preferred. The heterocyclic ring may be substituted by substituent groups other than hydroxy group. Examples of the substituent group include an alkyl group, substituted alkyl group, alkylthio group, amino group, hydroxyamino group, alkylamino group, dialkylamino group, arylamino group, carboxy group, alkoxycarbonyl group, halogen atom and cyano group. The amount of the heterocyclic ring containing compound to be added, which is broadly variable with the size or composition of silver halide grains, is within the range of 10⁻⁶ to 1 mol, and preferably 10⁻⁴ to 10⁻¹ mol per mol silver halide.

As described earlier, silver halide grains can be subjected to noble metal sensitization using compounds capable of releasing noble metal ions such as a gold ion. Examples of usable gold sensitizers include chloroaurates and organic gold compounds. In addition to the foregoing sensitization, reduction sensitization can also be employed and exemplary compounds for reduction sensitization include ascorbic acid, thiourea dioxide, stannous chloride, hydrazine derivatives, borane compounds, silane compounds and polyamine compounds. Reduction sensitization can also conducted by ripening the emulsion while maintaining the pH at not less than 7 or the pAg at not more than 8.3. Silver halide to be subjected to chemical sensitization may be one which has been prepared in the presence of an organic silver salt, one which has been formed under the condition in the absence of the organic silver salt, or a mixture thereof.

When the surface of silver halide grains is subjected to chemical sensitization, it is preferred that an effect of the chemical sensitization substantially disappears after subjected to thermal development. An effect of chemical sensitization substantially disappearing means that the sensitivity of the photothermographic material, obtained by the foregoing chemical sensitization is reduced, after thermal development, to not more than 1.1 times that of the case not having been subjected to chemical sensitization. To allow the effect of chemical sensitization to disappear, it is preferred to allow an oxidizing agent such as a halogen radical-releasing compound which is capable of decomposing a chemical sensitization center (or chemical sensitization nucleus) through an oxidation reaction to be contained in an optimum amount in the light-sensitive layer and/or the light-insensitive layer. The content of an oxidizing agent is adjusted in light of oxidizing strength of an oxidizing agent and chemical sensitization effects.

The light-sensitive silver halide usable in this invention is preferably spectrally sensitized by adsorption of spectral sensitizing-dyes. Examples of the spectral sensitizing dye include cyanine, merocyanine, complex cyanine, complex merocyanine, holo-polar cyanine, styryl, hemicyanine, oxonol and hemioxonol dyes, as described in JP-A Nos. 63-159841, 60-140335, 63-231437, 63-259651, 63-304242, 63-15245; U.S. Pat. Nos. 4,639,414, 4,740,455, 4,741,966, 4,751,175 and 4,835,096. Usable sensitizing dyes are also described in Research Disclosure (hereinafter, also denoted as RD) 17643, page 23, sect. IV-A (December, 1978), and ibid 18431, page 437, sect. X (August, 1978). It is preferred to use sensitizing dyes exhibiting spectral sensitivity suitable for spectral characteristics of light sources of various laser imagers or scanners. Examples thereof include compounds described in JP-A Nos. 9-34078, 9-54409 and 9-80679.

Useful cyanine dyes include, for example, cyanine dyes containing a basic nucleus, such as thiazoline, oxazoline, pyrroline, pyridine, oxazole, thiazole, selenazole and imidazole nuclei. Useful merocyanine dyes preferably contain, in addition to the foregoing nucleus, an acidic nucleus such as thiohydantoin, rhodanine, oxazolidine-dione, thiazoline-dione, barbituric acid, thiazolinone, malononitrile and pyrazolone nuclei. In the invention, there are also preferably used sensitizing dyes having spectral sensitivity within the infrared region. Examples of the preferred infrared sensitizing dye include those described in U.S. Pat. Nos. 4,536,478, 4,515,888 and 4,959,294.

The photothermographic material preferably contains at least one of sensitizing dyes described in Japanese Patent Application No. 2003-102726, represented by the following formulas (SD-1) and (SD-2): 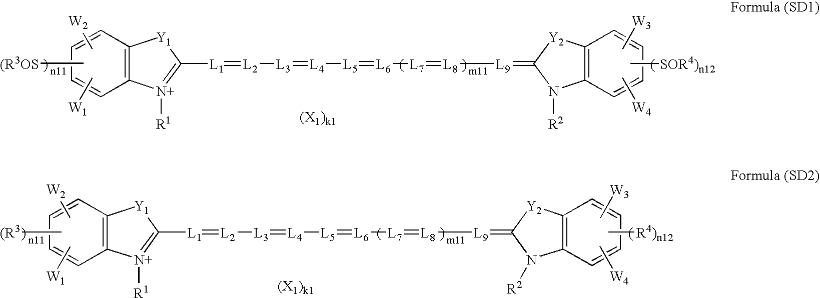
wherein Y₁ and Y₂ are each an oxygen atom, a sulfur atom, a selenium atom or —CH═CH—; L₁ to L₉ are each a methine group; R₁ and R₂ are an aliphatic group; R³ and R⁴ are each a lower alkyl group, a cycloalkyl group, an alkenyl group, an aralkyl group, an aryl group or a heterocyclic group; W₁, W₂, W₃ and W₄ are each a hydrogen atom, a substituent or an atom group necessary to form a ring by W₁ and W₂ or W₃ and W₄, or an atom group necessary to form a 5- or 6-membered ring by R³ and W₁, R³ and W₂, R⁴ and W₃, R⁴ and W₄; X₁ is an ion necessary to compensating for a charge within the molecule; k1 is the number of ions necessary to compensate for a charge within the molecule; m11 is 0 or 1;n11 and n12 are each 0, 1 or 2, provided that n11 and n12 are not 0 at the same time.

The infrared sensitizing dyes and spectral sensitizing dyes described above can be readily synthesized according to the methods described in F. M. Hammer, The Chemistry of Heterocyclic Compounds vol. 18, “The cyanine Dyes and Related Compounds” (A. Weissberger ed. Interscience Corp., New York, 1964).

The infrared sensitizing dyes can be added at any time after preparation of silver halide. For example, the dye can be added to a light sensitive emulsion containing silver halide grains/organic silver salt grains in the form of by dissolution in a solvent or in the form of a fine particle dispersion, so-called solid particle dispersion. Similarly to the heteroatom containing compound having adsorptivity to silver halide, after adding the dye prior to chemical sensitization and allowing it to be adsorbed onto silver halide grains, chemical sensitization is conducted, thereby preventing dispersion of chemical sensitization center specks and achieving enhanced sensitivity and minimized fogging.

These sensitizing dyes may be used alone or in combination thereof. The combined use of sensitizing dyes is often employed for the purpose of supersensitization, expansion or adjustment of the light-sensitive wavelength region. A super-sensitizing compound, such as a dye which does not exhibit spectral sensitization or substance which does not substantially absorb visible light may be incorporated, in combination with a sensitizing dye, into the emulsion containing silver halide grains and organic silver salt grains used in photothermographic imaging materials of the invention.

Useful sensitizing dyes, dye combinations exhibiting super-sensitization and materials exhibiting supersensitization are described in RD17643 (published in December, 1978), IV-J at page 23, JP-B 9-25500 and 43-4933 (herein, the term, JP-B means published Japanese Patent) and JP-A 59-19032, 59-192242 and 5-341432. In the invention, an aromatic heterocyclic mercapto compound represented by the following formula is preferred as a supersensitizer:
Ar—SM
wherein M is a hydrogen atom or an alkali metal atom; Ar is an aromatic ring or condensed aromatic ring containing a nitrogen atom, oxygen atom, sulfur atom, selenium atom or tellurium atom. Such aromatic heterocyclic rings are preferably benzimidazole, naphthoimidazole, benzthiazole, naphthothiazole, benzoxazole, naphthooxazole, benzoselenazole, benzotellurazole, imidazole, oxazole, pyrazole, triazole, triazines, pyrimidine, pyridazine, pyrazine, pyridine, purine, and quinoline. Other aromatic heterocyclic rings may also be included.

A disulfide compound which is capable of forming a mercapto compound when incorporated into a dispersion of an organic silver salt and/or a silver halide grain emulsion is also included in the invention. In particular, a preferred example thereof is a disulfide compound represented by the following formula:
Ar—S—S—Ar
wherein Ar is the same as defined in the mercapto compound represented by the formula described earlier.

The aromatic heterocyclic rings described above may be substituted with a halogen atom (e.g., Cl, Br, I), a hydroxy group, an amino group, a carboxy group, an alkyl group (having one or more carbon atoms, and preferably1 1 to 4 carbon atoms) or an alkoxy group (having one or more carbon atoms, and preferably1 1 to 4 carbon atoms). In addition to the foregoing supersensitizers, there are usable heteroatom-containing macrocyclic compounds described in JP-A No. 2001-330918, as a supersensitizer. The supersensitizer is incorporated into a light-sensitive layer containing organic silver salt and silver halide grains, preferably in an amount of 0.001 to 1.0 mol, and more preferably 0.01 to 0.5 mol per mol of silver.

It is preferred that a sensitizing dye is allowed to adsorb onto the surface of light-sensitive silver halide grains to achieve spectral sensitization and the spectral sensitization effect substantially disappears after being subjected to thermal development. The effect of spectral sensitization substantially disappearing means that the sensitivity of the photothermographic material, obtained by a sensitizing dye or a supersensitizer is reduced, after thermal development, to not more than 1.1 times that of the case not having been subjected to spectral sensitization. To allow the effect of spectral sensitization to disappear, it is preferred to use a spectral sensitizing dye easily releasable from silver halide grains and/or to allow an oxidizing agent such as a halogen radical-releasing compound which is capable of decomposing a spectral sensitizing dye through an oxidation reaction to be contained in an optimum amount in the light-sensitive layer and/or the light-insensitive layer. The content of an oxidizing agent is adjusted in light of oxidizing strength of the oxidizing agent and its spectral sensitization effects.

Reducing agents used in this invention can reduce silver ions in the light-sensitive layer are also called a developer or a developing agent. Compounds usable as a reducing agent are those as below.

In this invention, the preferred reducing agent for silver ions is a compound represented by the following formula (1), which may be used alone or in combination with other reducing agents: 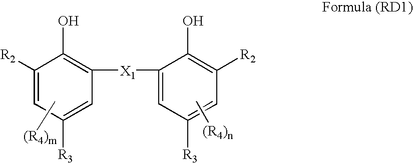
X₁ represents a chalcogen atom or CHR₁ in which R₁ is a hydrogen atom, a halogen atom, an alkyl group, an alkenyl group, an aryl group or a heterocyclic group; both R₂ are each an alkyl group, which may be the same or different; R₃ is a hydrogen atom or a group capable of being substituted on a benzene ring; R₄ is a group capable of being substituted on a benzene ring; m and n are each an integer of 0 to 2.

Of the foregoing compounds of formula (RD1), a high-active reducing agent having R₂ of secondary or tertiary alkyl group {which is denoted as a compound of formula (RD1a)} is preferred. Thus, the use of such a reducing agent results in a photothermographic material exhibiting superior image lightfastness. In this invention, the combined use of a compound of formula (RD1a) and a compound represented by the following formula (RD2) is preferred to achieve desired image color: 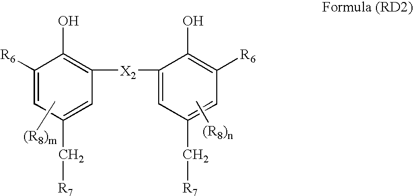
wherein X₂ represents a chalcogen atom or CHR₅ in which R₅ is a hydrogen atom, a halogen atom, an alkyl group, an alkenyl group, an aryl group or a heterocyclic group; both R₆ are each an alkyl group, which may be the same or different, provided that R₆ is not a secondary or tertiary alkyl group; R₇ is a hydrogen atom or a group capable of being substituted on a benzene ring; R₈ is a group capable of being substituted on a benzene ring; m and n are each an integer of 0 to 2.

The weight ratio of compound of formula (RD1a) to compound of formula (RD2) is preferably in the range of from 5:95 to 45:55, and more preferably from 10:90 to 40:60.

In the formula (RD1), X₁ represents a chalcogen atom or CHR₁. Specifically listed as chalcogen atoms are a sulfur atom, a selenium atom, and a tellurium atom. Of these, a sulfur atom is preferred; R₁ in CHR₁ represents a hydrogen atom, a halogen atom, an alkyl group, an alkenyl group, an alkynyl group, an aryl group or a heterocyclic group. Halogen atoms include, for example, a fluorine atom, a chlorine atom, and a bromine atom. Alkyl groups are an alkyl groups having 1-20 carbon atoms and specific examples thereof include a methyl group, an ethyl group, a propyl group, a butyl group, a hexyl group, a heptyl group and a cycloalkyl group. Examples of alkenyl groups are, a vinyl group, an allyl group, a butenyl group, a hexenyl group, a hexadienyl group, an ethenyl-2-propenyl group, a 3-butenyl group, a 1-methyl-3-propenyl group, a 3-pentenyl group, a 1-methyl-3-butenyl group and a cyclohexenyl group. Examples of aryl groups are, a phenyl group and a naphthyl group. Examples of heterocyclic groups are, a thienyl group, a furyl group, an imidazolyl group, a pyrazolyl group and a pyrrolyl group.

These groups may have a substituent. Listed as the substituents are a halogen atom (for example, a fluorine atom, a chlorine atom, or a bromine atom), a cycloalkyl group (for example, a cyclohexyl group or a cyclobutyl group), a cycloalkenyl group (for example, a 1-cycloalkenyl group or a 2-cycloalkenyl group), an alkoxy group (for example, a methoxy group, an ethoxy group, or a propoxy group), an alkylcarbonyloxy group (for example, an acetyloxy group), an alkylthio group (for example, a methylthio group or a trifluoromethylthio group), a carboxyl group, an alkylcarbonylamino group (for example, an acetylamino group), a ureido group (for example, a methylaminocarbonylamino group), an alkylsulfonylamino group (for example, a methanesulfonylamino group), an alkylsulfonyl group (for example, a methanesulfonyl group and a trifluoromethanesulfonyl group), a carbamoyl group (for example, a carbamoyl group, an N,N-dimethylcarbamoyl group, or an N-morpholinocarbonyl group), a sulfamoyl group (for example, a sulfamoyl group, an N,N-dimethylsulfamoyl group, or a morpholinosulfamoyl group), a trifluoromethyl group, a hydroxyl group, a nitro group, a cyano group, an alkylsulfonamide group (for example, a methanesulfonamide group or a butanesulfonamide group), an alkylamino group (for example, an amino group, an N,N-dimethylamino group, or an N,N-diethylamino group), a sulfo group, a phosphono group, a sulfite group, a sulfino group, an alkylsulfonylaminocarbonyl group (for example, a methanesulfonylaminocarbonyl group or an ethanesulfonylaminocarbonyl group), an alkylcarbonylaminosulfonyl group (for example, an acetamidosulfonyl group or a methoxyacetamidosulfonyl group), an alkynylaminocarbonyl group (for example, an acetamidocarbonyl group or a methoxyacetamidocarbonyl group), and an alkylsulfinylaminocarbonyl group (for example, a methanesulfinylaminocarbonyl group or an ethanesulfinylaminocarbonyl group). Further, when at least two substituents are present, they may be the same or different. Most preferred substituent is an alkyl group.

R₂ represents an alkyl group. The alkyl groups are preferably those having 1 to 20 carbon atoms, which may be substituted or unsubstituted. Specific examples thereof include a methyl, ethyl, i-propyl, butyl, i-butyl, t-butyl, t-pentyl, t-octyl, cyclohexyl, 1-methylcyclohexyl, or 1-methylcyclopropyl.

Substituents of the alkyl group are not particularly limited and include, for example, an aryl group, a hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group, and a halogen atom. In addition, (R₄)ₙ and (R₄)ₘ may form a saturated ring. R₂ is preferably a secondary or tertiary alkyl group and preferably has 2-20 carbon atoms. R₂ is more preferably a tertiary alkyl group, is still more preferably a t-butyl group, a t-pentyl group, or a methylcyclohexyl group, and is most preferably a t-butyl group.

R₃ represents a hydrogen atom or a group capable of being substituted to a benzene ring. Listed as groups capable of being substituted to a benzene ring are, for example, a halogen atom such as fluorine, chlorine, or bromine, an alkyl group, an aryl group, a cycloalkyl group, an alkenyl group, a cycloalkenyl group, an alkynyl group, an amino group, an acyl group, an acyloxy group, an acylamino group, a sulfonylamino group, a sulfamoyl group, a carbamoyl group, an alkylthio group, a sulfonyl group, an alkylsulfonyl group, a sulfonyl group, a cyano group, and a heterocyclic group.

R₃ is preferably methyl, ethyl, i-propyl, t-butyl, cyclohexyl, 1-methylcyclohexyl, or 2-hydroxyethyl. Of these, 2-hydroxyethyl is more preferred.

These groups may further have a substituent. There may be employed as such substituents those listed in aforesaid R₁. R₃ is an alkyl group containing a hydroxyl group or its precursor group and having carbon atoms of 1 to 20, preferably 1 to 5; and 2-hydroxyethyl is specifically preferred. Specifically preferred combination of R₂ and R₃ is R₂ of a tertiary alkyl group (e.g., t-butyl, 1-methylcyclohexyl) and R₃ of a primary alkyl group containing hydroxyl group or its precursor group (e.g., 2-hydroxyethyl). Plural R₂s or R₃s may be the same or different.

R₄ represents a group capable of being substituted on a benzene ring. Specific examples include an alkyl group having 1 to 25 carbon atoms (e.g., methyl, ethyl, propyl, i-propyl, t-butyl, pentyl, hexyl, or cyclohexyl), a halogenated alkyl group (e.g., trifluoromethyl or perfluorooctyl), a cycloalkyl group (e.g., cyclohexyl or cyclopentyl); an alkynyl group (e.g., propargyl), a glycidyl group, an acrylate group, a methacrylate group, an aryl group (e.g., phenyl), a heterocyclic group (e.g., pyridyl, thiazolyl, oxazolyl, imidazolyl, furyl, pyrrolyl, pyradinyl, pyrimidyl, pyridadinyl, selenazolyl, piperidinyl, sulforanyl, piperidinyl, pyrazolyl, or tetrazolyl), a halogen atom (e.g., chlorine, bromine, iodine or fluorine), an alkoxy group (e.g., methoxy, ethoxy, propyloxy, pentyloxy, cyclopentyloxy, hexyloxy, or cyclohexyloxy), an aryloxy group (e.g., phenoxy), an alkoxycarbonyl group (e.g., methyloxycarbonyl, ethyloxycarbonyl, or butyloxycarbonyl), an aryloxycarbonyl group (e.g., phenyloxycarbonyl), a sulfonamido group (e.g., methanesulfonamido, ethanesulfonamido, butanesulfonamido, hexanesulfonamido, cyclohexabesulfonamido, benzenesulfonamido), sulfamoyl group (e.g., aminosulfonyl, methyaminosulfonyl, dimethylaminosulfonyl, butylaminosulfonyl, hexylaminosulfonyl, cyclohexylaminosufonyl, phenylaminosulfonyl, or 2-pyridylaminosulfonyl), a urethane group (e.g., methylureido, ethylureido, pentylureido, cyclopentylureido, phenylureido, or 2-pyridylureido), an acyl group (e.g., acetyl, propionyl, butanoyl, hexanoyl, cyclohexanoyl, benzoyl, or pyridinoyl), a carbamoyl group (e.g., aminocarbonyl, methylaminocarbonyl, dimethylaminocarbonyl, propylaminocarbonyl, a pentylaminocarbonyl group, cyclohexylaminocarbonyl, phenylaminocarbonyl, or 2-pyridylaminocarbonyl), an amido group (e.g., acetamide, propionamide, butaneamide, hexaneamide, or benzamide), a sulfonyl group (e.g., methylsulfonyl, ethylsulfonyl, butylsulfonyl, cyclohexylsulfonyl, phenylsulfonyl, or 2-pyridylsulfonyl), an amino group (e.g., amino, ethylamino, dimethylamino, butylamino, cyclopentylamino, anilino, or 2-pyridylamino), a cyano group, a nitro group, a sulfo group, a carboxyl group, a hydroxyl group, and an oxamoyl group. Further, these groups may further be substituted with these groups. Each of n and m represents an integer of from 0 to 2. However, the most preferred case is that both n and m are 0. Plural R₄s may be the same or different.

Further, R₄ may form a saturated ring together with R₂ and R₃. R₄ is preferably a hydrogen atom, a halogen atom, or an alkyl group, and is more preferably a hydrogen atom.

In the formula (2), R₅ is the same as defined in R₁, R₇ is the same as defined in R₃, and R₈ is the same as defined in R₄. Both R₆ are each an alkyl group, which may the same or different, provided that R₆ is not a secondary or tertiary alkyl group. Thus, R₆ is preferably an alkyl group having 1 to 20 carbon atoms, which may be substituted. Specific examples thereof include methyl, ethyl, propyl and butyl.

Substituents of the alkyl group are not specifically limited but examples thereof include an aryl group, hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group and a halogen atom. R₆ may combine with (R₈)ₙ or (R₈)ₘ to form a saturated ring. R₆ is preferably methyl, which is most preferred compound of formula (RD2). The compounds are those which satisfy formula (S) and formula (T) described in European Patent No. 1,278,101, specifically, compounds (1-24), (1-28) to (1-54) and (1-56) to (1-75) are cited.

Specific examples of the compound of formula (RD1) or (RD2) are shown below but are not limited to these.

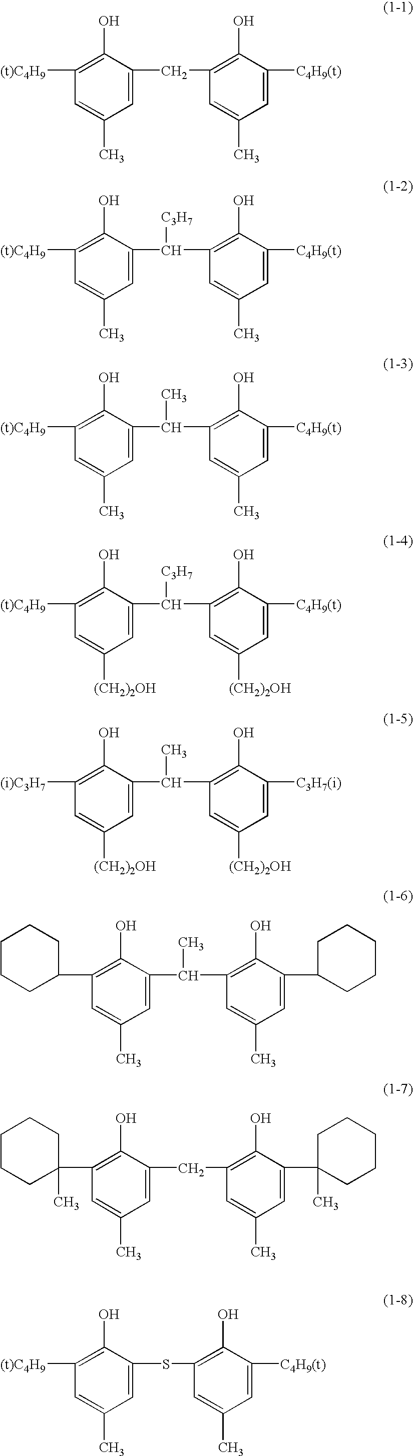

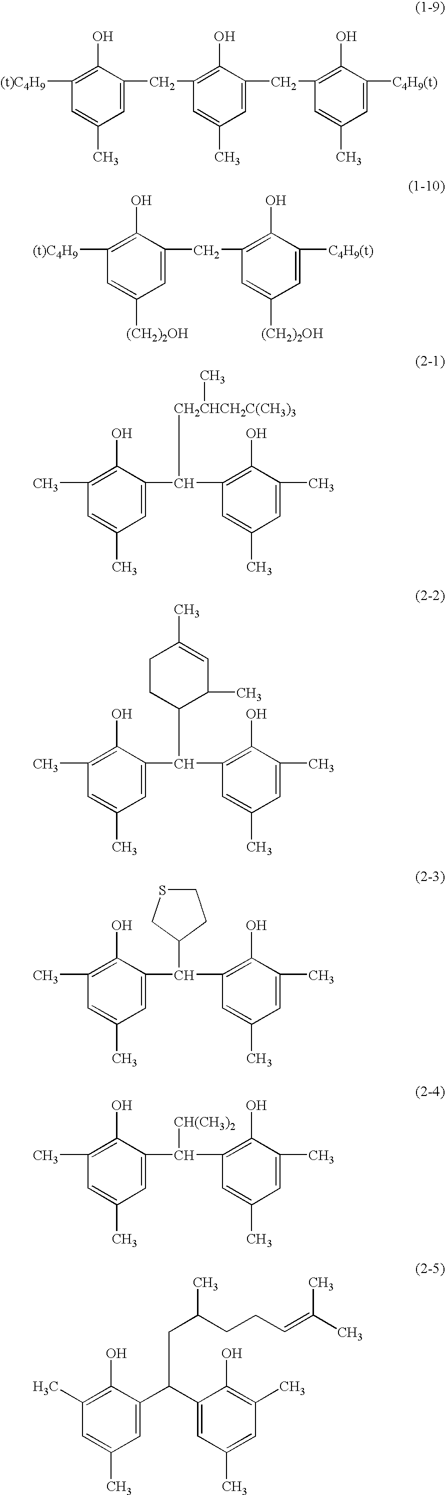

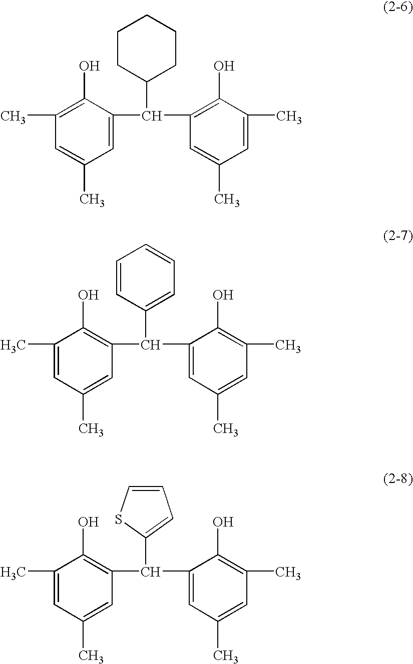

Bisphenol compounds of formula (RD1) or (RD2) can readily be synthesized according to conventionally known methods.

Examples of reducing agents which are usable in combination with the reducing agent described above are described in U.S. Pat. Nos. 3,770,448, 3,773,512, and 3,593,863; RD 17029 and 29963; JP-A Nos. 11-119372 and 2002-62616.

Reducing agents including the compounds of formula (1) are incorporated preferably in an amount of 1×10⁻² to 10 mol per mol of silver, and more preferably 1×10⁻² to 1.5 mol.

The color tone of images obtained by thermal development of the imaging material is described.

It has been pointed out that in regard to the output image tone for medical diagnosis, cold image tone tends to result in more accurate diagnostic observation of radiographs. The cold image tone, as described herein, refers to pure black tone or blue black tone in which black images are tinted to blue. On the other hand, warm image tone refers to warm black tone in which black images are tinted to brown.

The tone is more described below based on an expression defined by a method recommended by the Commission Internationale de l'Eclairage (CIE) in order to define more quantitatively.

“Colder tone” as well as “warmer tone”, which is terminology of image tone, is expressed, employing minimum density Dₘᵢₙ and hue angle h_{ab} at an optical density D of 1.0. The hue angle h_{ab} is obtained by the following formula, utilizing color specifications a* and b* of L*a*b* Color Space which is a color space perceptively having approximately a uniform rate, recommended by Commission Internationale de l'Eclairage (CIE) in 1976.
h_{ab}=tan⁻¹(b*/a*)

In this invention, h_{ab} is preferably in the range of 180 degrees <h_{ab}<270 degrees, is more preferably in the range of 200 degrees <h_{ab}<270 degrees, and is most preferably in the range of 220 degrees <h_{ab}<260 degrees.

This finding is also disclosed in JP-A 2002-6463.

Incidentally, as described, for example, in JP-A No. 2000-29164, it is conventionally known that diagnostic images with visually preferred color tone are obtained by adjusting, to the specified values, u* and v* or a* and b* in CIE 1976 (L*u*v*) color space or (L*a*b*) color space near an optical density of 1.0.

Extensive investigation was performed for the silver salt photothermographic material according to the present invention. As a result, it was discovered that when a linear regression line was formed on a graph in which in the CIE 1976 (L*u*v*) color space or the (L*a*b*) color space, u* or a* was used as the abscissa and v* or b* was used as the ordinate, the aforesaid materiel exhibited diagnostic properties which were equal to or better than conventional wet type silver salt photosensitive materials by regulating the resulting linear regression line to the specified range. The condition ranges of the present invention will now be described.

(1) It is preferable that the coefficient of determination value R² of the linear regression line, which is made by arranging u* and v* in terms of each of the optical densities of 0.5, 1.0, and 1.5 and the minimum optical density, is also from 0.998 to 1.000.

The value v* of the intersection point of the aforesaid linear regression line with the ordinate is −5-+5; and gradient (v*/u*) is 0.7 to 2.5.

(2) The coefficient of determination value R² of the linear regression line is 0.998 to 1.000, which is formed in such a manner that each of optical density of 0.5, 1.0, and 1.5 and the minimum optical density of the aforesaid imaging material is measured, and a* and b* in terms of each of the above optical densities are arranged in two-dimensional coordinates in which a* is used as the abscissa of the CIE 1976 (L*a*b*) color space, while b* is used as the ordinate of the same. In addition, value b* of the intersection point of the aforesaid linear regression line with the ordinate is from −5 to +5, while gradient (b*/a*) is from 0.7 to 2.5.

A method for making the above-mentioned linear regression line, namely one example of a method for determining u* and v* as well as a* and b* in the CIE 1976 color space, will now be described.

By employing a thermal development apparatus, a 4-step wedge sample including an unexposed portion and optical densities of 0.5, 1.0, and 1.5 is prepared. Each of the wedge density portions prepared as above is determined employing a spectral chronometer (for example, CM-3600d, manufactured by Minolta Co., Ltd.) and either u* and v* or a* and b* are calculated. Measurement conditions are such that an F7 light source is used as a light source, the visual field angle is 10 degrees, and the transmission measurement mode is used. Subsequently, either measured u* and v* or measured a* and b* are plotted on the graph in which u* or a* is used as the abscissa, while v* or b* is used as the ordinate, and a linear regression line is formed, whereby the coefficient of determination value R² as well as intersection points and gradients are determined.

The specific method enabling to obtain a linear regression line having the above-described characteristics will be described below. In this invention, by regulating the added amount of the developing agents, silver halide grains, and aliphatic carboxylic acid silver, which are directly or indirectly involved in the development reaction process, it is possible to optimize the shape of developed silver so as to result in the desired tone. For example, when the developed silver is shaped to dendrite, the resulting image tends to be bluish, while when shaped to filament, the resulting imager tends to be yellowish. Namely, it is possible to adjust the image tone taking into account the properties of shape of developed silver.

Usually, image toning agents such as phthalazinone or a combinations of phthalazine with phthalic acids, or phthalic anhydride are employed. Examples of suitable image toning agents are disclosed in Research Disclosure, Item 17029, and U.S. Pat. Nos. 4,123,282, 3,994,732, 3,846,136, and 4,021,249.

In this invention, when rapid processing was performed using a compact laser image having a cooling section of a short length, it was proved that silver image tone was greatly different from preferable color. To overcome such a problem, conventional toning agents were insufficient and there were needed compounds capable of performing imagewise dye formation upon thermal development to form a dye image (e.g., leuco dyes or coupler compounds). As such a compound is preferable one capable of forming a dye image exhibiting an absorption peak at a wavelength of 360 to 450 nm upon thermal development or one capable of forming a dye image exhibiting an absorption peak at a wavelength of 600 to 700 nm upon thermal development. It is specifically preferred to contain both compounds to achieve superior image tone. Thus, it is preferable to control color tone employing couplers disclosed in JP-A No. 11-288057 and EP 1134611A2 as well as leuco dyes detailed below.

The photothermographic material relating to this invention can employ leuco dyes to control image tone, as described above. Leuco dyes are employed in the silver salt photothermographic materials relating to this invention. There may be employed, as leuco dyes, any of the colorless or slightly tinted compounds which are oxidized to form a colored state when heated at temperatures of about 80 to about 200° C. for about 0.5 to about 30 seconds. It is possible to use any of the leuco dyes which are oxidized by silver ions to form dyes. Compounds are useful which are sensitive to pH and are oxidizable to a colored state.

Representative leuco dyes suitable for the use in the present invention are not particularly limited. Examples include bisphenol leuco dyes, phenol leuco dyes, indoaniline leuco dyes, acrylated azine leuco dyes, phenoxazine leuco dyes, phenodiazine leuco dyes, and phenothiazine leuco dyes. Further, other useful leuco dyes are those disclosed in U.S. Pat. Nos. 3,445,234, 3,846,136, 3,994,732, 4,021,249, 4,021,250, 4,022,617, 4,123,282, 4,368,247, and 4,461,681, as well as JP-A Nos. 50-36110, 59-206831, 5-204087, 11-231460, 2002-169249, and 2002-236334.

In order to control images to specified color tones, it is preferable that various color leuco dyes are employed individually or in combinations of a plurality of types. In the present invention, for minimizing excessive yellowish color tone due to the use of highly active reducing agents, as well as excessive reddish images especially at a density of at least 2.0 due to the use of minute silver halide grains, it is preferable to employ leuco dyes which change to cyan. Further, in order to achieve precise adjustment of color tone, it is further preferable to simultaneously use yellow leuco dyes and other leuco dyes which change to cyan.

It is preferable to appropriately control the density of the resulting color while taking into account the relationship with the color tone of developed silver itself. In this invention, dye formation is performed so as to have a reflection density of 0.01 to 0.05 or a transmission density of 0.005 to 0.50, and the image tone is adjusted so as to form images exhibiting tone falling within the foregoing tone range. In the present invention, color formation is performed so that the sum of maximum densities at the maximum adsorption wavelengths of dye images formed by leuco dyes is customarily 0.01 to 0.50, is preferably 0.02 to 0.30, and is most preferably 0.03 to 0.10. Further, it is preferable that images be controlled within the preferred color tone range described below.

In this invention, particularly preferably employed as yellow forming leuco dyes are color image forming agents represented by the following formula (YA) which increase absorbance between 360 and 450 nm via oxidation: 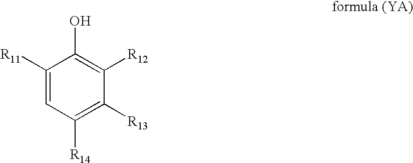
wherein R₁₁ is a substituted or unsubstituted alkyl group; R₁₂ is a hydrogen atom or a substituted or unsubstituted alkyl or acyl group, provided that R₁₁ and R₁₂ are not 2-hydroxyphenylmethyl; R₁₃ is a hydrogen atom or a substituted or unsubstituted alkyl group; R₁₄ is a group capable of being substituted on a benzene ring.

The compounds represented by formula (YA) will now be detailed. In the Formula (YA), R₁₁ is a substituted or unsubstituted alkyl group, provided that when R₁₂ is a substituent other than a hydrogen atom, R₁₁ is an alkyl group. In the foregoing formula (YA), the alkyl groups represented by R₁ are preferably those having 1 to 30 carbon atoms, which may have a substituent. Specifically preferred is methyl, ethyl, butyl, octyl, i-propyl, t-butyl, t-octyl, t-pentyl, sec-butyl, cyclohexyl, or 1-methyl-cyclohexyl. Groups (i-propyl, i-nonyl, t-butyl, t-amyl, t-octyl, cyclohexyl, 1-methyl-cyclohexyl or adamantyl) which are three-dimensionally larger than i-propyl are preferred. Of these, preferred are secondary or tertiary alkyl groups and t-butyl, t-octyl, and t-pentyl, which are tertiary alkyl groups, are particularly preferred. Examples of substituents which R₁ may have include a halogen atom, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group, and a phosphoryl group.

R₁₂ represents a hydrogen atom, a substituted or unsubstituted alkyl group, or an acylamino group. The alkyl group represented by R₂ is preferably one having 1-30 carbon atoms, while the acylamino group is preferably one having 1-30 carbon atoms. Of these, description for the alkyl group is the same as for aforesaid R₁₁.

The acylamino group represented by R₂ may be unsubstituted or have a substituent. Specific examples thereof include an acetylamino group, an alkoxyacetylamino group, and an aryloxyacetylamino group. R₁₂ is preferably a hydrogen atom or an unsubstituted group having 1 to 24 carbon atoms, and specifically listed are methyl, i-propyl, and t-butyl. Further, neither R₁ nor R₂ is a 2-hydroxyphenylmethyl group.

R₁₃ represents a hydrogen atom, and a substituted or unsubstituted alkyl group. Preferred as alkyl groups are those having 1 to 30 carbon atoms. Description for the above alkyl groups is the same as for R₁₁. Preferred as R₁₃ are a hydrogen atom and an unsubstituted alkyl group having 1 to 24 carbon atoms, and specifically listed are methyl, i-propyl and t-butyl. It is preferable that either R₁₂ or R₁₃ represents a hydrogen atom.

R₁₄ represents a group capable of being substituted to a benzene ring, and represents the same group which is described for substituent R₄, for example, in aforesaid Formula (RED). R₄ is preferably a substituted or unsubstituted alkyl group having 1 to 30 carbon atoms, as well as an oxycarbonyl group having 2 to 30 carbon atoms. The alkyl group having 1 to 24 carbon atoms is more preferred. As substituents of the alkyl group are cited an aryl group, an amino group, an alkoxy group, an oxycarbonyl group, an acylamino group, an acyloxy group, an imido group, and a ureido group. Of these, more preferred are an aryl group, an amino group, an oxycarbonyl group, and an alkoxy group. The substituent of the alkyl group may be substituted with any of the above alkyl groups.

Among the compounds represented by the foregoing formula (YA), preferred compounds are bis-phenol compounds represented by the following formula (YB): 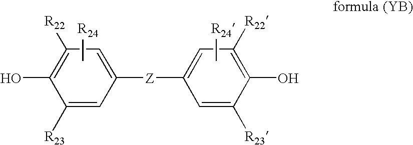
wherein, −0269 Z represents a —S— or —C(R₂₁) (R_{21′})-group. R₂₁ and R_{21′} each represent a hydrogen atom or a substituent. The substituents represented by R₂₁ and R_{21′}, are the same substituents listed for R₂₁ in the aforementioned Formula (RED). R₂₁ and R_{21′}, are preferably a hydrogen atom or an alkyl group.

R₂₂, R₂₃, R_{22′} and R₂₃′ each represent a substituent. The substituents represented by R₂₂, R₂₃, R₂₂′ and R₂₃′ are the same substituents listed for R₂ and R₃ in the afore-mentioned formula (1). R₂₂, R₂₃, R₂₂′ and R₂₃′ are preferably, an alkyl group, an alkenyl group, an alkynyl group, an aryl group, a heterocyclic group, and more preferably, an alkyl group. Substituents on the alkyl group are the same substituents listed for the subsitituents in the aforementioned Formula (RD1). R₂₂, R₂₃, R₂₂′ and R₂₃′ are more preferably tertiary alkyl groups such as t-butyl, t-amino, t-octyl and 1-methyl-cyclohexyl.

R₂₄ and R₂₄, each represent a hydrogen atom or a substituent, and the substituents are the same substituents listed for R₄ in the afore-mentioned formula (RD1).

Examples of the bis-phenol compounds represented by the formulas (YA) and (YB) are, the compounds disclosed in JP-A No. 2002-169249, Compounds (II-1) to (II-40), paragraph Nos. [0032]-]0038]; and EP 1211093, Compounds (ITS-1) to (ITS-12), paragraph No. [0026].

Specific examples of bisphenol compounds represented by formulas (Ya) and (YB) are shown below.

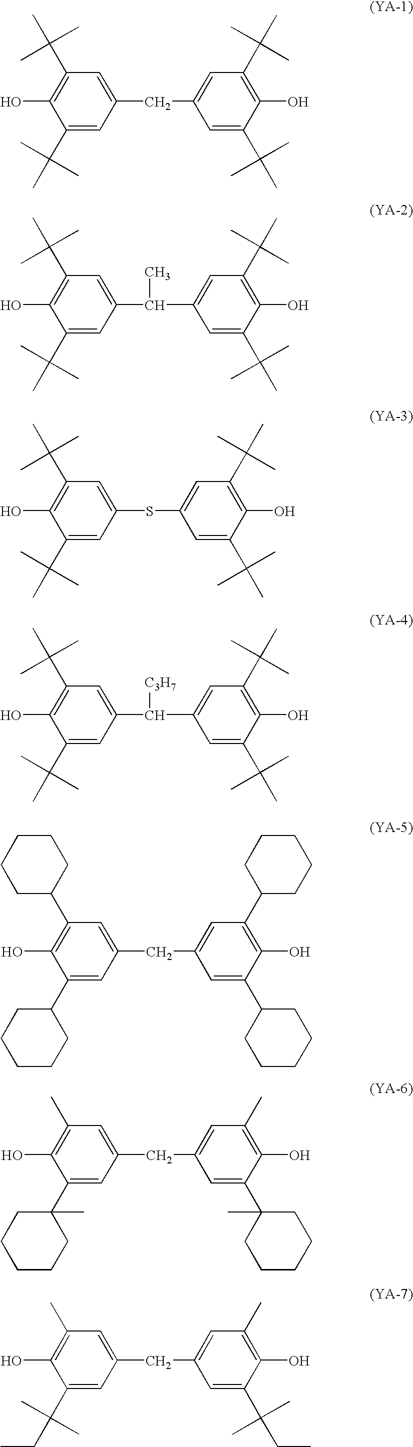

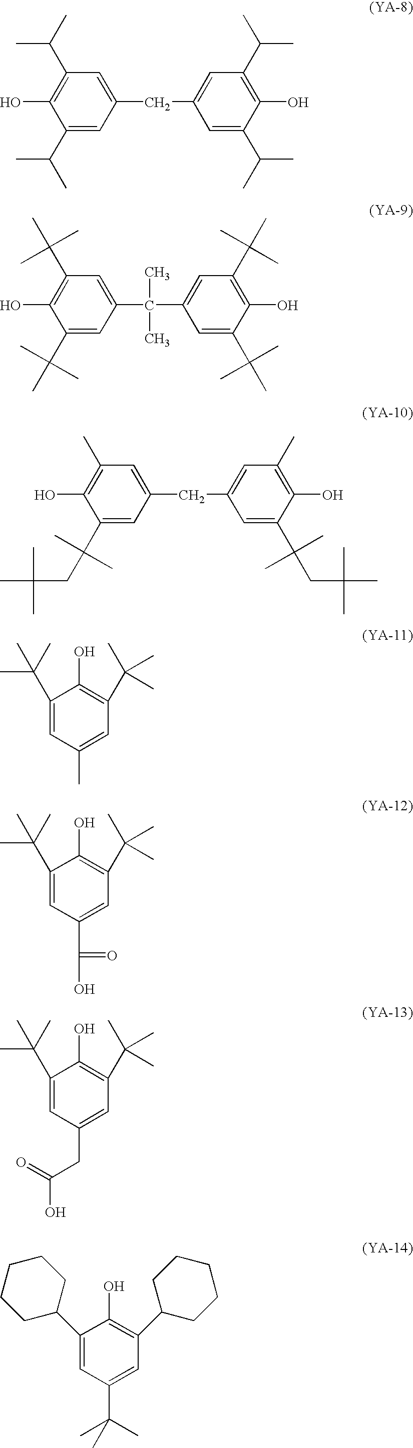

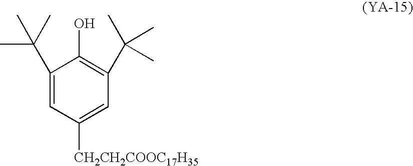

An amount of an incorporated compound represented by formula (YA), which is hindered phenol compound and include compound of formula (YB), is; usually, 0.00001 to 0.01 mol, and preferably, 0.0005 to 0.01 mol, and more preferably, 0.001 to 0.008 mol per mol of Ag.

A yellow dye forming leuco dye is incorporated preferably in a molar ratio of 0.00001 to 0.2, and more preferably 0.005 to 0.1, based on the total amount of reducing agents of formulas (RD1) and (RD2).

Besides the foregoing yellow dye forming leuco dyes, cyan dye forming leuco dyes are also usable in a photothermographic material to control image tone.

Cyan dye forming leuco dyes will be described hereinafter. A leuco dye is preferably a colorless or slightly colored compound which is capable of forming color upon oxidation when heated at 80 to 200° C. for 5 to 30 sec. There is also usable any leuco dye capable of forming a dye upon oxidation by silver ions. A compound which is sensitive to pH and being oxidized to a colored form.

Cyan forming leuco dyes will now be described. In the present invention, particularly preferably employed as cyan forming leuco dyes are color image forming agents which increase absorbance between 600 and 700 nm via oxidation, and include the compounds described in JP-A No. 59-206831 (particularly, compounds of λmax in the range of 600-700 nm), compounds represented by formulas (I) through (IV) of JP-A No. 5-204087 (specifically, compounds (1) through (18) described in paragraphs [0032] through [0037]), and compounds represented by formulas 4-7 (specifically, compound Nos. 1 through 79 described in paragraph [0105]) of JP-A No. 11-231460.

A cyan dye forming leuco dye represented by the following formula (CL) is specifically preferred: 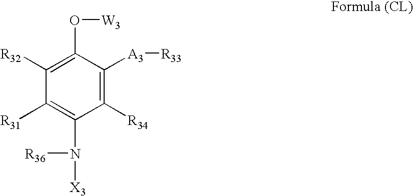
wherein R₃₁ and R₃₂ each represent a hydrogen atom, a substituted or unsubstituted alkyl group, an NHCO-R₃₀ group wherein R₃₀ is an alkyl group, an aryl group, or a heterocyclic group, while R₃₁ and R₃₂ may bond to each other to form an aliphatic hydrocarbon ring, an aromatic hydrocarbon ring, or a heterocyclic ring; A₃ represents-NHCO—, —CONH—, or —NHCONH—; R₃₃ represents a substituted or unsubstituted alkyl group, an aryl group, or a heterocyclic group, or -A-R₃₃ is a hydrogen atom; W represents a hydrogen atom or a —CONHR₅-group, —COR₃₅ or a —CO—O—R₃₅ group wherein R₃₅ represents a substituted or unsubstituted alkyl group, an aryl group, or a heterocyclic group; R₃₄ represents a hydrogen atom, a halogen atom, a substituted or unsubstituted alkyl group, an alkoxy group, a carbamoyl group, or a nitrile group; R₃₆ represents a —CONH—R₃₇ group, a —CO—R₃₇ group, or a —CO—O—R₃₇ group wherein R₃₇ is a substituted or unsubstituted alkyl group, an aryl group, or a heterocyclic group; and X₃ represents a substituted or unsubstituted aryl group or a heterocyclic group.

In the foregoing formula (CL), halogen atoms of R₃₁ and R₃₂ include fluorine, bromine, and chlorine; alkyl groups include those having at most 20 carbon atoms (methyl, ethyl, butyl, or dodecyl); alkenyl groups include those having at most 20 carbon atoms (vinyl, allyl, butenyl, hexenyl, hexadienyl, ethenyl-2-propenyl, 3-butenyl, 1-methyl-3-propenyl, 3-pentenyl, or 1-methyl-3-butenyl); alkoxy groups include those having at most 20 carbon atoms (methoxy or ethoxy). Alkyl groups of R₃₀ of —NHCO—R₃₀ include those having at most 20 carbon atoms (methyl, ethyl, butyl, or dodecyl), aryl groups include those having 6-20 carbon atoms such as a phenyl group or a naphthyl group; heterocyclic groups include each of thiophene, furan, imidazole, pyrazole, and pyrrole groups. R₃₃ represents an alkyl group (preferably having at most 20 carbon atoms such as methyl, ethyl, butyl, or dodecyl), an aryl group (preferably having 6 to 20 carbon atoms, such as phenyl or naphthyl), or a heterocyclic group (thiophene, furan, imidazole, pyrazole, or pyrrole). In a —CONHR₃₅ group, a —CO—R₃₅ group or a —CO—OR₃₅ of W₃, R₃₅ represents an alkyl group (preferably having at most 20 carbon atoms, such as methyl, ethyl, butyl, or dodecyl), an aryl group (preferably having 6 to 20 carbon atoms, such as phenyl or naphthyl), or a heterocyclic group (such as thiophene, furan, imidazole, pyrazole, or pyrrole).

R₃₄ is a hydrogen atom, a halogen atom (e.g., fluorine, chlorine, bromine, iodine), a chained or cyclic alkyl group (e.g., methyl, butyl dodecyl, or cyclohexyl), an alkenyl group having at most 20 carbon atoms (e.g., vinyl, allyl, butenyl, hexenyl, hexadienyl, ethenyl-2prpenyl, 3-butenyl, 1-methyl-3-propenyl, 3-pentenyl, 1-methyl-3-butenyl), an alkoxy group (e.g., methoxy, butoxy, or tetradecyloxy), a carbamoyl group (e.g., dimethylcarbamoyl, phenylcarbamoyl group), and a nitrile group. Of these, a hydrogen atom and an alkyl group are more preferred. R₃₃ and R₃₄ combine with each other to form a ring structure. The foregoing groups may have a single substituent or a plurality of substituents. Typical example of substituents include a halogen atom (e.g., fluorine, chlorine, or bromine atom), an alkyl group (e.g., methyl, ethyl, propyl, butyl, or dodecyl), hydroxyl group, cyan group, nitro group, an alkoxy group (e.g., methoxy or ethoxy), an alkylsulfonamide group (e.g., methylsulfonamido or octylsulfonamido), an arylsulfonamide group (e.g., phenylsulfonamido or naphthylsulfonamido), an alkylsulfamoyl group (e.g., butylsulfamoyl), an arylsulfamoyl group (e.g., phenylsulfamoyl), an alkyloxycarbonyl group (e.g., methoxycarbonyl), an aryloxycarbonyl group (e.g., phenyloxycarbonyl), an aminosulfonamide group, an acylamino group, a carbamoyl group, a sulfonyl group, a sulfinyl group, a sulfoxy group, a sulfo group, an aryloxy group, an alkoxy group, an alkylcarbonyl group, an arylcarbonyl group, or an aminocarbonyl group.

Either R₃₀ or R₃₅ is preferably a phenyl group, and more preferably a phenyl group having a plurality of substituents of a halogen atom or a cyano group. R₃₆ is a —CONH—R₈₇ group, a —CO—R₈₇ group, or —CO—O—R₈₇ group, wherein R₈₇ is an alkyl group (preferably having at most 20 carbon atoms, such as methyl, ethyl, butyl, or dodecyl), an aryl group (preferably having 6 to 20 carbon atoms, such as phenyl, naphthol, or thienyl), or a heterocyclic group (thiophene, furan, imidazole, pyrazole, or pyrrole). Substituents of the alkyl group represented by R₈₇ may be the same ones as substituents in R₃₁ to R₃₄.

X₃ represents an aryl group or a heterocyclic group. These aryl groups include groups having 6 to 20 carbon atoms such as phenyl, naphthyl, or thienyl, while the heterocyclic groups include any of the groups such as thiophene, furan, imidazole, pyrazole, or pyrrole. Substituents which may be substituted to the group represented by X₃ may be the same ones as the substituents in R₃₁ to R₃₄. As the groups represented by X₃ are preferred an aryl group, which is substituted with an alkylamino group (a diethylamino group) at the para-position, or a heterocyclic group.

The foregoing groups may further contain photographically useful groups.

Specific examples of a cyan dye forming leuco dye (CL) are shown below but cyan dye forming leuco dyes usable in this invention are not limited to these.

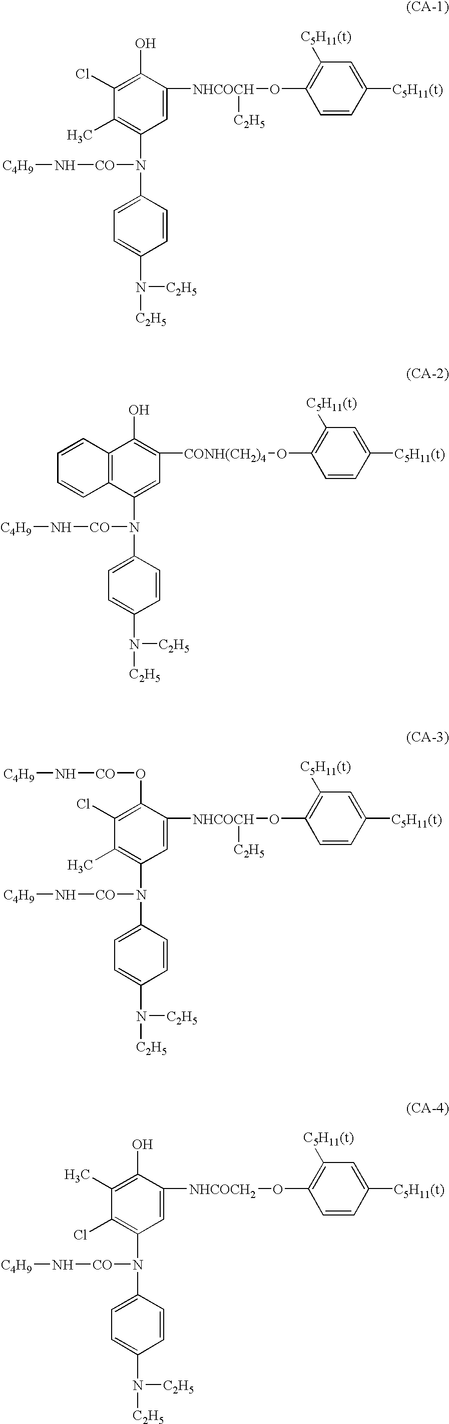

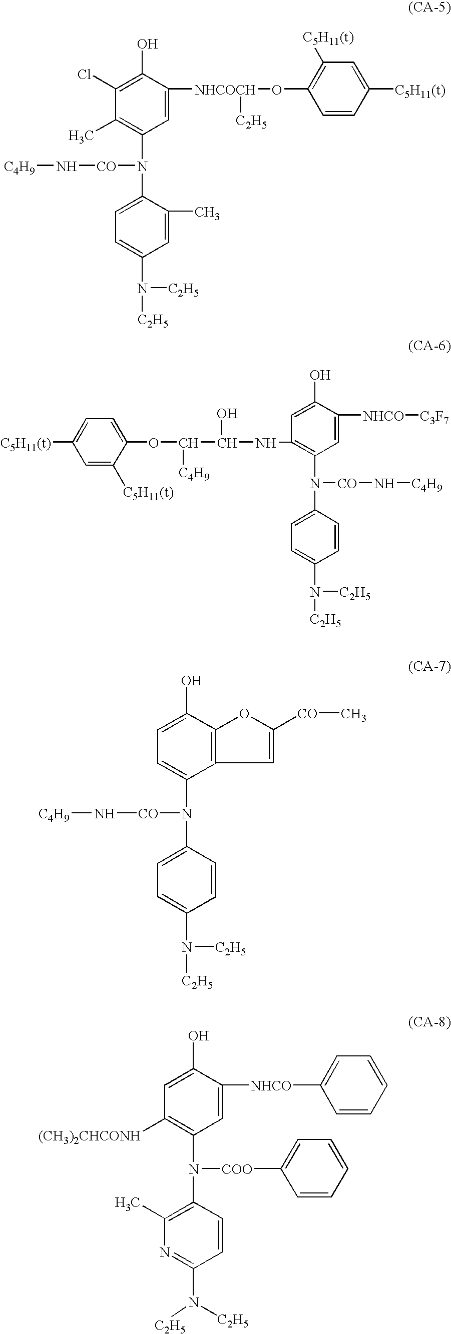

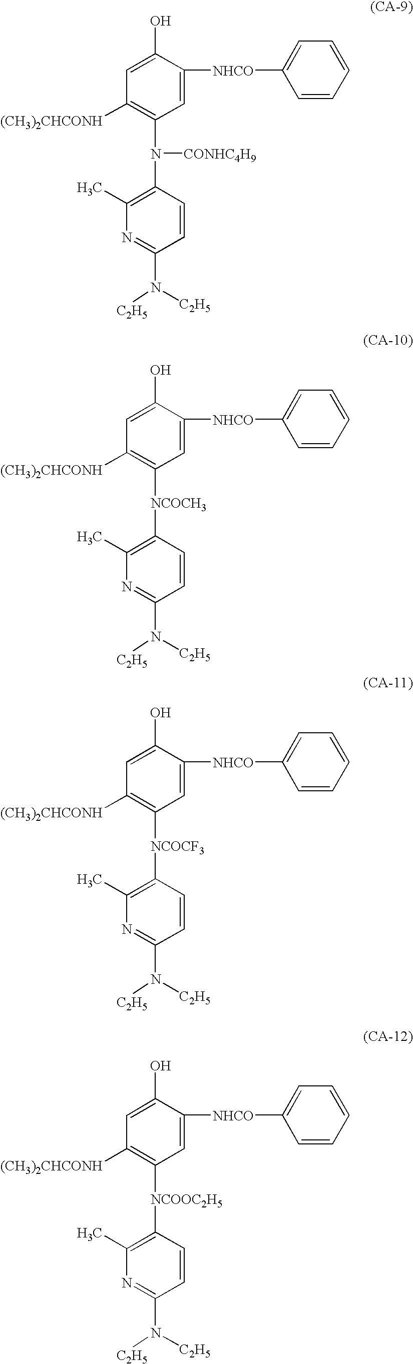

The addition amount of cyan forming leuco dyes is usually 0.00001 to 0.05 mol/mol of Ag, preferably 0.0005 to 0.02 mol/mol, and more preferably 0.001 to 0.01 mol. A cyan forming leuco dye is incorporated preferably in a molar ratio of 0.00001 to 0.2, and more preferably 0.005 to 0.1, based on the total amount of reducing agents of formulas (1) and (2). The cyan dye is preferably formed so that the sum of the maximum density at the absorption maximum of a color image formed by a cyan forming leuco dye is preferably 0.01 to 0.50, more preferably 0.02 to 0.30, and still more preferably 0.03 to 0.10.

In addition to the foregoing cyan forming leuco dye, magenta color forming leuco dyes or yellow color forming leuco dyes may be used to control delicate color tone.

The compounds represented by the foregoing formulas (YA) and (YB) and cyan forming leuco dyes may be added employing the same method as for the reducing agents represented by the foregoing formula (RD1). They maybe incorporated in liquid coating compositions employing an optional method to result in a solution form, an emulsified dispersion form, or a minute solid particle dispersion form, and then incorporated in a photosensitive material.

It is preferable to incorporate the compounds represented by formulas (RD1) and (RD2), formulas (YA) and (YB), and cyan forming leuco dyes into an image forming layer containing organic silver salts. On the other hand, the former may be incorporated in the image forming layer, while the latter may be incorporated in a non-image forming layer adjacent to the aforesaid image forming layer.

Alternatively, both may be incorporated in the non-image forming layer. Further, when the image forming layer is comprised of a plurality of layers, incorporation may be performed for each of the layers.

The photothermographic material of this invention may contain a binder in the light-sensitive layer or the light-insensitive layer.

Suitable binders for the silver salt photothermographic material are to be transparent or translucent and commonly colorless, and include natural polymers, synthetic resin polymers and copolymers, as well as media to form film, for example, those described in paragraph [0069] of JP-A No. 2001-330918. Preferable binders for the light-sensitive layer of the photothermographic material of this invention are poly(vinyl acetals), and a particularly preferable binder is poly(vinyl butyral).

Of these, for example, methacrylic acid alkyl esters, methacrylic acid aryl esters, and styrenes are preferred. Specifically, polymer compounds containing an acetal group are preferred. Of polymer compounds containing an acetal group, polyvinyl acetal having an acetoacetal structure is more preferred and examples thereof include polyvinyl acetals described in U.S. Pat. Nos. 2,358,836, 3,003,879 and 2,828,204 and British Patent No. 771,155. Further, The polymer compound containing an acetal group is also preferably a compound represented by formula (V) described in JP-A no. 2002-287299, paragraph [150].

The binder used in the light-sensitive layer is preferably polyvinyl acetals, and polyvinyl butyral is specifically preferred as a main binder. The main binder means that the foregoing polymer accounts for at least 50% by weight of the total binder of the light-sensitive layer. Accordingly, other binders may be blended at less than 50% by weight. Such binders are soluble in solvents in which the foregoing binder is soluble, and preferably polyvinyl acetate, acryl resin or urethane resin.

The glass transition temperature (Tg) of a binder used in the invention is preferably 70 to 105° C. to obtain a sufficient maximum density in image formation. The number-average molecular weight of the binder is preferably 1,000 to 1,000,000, more preferably 10,000 to 500,000; and the degree of polymerization is in the range of 50 to 1,000.

A polymer exhibiting a relatively high softening poin, such as cellulose esters, e.g., cellulose triacetate or cellulose acetate butyrate, is preferred for the over-coat or sub-coat layer, specifically a protective layer or a back-coat layer. Two or more kinds of binders may optionally be used in combination.

Such a binder is used within the effective range capable of functioning as a binder. The effective range can easily be determined by one skilled in the art. In the light-sensitive layer (or image forming layer), for example, the weight ratio of a binder to organic silver salt is preferably from 5:1 to 1:2, and more preferably from 8:1 to 1:1 to hold the organic silver salt in the layer. Thus, the amount of a binder of the light-sensitive layer is preferably from 1.5 to 6.0 g/m² and more preferably 1.7 to 5.0 g/m². An amount of less than 1.5 g/m² results in an increased density of the unexposed area at a level unacceptable in practice.

The image forming layer may contain an organic gelling agent. The organic gelling agent refers to a compound which provides its system a yield point when incorporated to organic liquid and having a function of disappearing or lowering fluidity.

In one preferred embodiment of this invention, a coating solution for the image forming layer contains an aqueous-dispersed polymer latex. The aqueous-dispersed polymer latex accounts for preferably at least 50% by weight of the whole binder of the coating solution. The polymer latex preferably accounts for at least 50% by weight of the whole binder of the image forming layer, and more preferably at least 70% by weight. The polymer latex is a dispersion in which a water-insoluble hydrophobic polymer is in the form of minute particles dispersed in aqueous dispersing medium. The polymer may be dispersed in any form, such as being emulsified in the dispersing medium, being emulsion-polymerized, being dispersed in the form of micelles or a polymer partially having a hydrophilic structure in the molecule and its molecular chain being molecularly dispersed.

Polymer latex usable in the photothermographic material of this invention may be not only conventional polymer latex having a uniform structure but also a so-called core/shell type latex. In this regard, core and shell which differ in Tg, are occasionally preferred. The minimum film-forming temperature (MFT) of a polymer latex relating to this invention is preferably from −30 to 90° C., and more preferably 0 to 70° C. There may be added a film-forming aid to control the minimum film-forming temperature.

Polymer species used in polymer latex include, for example, acryl resin, vinyl acetate resin, polyester resin, polyurethane resin, rubber type resin, vinyl chloride resin, vinylidene chloride resin, polyolefin resin and their copolymers. The equilibrium moisture content of a polymer latex is preferably from 0.01% to 2% by weight at 25° C. and 60% RH (relative humidity), and more preferably 0.01% to 1%. The definition and measurement of the equilibrium moisture content is referred to, for example, “Kobunshi-Kogaku Koza 14, Kobunshi-Shikenho” (edited by Kobunshi Gakkai, Chijin Shoin).

Specific examples of polymer latex include those described in JP-A No. 2002-287299, {0173}. These polymers may be used singly or in their combination as a blend. A carboxylic acid component as a polymer specie, such as an acrylate or methacrylate component, is contained preferably in an amount of 0.1 to 10% by weight.

A hydrophilic polymer such as gelatin, polyvinyl alcohol, methyl cellulose, hydroxypropyl cellulose, carboxymethyl cellulose, or hydroxypropyl cellulose may optionally be incorporated within the range of not more than 50% by weight of the whole binder. The hydrophilic polymer content is preferably not more than 30% by weight of the image forming layer.

In the preparation of a coating solution for the image forming layer, an organic silver salt and an aqueous-dispersed polymer latex may be added in any order. Thus, either one may be added at first or both may be added simultaneously, but the polymer latex is added preferably later.

The light-sensitive layer may contains cross-linking agents capable of binding binder molecules through cross linking. It is known that employing cross-linking agents in the aforesaid binders minimizes uneven development, due to the improved adhesion of the layer to the support. In addition, it results in such effects that fogging during storage is minimized and the creation of printout silver after development is also minimized.

There may be employed, as cross-linking agents used in this invention, various conventional cross-linking agents, which have been employed for silver halide photosensitive photographic materials, such as aldehyde type, epoxy type, ethyleneimine type, vinylsulfone type, sulfonic acid ester type, acryloyl type, carbodiimide type, and silane compound type cross-linking agents, which are described in JP-A No. 50-96216. Of these, isocyanate type compounds, silane type compounds, epoxy type compounds and acid anhydride are preferred.

Incidentally, adducts of an isocyanate with a polyalcohol are capable of markedly improving the adhesion between layers and further of markedly minimizing layer peeling, image dislocation, and air bubble formation. Such isocyanates may be incorporated in any portion of the silver salt photothermographic material. They may be incorporated in, for example, a support (particularly, when the support is paper, they may be incorporated in a sizing composition), and optional layers such as a photosensitive layer, a surface protective layer, an interlayer, an antihalation layer, and a subbing layer, all of which are placed on the photosensitive layer side of the support, and may be incorporated in at least two of the layers.

Further, as thioisocyanate based cross-linking agents usable in the present invention, compounds having a thioisocyanate structure corresponding to the isocyanates are also useful as thioisocyanate based cross-linking agents usable in the present invention.

The amount of the cross-linking agents employed in the present invention is in the range of 0.001 to 2.000 mol per mol of silver, and is preferably in the range of 0.005 to 0.500 mol.

Isocyanate compounds as well as thioisocyanate compounds, which may be incorporated in the present invention, are preferably those which function as the cross-linking agent. However, it is possible to obtain the desired results by employing compounds which have “v” of 0, namely compounds having only one functional group.

Examples of silane compounds which can be employed as a cross-linking agent in this invention are compounds represented by General formulas (1) to (3), described in JP-A No. 2001-264930.

Compounds, which can be used as a cross-linking agent, may be those having at least one epoxy group. The number of epoxy groups and corresponding molecular weight are not limited. It is preferable that the epoxy group be incorporated in the molecule as a glycidyl group via an ether bond or an imino bond. Further, the epoxy compound may be a monomer, an oligomer, or a polymer. The number of epoxy groups in the molecule is commonly from about 1 to about 10, and is preferably from 2 to 4. When the epoxy compound is a polymer, it may be either a homopolymer or a copolymer, and its number average molecular weight Mn is most preferably in the range of about 2,000 to about 20,000.

Acid anhydrides usable in this invention are compounds containing at least one acid anhydride group having a structure, as shown below:
—CO—O—CO—.

Any compound containing such at least one acid anhydride group is not limited with respect to the number of acid anhydride groups, molecular weight and others.

The foregoing epoxy compounds or acid anhydrides may be used singly or in combination. The addition amount is preferably 1×10⁻⁶ to 1×10⁻² mol/m², and more preferably 1×10⁻⁵ to 1×10^{31 3} mol/m². The epoxy compounds or acid anhydrides may be incorporated into any layer of the light-sensitive layer side, such as a light-sensitive layer, surface protective layer, an interlayer, an antihalation layer or a sublayer. The compounds may be incorporated into one or more of these layers.

A silver saving agent may be incorporated to the light-sensitive or light-insensitive layer. The silver saving agent refers to a compound which is capable of lessen a silver amount necessary to obtain a prescribed silver image density.

Various mechanisms of working have been assumed with respect to function of lessen the silver amount but a compound capable of enhancing covering power of developed silver is preferred. The covering power of developed silver refers to an optical density per unit amount of silver. Silver saving agents may be incorporated to a light-sensitive layer or a light-insensitive layer, or to both layers. Examples of a silver saving agent include a hydrazine derivative compound, a vinyl compound, a phenol compound, a naphthol compound, a quaternary onium compound and a silane compound. Specific examples thereof include silver saving agents described in JP-A No. 2003-270755, paragraph [0195]-[0235].

In this invention, specifically preferred silver saving agents are compounds represented by the following formula (SE1) or (SE2).

The compound of formula (SE1) is represented as follows:
Q₁-NHNH-Q₂ Formula (SE1).
wherein Q₁ is an aromatic or heterocyclic group bonding at a carbon atom to —NHNH-Q₂; Q₂ is a carbamoyl group, an acyl group, an alkoxycarbonyl group, an aryloxycarbonyl group, a sulfonyl group or a sulfamoyl group.

In the formula (SE1), an aromatic or heterocyclic group represented by Q₁ is preferably a 5- to 7-membered unsaturated ring. Preferred examples thereof include a benzene ring, a pyridine ring, a pyrazine ring, pyrimidine ring, pyridazine ring, 1,2,4-triazine ring, 1,2,40triazine ring, 1,3,5-triazine ring, pyrrole ring, animidazole ring, a pyrazole ring, 1,2,3-triazole ring, 1,2,4-triazole ring, tetrazole ring, 1,3,4-thiadizole ring, 1,2,4-thiadiazole ring1,2,5-thiadiazole ring, 1,3,4-oxadiazole ring, 1,2,4-oxadiazole ring, 1,2,5-oxadiazole ring, a thiazole ring, oxazole ring, isothiazole ring, isooxazole ring, and a thiophene ring. These rings may be combined with each other to form a condensed ring and such a condensed ring is also preferable.

The compound represented by the formula (SE2) is as follows: 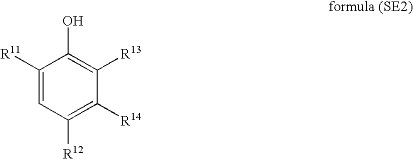
wherein R₁₁ is an alkyl group, an acyl group, an acylamino group, a sulfonamide group, an alkoxycarbonyl group or a carbamoyl group; R₁₂ is a hydrogen atom, an alkyl group, an alkoxy group, an aryloxy group, an alkylthio group, an arylthio group, an acyloxy group, or a carboxylic acid ester group; R₁₃ and R₁₄ are each a group capable of being substituted on a benzene ring, as cited in examples of a substituent of the foregoing formula (SE1), provided that R₁₃ and R₁₄ may combine with each other to form a ring.

In the formula (SE2), when R₁₃ and R₁₄ combine with each other to form a condensed ring, the condensed ring is preferably a naphthalene ring. When a compound of formula (SE2) is a naphthol type compound, R₁₁ is preferably a carbamoyl group and more preferably a benzoyl group. R₁₃ is preferably an alkoxy group or aryloxy group and more preferably an alkoxy group.

The photothermographic material of this invention preferably contains a thermal solvent. In this invention, the thermal is defined as a material capable of lowering the thermal development temperature of a thermal solvent-containing photothermographic material by at least 1° C. (preferably at least 2° C., and more preferably at least 3° C.), as compared to a photothermographic material containing no thermal solvent. For example, a density obtained by developing a photothermographic material (B) containing no thermal solvent at 120° C. for 20 sec., can be obtained by developing a photothermographic material (A) in which a thermal solvent is added to the photothermographic material (B), at a temperature of 119° C. or less for the period of the same time as the photothermographic material (B).

A thermal solvent contains a polar group and is preferably a compound represented by the following formula (TS):
(Y)ₙZ formula (TS)
wherein Y is a group selected from an alkyl group, an alkenyl group, an alkynyl group, an aryl group or a heterocyclic group; Z is hydroxyl, carboxyl, an amino group, an amide group, a sulfonamido group, a phosphoric acid amide, cyano, imide, ureido, sulfonoxide, sulfone, phosphine, phosphineoxide and nitrogen-containing heterocyclic group; n is an integer of 1 to 3, provided that when Z is a mono-valent, n is 1 and when Z has a valence of two or more, n is the same as a valence number of Z, and when n is 2 or more, Ys may be the same or different.

Y may be substituted and examples of a substituent may be the same as represented by Z described above. In the formula (TS), Y is a straight, branched or cyclic alkyl group (preferably having 1-40 carbon atoms, more preferably 1-30, still more preferably 1-25 carbon atoms, e.g., methyl, ethyl, propyl, isopropyl, sec-butyl, tert-butyl, t-octyl, n-amyl, t-amyl, n-dodecyl, n-tridecyl, octadecyl, icosyl, docosyl, cyclopentyl, cyclohexyl), alkenyl group (preferably having 2-40 carbon atoms, more preferably 2-30, still more preferably 2-25 carbon atoms, e.g., vinyl, allyl, 2-butenyl, 3-pentenyl), aryl group (preferably having 6-40 carbon atoms, more preferably 6-30, still more preferably 6-25 carbon atoms, e.g., phenyl, p-methylphenyl, naphthyl), heterocyclic group preferably having 2-20 carbon atoms, more preferably 2-16, still more preferably 2-12 carbon atoms, e.g., pyridyl, pyrazyl, imidazolyl, pyrrolidyl). These substituents may be substituted and substituents may combine with each other to form a ring.

Y may be substituted and as examples of a substituent are cited those described in JP-A No. 2004-21068, paragraph [0015]. It is assumed, as the reason for the use of a thermal solvent activating development that the thermal solvent melts at a temperature near a development temperature and solubilizes a material participating in development, rendering a reaction feasible at a temperature lower than the case containing no thermal solvent. Thermal development is a reduction reaction in which a carboxylic acid having a relatively high polarity or a silver ion carrier is involved. It is therefore preferred that a reaction field exhibiting an appropriate polarity is formed by a thermal solvent having a polar group.

The melting point of a thermal solvent is preferably 50 to 200° C., and more preferably 60 to 150° C. The melting point is preferably 100 to 150° C. specifically in a photothermographic material which places primary importance on stability to external environments, such as image fastness.

Specific examples of a thermal solvent include compounds described in JP-A No. 2004-21068, paragraph [0017] and compounds MF-1 through MF-3, MF-6, MF-7, MF-9 through MF-12 and MF-15 through MF-22.

A thermal solvent is contained preferably at 0.01 to 5.0 g/m², more preferably 0.05 to 2.5 g/m², and still more preferably 0.1 to 1.5 g/m². Thermal solvents may be contained singly or in combination thereof. A thermal solvent may be added to a coating solution in any form, such as a solution, emulsion or solid particle dispersion.

There is known a method in which a thermal solvent is dissolved using oil such as dibutyl phthalate, tricresyl phosphate, glyceryl triacetate or diethyl phthalate, and optionally an auxiliary solvent such as diethyl acetate or cyclohexanone, and is mechanically dispersed to obtain an emulsified dispersion.

Solid particle dispersion is prepared by dispersing powdery thermal solvent in an appropriate solvent such as water using a ball mill, a colloid mill, a vibration ball mill, a jet mill, a roller mill or a ultrasonic homogenizer. A protective colloid (e.g., polyvinyl alcohol), a surfactant (e.g., anionic surfactants such as sodium triisbpropylnaphthalenesulfonate) may be used therein. In the foregoing mills, beads such as zirconia are usually used. Zr or the like is sometime dissolved out and mixed in the dispersion within a range of 1 to 1,000 ppm, depending dispersing conditions. A Zr content of 0.5 g or less per g of silver is acceptable to practical use. Aqueous dispersion preferably contains an antiseptic (e.g., benzoisothiazolinone sodium salt).

Any component layer of the photothermographic material of this invention preferably contains an antifoggant to inhibit fogging caused before being thermally developed and an image stabilizer to prevent deterioration of images after being thermally developed.

Next, there will be described an antifoggant and an image stabilizer usable in the photothermographic material of this invention.

Since bisphenols and sulfonamidophenols which contain a proton are mainly employed as a reducing agent, incorporation of a compound which generates reactive species capable of abstracting hydrogen is preferred to deactivate the reducing agent. It is also preferred to include a compound capable of oxidizing silver atoms or metallic silver (silver cluster) generated during storage of raw film or images. Specific examples of a compound exhibiting such a function include biimidazolyl compounds and iodonium compounds, as described in JP-A No. 2003-270755, paragraph [00961- [0128]. Further, compounds capable of releasing a halogen atom as a active specie. Examples of such compounds include a polymer comprised of at least a repeating unit of a monomer having a halogen radical releasing group, as described in JP-A 2003-91054; vinylsulfons and/or β-halosulfons, as described JP-A No. 6-208192; vinyl type inhibitors containing an electron-withdrawing group, as described in Japanese Patent Application publication No. 2004-234206.

In cases when a reducing agent used in this invention is a compound containing an aromatic hydroxyl group (OH), specifically bisphenols, it is preferred to use a non-reducible compound capable of forming a hydrogen bond with such a group, for example, compounds (II-1) to (II-40) described in JP-A No. 2002-90937, paragraph [0061]-[064].

A number of compounds capable of generating a halogen atom as reactive species are knows as an antifoggant or an image stabilizer. Specific examples of a compound generating an active halogen atom include compounds of formula (9) described in JP-A No. 2002-287299, paragraph [0264]-[0271]. These compounds are incorporated preferably at an amount within the range of an increase of printed-out silver formed of silver halide being ignorable. Thus, the ratio to a compound forming no active halogen radical is preferably at most 150%, more preferably at most 100%. Specific examples of a compound generating active halogen atom include compounds (III-1) to (III-23) described in paragraph [0086]-0087] of JP-A NO. 2002-169249; compounds 1-1a to 1-1o, and 1-2a to 1-2o described in paragraph [0031] to [0034] and compounds 2a to 2z, 2aa to 2ll and 2-1a to 2-1f described in paragraph [0050]-[0056] of JP-A No. 2003-50441; and compound 4-1 to 4-32 described in paragraph [0055] to [0058] and compounds 5-1 to 5-10 described in paragraph [0069] to [0072] of JP-A No. 2003-91054.

Examples of preferred antifoggants usable in this invention include compounds a to j described in [0012] of JP-A No. 8-314059, thiosufonate esters A to K described in [0028] of JP-A No. 7-209797, compounds (1) to (44) described on page 14 of JP-A No. 55-140833, compounds(I-1) to (I-6) described in [0063] and compounds (C-1) to (C-3) described in [0066] of JP-A No. 2001-13627, compounds (III-1) to ) III-108) described in [0027] of JP-A No. 2002-90937, vinylsulfone and/or β-halosulfone compounds VS-1 to VS-7 and HS-1 to HS-5 described in [0013] of JP-A No. 6-208192, sulfonylbenzotriazole compounds KS-1 to KS-8 described in JP-A No. 200-330235, substituted propenenitrile compounds PR-01 to PR-08 described in JP-A No. 2000-515995 (published Japanese translation of PCT international publication for patent application) and compounds (1)-1 to (1)-132 described in [0042] to [0051] of JP-A No. 2002-207273. The foregoing antifoggant is used usually in an amount of at least 0.001 mol per mol of silver, preferably from 0.01 to 5 mol, and more preferably from 0.02 to 0.6 mol.

Compounds commonly known as other than the foregoing compounds may be contained in the photothermographic material of this invention, which may be a compound capable of forming a reactive species or a compound exhibiting a different mechanism of antifogging. Examples of such compounds include those described in U.S. Pat. No. 3,589,903, 4,546,075 and 4,452,885; JP-A No. 59-57234; U.S. Pat. Nos. 3,874,946 and 4,756,999; JP-A No. 59-57234, 9-188328 and 9-90550. Further, other antifoggants include, for example, compounds described in U.S. Pat. No. 5,028,523 and European Patent No. 600,587, 605,981 and 631,176.

The photothermographic material of this invention forms a photographic image upon thermal development and preferably contains an image toning agent to control image color in the form of dispersion in (organic binder matrix.

Examples of suitable image toning agents are described in RD 17029, U.S. Pat. Nos. 4,123,282, 3,994,732 and 4,021,249. Specific examples include imides (e.g. succinimide, phthalimide, naphthalimide, N-hydroxy-1,8-naphthalimide), mercaptans (e.g., 3-mercapto-1,24-triazole), phthalazinone derivatives and their metal salts (e.g., phthalazinone, 4-(1-naphthyl)phthalazinone, 6-chlorophthalazinone, 5,7-dimethyloxyphthalazinone, 2,3-dihydroxy1,4-phthalazine-dione), combination of phthalazine and phthalic acids (e.g., phthalic acid, 4-methylphthalic acid, 4-nitrophthalic acid, tetrachlorophthalic acid); combination of phthalazine and a compound selected from maleic acid anhydride, phthalic acid, 2.3-naphthalenedicarboxylic acid and o-phenylene acid derivatives and their anhydrides (e.g., phthalic acid, 4-methylpthalic acid, 4-nitrophthalic acid, tetrachlorophthalic acid anhydride). Of these, a specifically preferred image toning agent is a combination of phthalazinone or phthalazine, and phthalic acids or phthalic acid anhydrides.

To improve film tracking characteristics of thermal development apparatus and environmental suitability (accumulativeness in organ), fluorinated surfactants represented by the following formula (SF) are preferably used:
[R_{f}-(L)ₙ-]ₚ-(Y)ₘ-(A)_{q} formula (SF)
wherein R_{f} represents a fluorine-containing substituent, L represents a bivalent linkage group containing no fluorine, Y represents a linkage group having a valence of (p+q) and containing no fluorine, A represents an anion or its salt, n and m are each an integer of 0 or 1, p is an integer of 1 to 3, q is an integer of 1 to 3, provided that when q is 1, n and m are not zero at the same time.

In the formula (SF), examples of R_{f} of a fluorine-containing substituent include a fluoroalkyl group having 1 to 25 carbon atoms (e.g., trifluoromethyl, trifluoroethyl, perfluoroethyl, perfluorobutyl, perfluorooctyl, perfluorododecyl, perfluorooctadecyl), and a fluoroalkenyl group (e.g., perfluoropropenyl, perfluorobutenyl, perfluorononenyl, perfluorododecenyl). R_{f} preferably contains 2 to 8 carbon atoms, and more preferably 2 to 6 carbon atoms. R_{f} preferably 2 to 12 fluorine atoms, and more preferably 3 to 12 fluorine atoms.

In the foregoing formula, L represents a bivalent, fluorine-free linkage group. Examples of divalent linking groups containing no fluorine atom include an alkylene group (e.g., a methylene group, an ethylene group, and a butylene group), an alkyleneoxy group (such as a methyleneoxy group, an ethyleneoxy group, or a butyleneoxy group), an oxyalkylene group (e.g., an oxymethylene group, an oxyethylene group, and an oxybutylene group), an oxyalkyleneoxy group (e.g., an oxymethyleneoxy group, an oxyethyleneoxy group, and an oxy ethyleneoxyethyleneoxy group), a phenylene group, and an oxyphenylene group, a phenyloxy group, and an oxyphenyloxy group, or a group formed by combining these groups.

In the foregoing formula, A represents an anion group or a salt group thereof. Examples include a carboxylic acid group or salt groups thereof (sodium salts, potassium salts and lithium salts), a sulfonic acid group or salt groups thereof (sodium salts, potassium salts and lithium salts), a sulfuric acid half ester group or salt group thereof (sodium salts, potassium salts and lithium salts) and a phosphoric acid group and salt groups thereof (sodium salts, potassium salts and lithium salts).

In the foregoing formula, Y represents a fluorine-free linkage group having a valence of (p+q). Examples thereof include trivalent or tetravalent linking groups having no fluorine atom, which are groups of atoms comprised of a nitrogen atom as the center; n1 is an integer of 0 or 1, and preferably 1.

The fluorinated surfactants represented by the foregoing formula (SF) are prepared as follows. Alkyl compounds having 1 to 25 carbon atoms into which fluorine atoms are introduced (e.g., compounds having a trifluoromethyl group, a pentafluoroethyl group, a perfluorobutyl group, a perfluorooctyl group, or a perfluorooctadecyl group) and alkenyl compounds (e.g., a perfluorohexenyl group or a perfluorononenyl group) undergo addition reaction or condensation reaction with each of the tri- to hexa-valent alkanol compounds into which fluorine atom(s) are not introduced, aromatic compounds having 3 or 4 hydroxyl groups or hetero compounds. Anion group (A) is further introduced into the resulting compounds (including alkanol compounds which have been partially subjected to introduction of R_{f}) employing, for example, sulfuric acid esterification.

Examples of the aforesaid tri- to hexa-valent alkanol compounds include glycerin, pentaerythritol, 2-methyl-2-hydroxymethyl-1,3-propanediol, 2,4-dihydroxy-3-hydroxymethylpentane, 1,2,6-hexanrtriol. 1,1,1-tris(hydroxymethyl)propane, 2,2-bis(butanol), aliphatic triol, tetramethylolmethane, D-sorbitol, xylitol, and D-mannitol. The aforesaid aromatic compounds, having 3-4 hydroxyl groups and hetero compounds, include, for example, 1,3,5-trihydroxybenzene and 2,4,6-trihydroxypyridine.

Specific examples of fluorinated surfactants of formula (SF) are sown below.

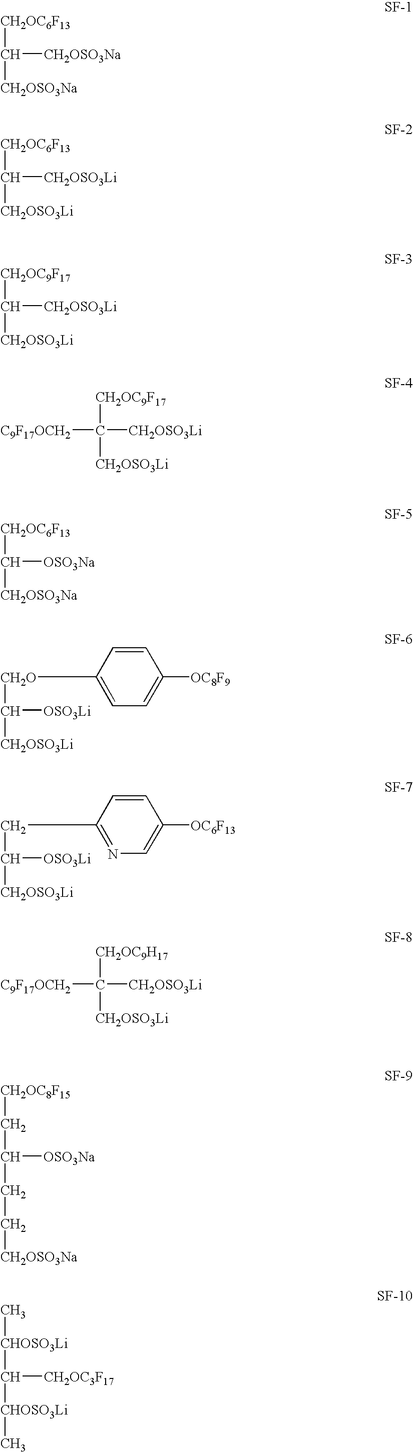

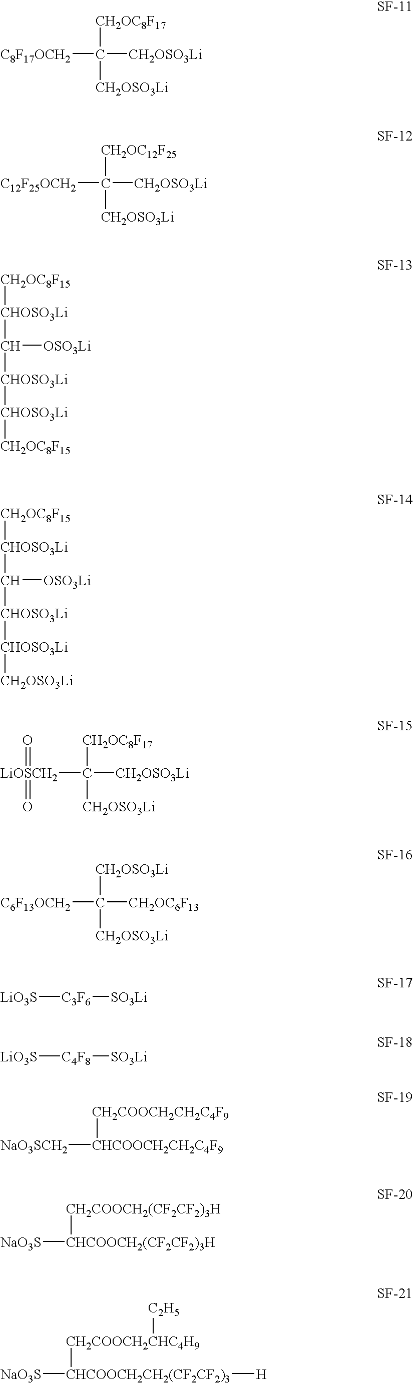

It is possible to add the fluorinated surfactants represented by the foregoing formula (SF) to liquid coating compositions, employing any conventional addition methods known in the art. Thus, they are dissolved in solvents such as alcohols including methanol or ethanol, ketones such as methyl ethyl ketone or acetone, and polar solvents such as dimethylformamide, and then added. Further, they may be dispersed into water or organic solvents in the form of minute particles at a maximum size of 1 μm, employing a sand mill, a jet mill, or an ultrasonic homogenizer and then added. Many techniques are disclosed for minute particle dispersion, and it is possible to perform dispersion based on any of these. It is preferable that the aforesaid fluorinated surfactants are added to the protective layer which is the outermost layer.

The added amount of the aforesaid fluorinated surfactants is preferably 1×10⁻⁸ to 1×10⁻¹ mol per m², more preferably 1×10⁻⁵ to 1×10⁻² mol per m². When the added amount is less than the lower limit, it is not possible to achieve desired charging characteristics, while it exceeds the upper limit, storage stability degrades due to an increase in humidity dependence.

Silver salt photothermographic material is often subject to undesirable effects caused by the photothermographic material being brought into contact with various devices at the time of wind-up, rewind or transport of the photothermographic material in the manufacturing process, such as coating, drying or converting. Such are scratch or a slippage mark on the photothermographic material surface or deteriorated transportability in a development apparatus.

To prevent flaws on the surface or deteriorated transportability, a lubricant or a matting agent may be incorporated to any one of constituent layers of the photothermographic material of the invention, specifically an uppermost layer on the support to control a physical property of the surface.

The photothermographic material preferably contains organic solid lubricant particles having an average particle size of 1 to 30 μm in the uppermost layer on the support. The organic solid lubricant particles are dispersed preferably by a polymeric dispersing agent. The melting point of the organic solid lubricant particles preferably is higher than the thermal development temperature and preferably 80° C. or more, more preferably 110° C. or more.

Organic solid lubricant particles usable in the photothermographic material are preferably compounds capable of lowering energy of the surface and, for example, particles formed by pulverizing polyethylene, polypropylene, polytetrafluoroethylene and their compoymers.

Examples of organic solid lubricant particles composed of polyethylene or polypropylene are shown below but are by no means limited to these:

| | melting point (° C.) |
|---|---|
| polytetrafluoroethylene | 321 |
| polypropylene/polyethylene copolymer | 142 |
| polyethylene (low density) | 113 |
| polyethylene (high density) | 126 |
| polypropylene | 145 |

Organic solid lubricant particles usable in the photothermographic material are preferably a compound represented by the following formula (6):
(R₆₁)ₚ₆—X₆₁-L₆-X₆₂—(R₆₂)_{q6} formula (6)
wherein R₆₁ and R₆₂ are each a substituted or unsubstituted alkyl, alkenyl, aralkyl or aryl group, provided that when p6 or q6 is 2 or more, plural R₆₁s or R₆₂s may be the same with or different from each other; X₆₁ and X₆₂ are each a N-containing bivalent linkage group; L₆ is a substituted or unsubstituted alkyl, alkenyl, aralkyl or aryl group having a valence of p6+q6.

In the compound of formula (6), the number of total carbon atoms is not specifically limited but usually 20 or more preferably 30 or more. The alkyl, alkenyl, aralkyl or aryl group of R₆₁ and R₆₂ may be substituted. Examples of a substituent include a halogen atom, hydroxy, cyano, an alkoxy group, an aryloxy group, an alkylthio group, an arylthio group, an alkoxycarbonyl group, an arylthio group, an alkoxycarbonyl group, an aryloxycarbonyl group, an amino group, an acylamino group, a sulfonylamino group, a ureido group, a carbamoyl group, a sulfamoyl group, an acyl group, a sulfonyl group, a sulfinyl group, an aryl group and an alkyl group. These groups may be substituted. Preferred examples of a substituent include a halogen atom, hydroxy, an alkoxy group, an alkylthio group, an alkoxycarbonyl group, an acylamino group, a sulfonylamino group, an acyl group and alkyl group. Of halogen atoms, a fluorine or chlorine atom is preferred. The alkyl component of an alkoxy group, alkylthio group or alkoxycarbonyl group is the same as defined in the alkyl group defined in R₆₂. The amino group of an acylamino or sulfonylamino group includes a N-substituted amino group, in which a substituent is preferably an alkyl group. Of an alkyl group and aryl group attached to carbonyl of an acylamino group and sulfonyl of a sulfonylamino group, respectively, the foregoing alkyl group is preferred.

R₆₁ and R₆₂ are each a substituted or unsubstituted alkyl, alkenyl, aralkyl or aryl group having 6 to 60 carbon atoms, preferably 6 to 40 carbon atoms and more preferably 10 to 30 carbon atoms. These alkyl, alkenyl and aralkyl groups may be straight chain, branched or cyclic, or the combination thereof. Preferred examples of R₆₁ and R₆₂ include octyl, t-octyl, dodecyl, tetradecyl, hexadecyl, 2-hexyldecyl, octadecyl, CₙH₂ₙ₋₁ (n=20-60), eicosyl, merisinyl, octenyl, myristoyl, oleyl, ersinyl, phenyl, naphthyl, benzyl, nonyphenyl, dipentylphenyl, cyclohexyl and the foregoing groups substituted by substituents described above.

X₆₁ and X₆₂ are each a N-containing bivalent linkage group, and preferably —CONR₃—, —NR₄CONR₅— or —NR₆COO—.

L₆ is a substituted or unsubstituted alkyl, alkenyl, aralkyl or aryl group having a valence of L₆ is a substituted or unsubstituted alkyl, alkenyl, aralkyl or aryl-group having a valence of p₆+q₆. The number of carbon atoms of a hydrocarbon group is not specifically limited but preferably 1 to 60, more preferably 1 to 40, and still more preferably 10 to 40. The valence of p₆+q₆ means that hydrogen atoms of p₆+q₆ are removed, and X₆₁-groups of p6 and X₆₂-groups of q6 are attached thereto; p6 or q6 are each 0 or an integer of 1 to 6 and 1p6+q6≦6, and preferably 1≦p6+q6≦4 and p6 and q6 preferably are hydrogen atoms at the same time.

The foregoing compound of formula (6) may be natural one or synthetic one. A natural compound or a synthetic compound made from a natural higher fatty acid or alcohol include compounds differing in straight chain and branched compounds but the use of a mixture of such different compounds produces no problem Synthetic compounds are preferable in terms of stability of quality.

Specific examples of a preferred compound of formula (6) are shown below but are by no means limited to these:

| | melting point (° C.) |
|---|---|
| OW-1: lauric acid amide | 87 |
| OW-2: palmitic acid amide | 100 |
| OW-3: stearic acid amide | 101 |
| OW-4: behenic acid amide | 98 |
| OW-5: hydroxystearic acid | 107 |
| OW-6 oleic acid amide | 75 |
| OW-7 erucic acid amide | 81 |
| OW-8 ricinoleic acid amide | 62 |
| OW-9 N-lauryllauric acid amide | 77 |
| OW-10: N-paltylpalmitic acid amide | 91 |
| OW-11: N-stearylstearic acid amide | 95 |
| OW-12: N-oleyloleic acid amide | 65 |
| OW-13: N-stearyloleic acid amide | 67 |
| OW-14: N-oleyloleic acid amide | 74 |
| OW-15: N-stearylerucic acid amide | 69 |
| OW-16: N-oleylpalmitic acid amide | 68 |
| OW-17: N-stearyl-12-hydroxystearic acid | 102 |
| OW-18: N-oleyl-12-hydroxystearic acid amide | 90 |
| OW-19: methylol stearic acid amide | 110 |
| OW-20: methylol behenic acid amide | 110 |
| OW-21: methylenebisstearic acid amide | 142 |
| OW-22: methylenebislauric acid amide | 131 |
| OW-23: methylenebishydroxystearic acid amide | 143 |
| OW-24: ethylenebiscaprylic acid amide | 165 |
| OW-25: ethylenebiscapric acid amide | 161 |
| OW-26: ethylenebislauric acid amide | 157 |
| OW-27: ethylenebisstearic acid amide | 145 |
| OW-28: ethylenebisisostearic acid amide | 106 |
| OW-29: ethylenebishydroxystearic acid amide | 145 |
| OW-30: ethylenebisbehenic acid amide | 142 |
| OW-31: hexamethylenebisstearic acid amide | 140 |
| OW-32: hexametylenebisstearic acid amide | 142 |
| OW-33: hexamethylenebishydroxystearic acid amide | 135 |
| OW-34: butylenebishydroxystearic acid amide | 140 |
| OW-35: N,N′-distearyladipic acid amide | 141 |
| OW-36: N,N′-distearylcebacic acid amide | 136 |
| OW-37: methylenebisoleic acid amide | 116 |
| OW-38: ethylenebisoleic acid amide | 119 |
| OW-39: ethylenebiserucic acid amide | 120 |
| OW-40: hexamethylenebisoleic acid amide | 110 |
| OW-41: N,N′-dioleyladipic acid amide | 118 |
| OW-42: N,N′-dioleylcebacic acid amide | 113 |
| OW-43: m-xylenestearic acid amide | 123 |
| OW-44: N,N′-distearylisophthalic acid amide | 125 |
| OW-45: ethanolamine distearate | 82 |
| OW-46: N-butyl-N7-stearylurea | 94 |
| OW-47: N-phenyl-N′-stearylurea | 99 |
| OW-48: N-stearyl-N′-tearylurea | 109 |
| OW-49: xylenebisstearylurea | 166 |
| OW-50: toluilenebisstearylurea | 172 |
| OW-51: hexamethylenebisstearylurea | 173 |
| OW-53: diphenylmethanebisstearylurea | 206. |

Organic solid lubricant particles described above are used preferably in the form of being dispersed in a coating solution. The organic solid lubricant particles, which have slippery surfaces, often do not exhibit sufficient affinity to water or an organic solvent. When stability of the dispersion is lowered, coagulation or precipitation often occurs. Coagulation of precipitation in a coating solution often causes coating defects in the course of conversion to film. To enhance stability of a dispersion, there are employed an electrostatic effect by surface modification or a steric hindrance effect by using a surface adsorption layer of a polymeric surfactant. The former is a general method for stabilizing a dispersion but there are concerns that a surface modifier affects other performance. Accordingly, the latter which easily displays effects not only in an aqueous system but also in non-aqueous system, is preferred.

A binder used in the photothermographic material is usable as a polymeric dispersing agent. Examples of such a binder include polyvinyl butyral, polyvinyl acetal, polyvinyl alcohol, cellulose acetate butyrate, and cellulose acetate propionate.

A polymeric dispersing agent used preferably at 1% to 200% by weight of organic solid lubricant particles. Dispersing is not specifically limited but performed by employing a dissolver, ultrasonic or compression. It is preferred to perform dispersion by using a dispersing apparatus provided with a cooling device to inhibit heat generation.

The average particles of the foregoing organic solid lubricant particles refers to that of the particles having been subjected to the following dispersion procedure. Thus, the average particle size can be determined in such a manner that a dispersion containing a compound relating to the invention is diluted, dropped onto a grid attached with carbon supporting membrane and dried; and the thus dried sample is observed by a transmission electron microscope (e.g., 2000FX type, produced by Nippon Denshi Co., Ltd.) and photographed at a factor of 5,000; the obtained negative image is read in a scanner and the particle size is measured with respect to at least 3,000 particles to determine an average particle size from the arithmetic average.

In the photothermographic material used in the invention, at least one layer on the support preferably contains a compound of the foregoing formula (6) and preferably contains a fluorinated nonionic surfactant and a fluorinated anionic surfactant in combination. The fluorinated nonionic surfactant is not specifically limited but preferably a compound represented by the following formula (A):
Rf1-(AO)ₙ—Rf2 formula (A)
wherein Rf1 and Rf2 are each a fluorine-containing aliphatic group, which-may be the same or different; AO is a group containing at least one alkyleneoxy group; n is an integer of 1 to 30.

In the formula (A), the fluorine-containing aliphatic group may be straight chain, branched or cyclic one, or the combination thereof, such as an alkylcycloaliphatic group. The fluorine-containing aliphatic group is preferably a fluoroalkyl group (e.g., —C₄H₉, —C₈H₁₇), a sulfofluoroalkyl group (e.g., —C₇F₁₅SO₃, —C₈F₁₇SO₃), CₙF₂ₙ₊₁SO₂N(R₁)R₂— (in which R₁ is a hydrogen atom, an alkyl, alkoxy, alkylcarboxy group having 1 to 20 carbon atoms or an aryl group, R₂ is an alkylene group or an alkylenecarboxyl group, and n is an integer of 1 to 20, e.g., C₇F₁₅SO₂N(C₂H₅)CH₂—, C₈F₁₇SO₂N(CH₂COOH) CH₂CH₂CH₂—), and each having 1 to 17 carbon atoms. These groups may be substituted. AO is a group containing an alkyleneoxy group, such as ethyleneoxy, propyleneoxy or i-propyleneoxy, in which a substituent such as an amino group may be contained at the end; and n is preferably an integer of 5 to 15.

A-1: C₁₂F₂₅(CH₂CH₂O)₂₄C₁₂F₂₅

A-2: C₈F₁₇(CH₂CH₂O)₈C₈F₁₇

A-3: C₇F₁₅CH₂CH(OH)CH₂(CH₂CH₂O)₁₅CH₂CH(OH)CH₂C₇F₁₅

A-4: C₇F₁₅(CH₂CH₂O)₁₀C₇F₁₅

A-5: C₁₂F₂₅(CH₂CH₂O)₁₅C₁₂F₂₅

A-6: C₈F₁₇CH₂CH(OH)CH₂(CH₂CH₂O)₂₀CH₂CH(OH)CH₂C₈F₁₇

A-7: C₈F₁₇(CH₂CH₂O)₁₈C₈F₁₇

A-8: C₈F₁₇(CH₂CH₂O)₂₀C₈F₁₇

A-9: C₇F₁₅SO₂N(C₂H₅)CH₂(CH₂CH₂O)₂₂CH₂N(CH₃)SO₂C₇H₁₅

A-10: C₉F₁₇O(CH₂CH₂O)₂₂C₉F₁₇

Fluorine-containing anionic surfactants usable I the invention are not specifically limited, and specific examples thereof are shown below but are not limited to these.

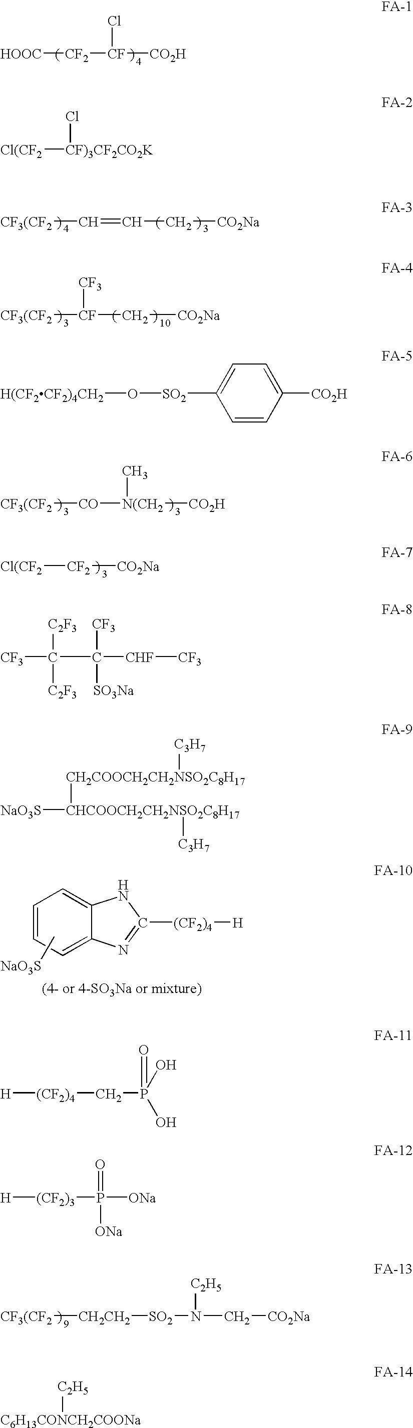

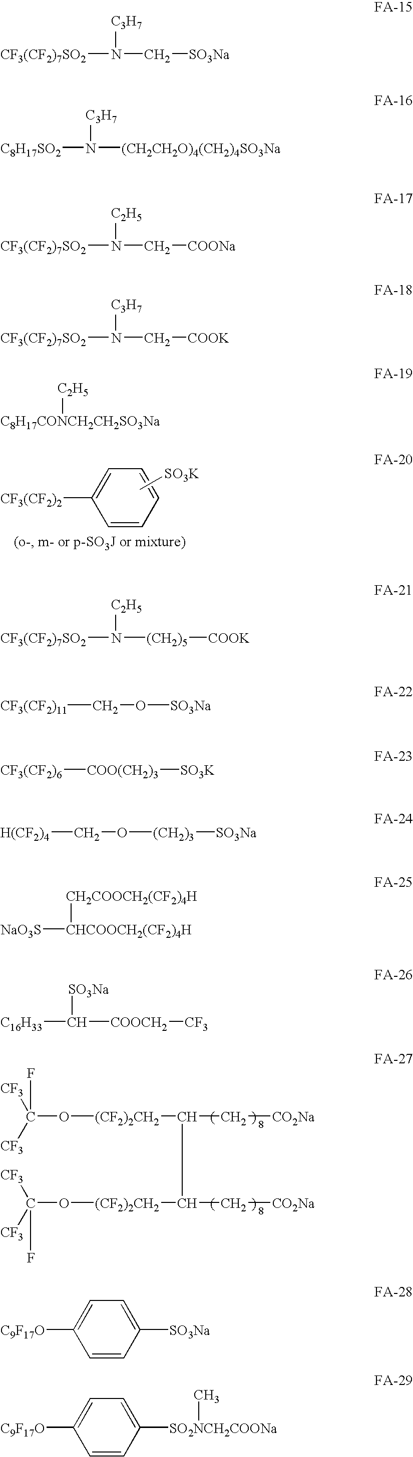

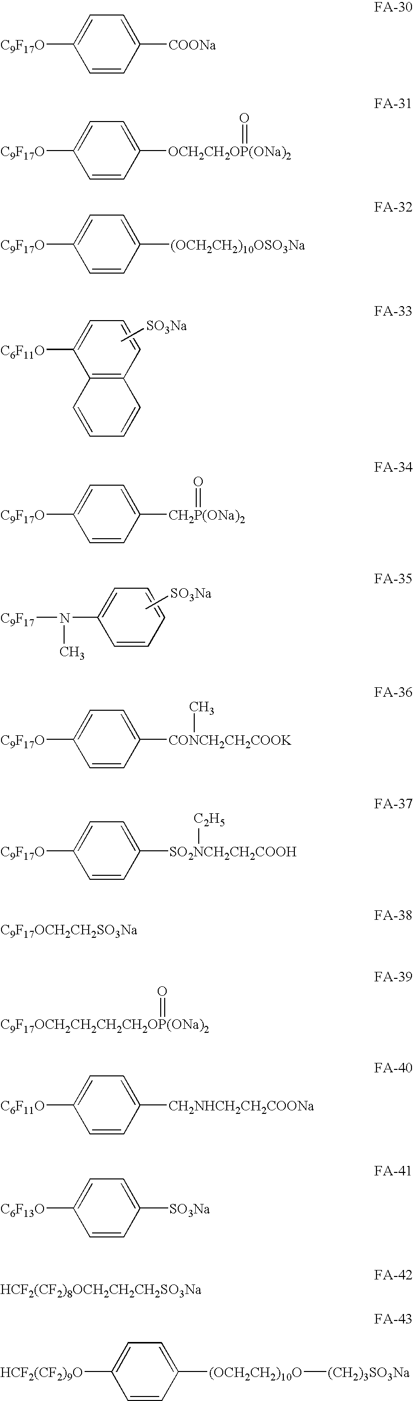

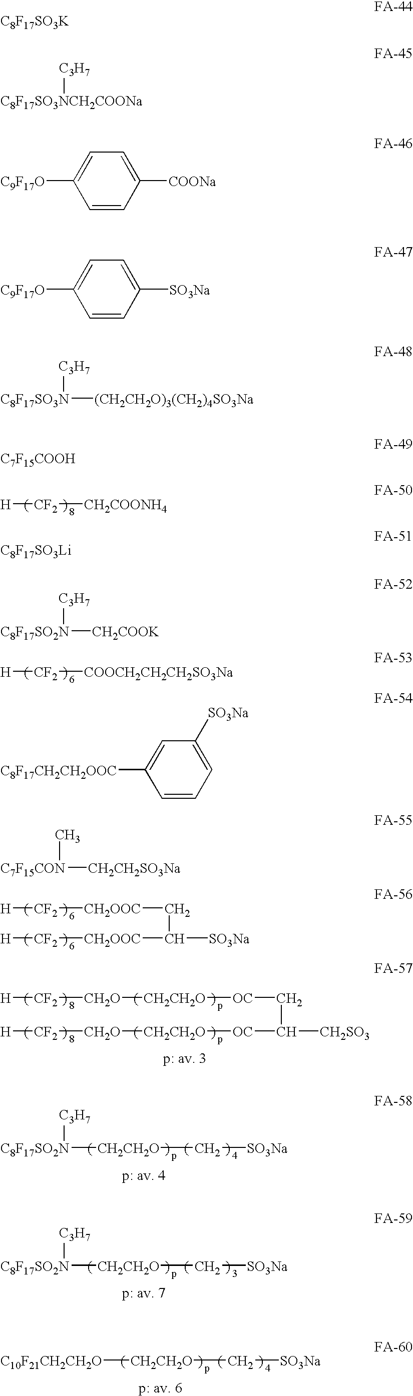

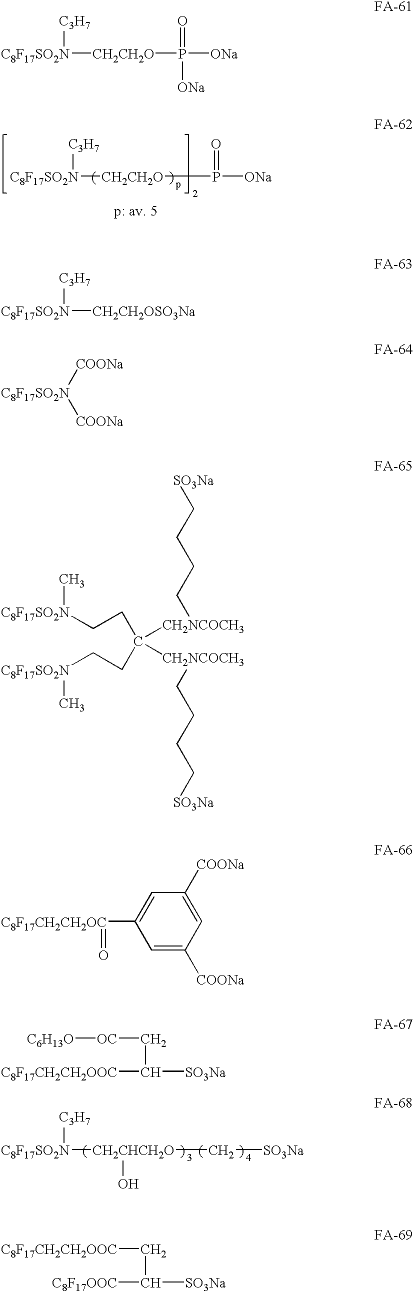

The foregoing fluorinated surfactants are used in an amount of 0.01 to 1 g per m² of photothermographic material, preferably 10 to 500 mg, and more preferably 50 to 300 mg.

In addition to the foregoing fluorinated surfactants, there are also usable ionic fluorinated surfactants, as described in JP-A Nos. 60-244945, 63-306437 and 1-24245; anionic•cationic fluorinated surfactants, as described in JP-A Nos. 5-197068 and 5-204115.

Fluorinated surfactants may be incorporated to any layer but preferably an uppermost layer.

It is preferred to form a filter layer on the same side as or on the opposite side to the light sensitive layer or to allow a dye or pigment to be contained in the light sensitive layer to control the amount of wavelength distribution of light transmitted through the light sensitive layer of photothermographic materials relating to this invention. Commonly known compounds having absorptions in various wavelength regions can used as a dye, in response to spectral sensitivity of the photothermographic material. In cases where the photothermographic material are applied as an image recording material using infrared light is preferred the use of squarilium dye containing a thiopyrylium nucleus (also called as thiopyrylium squarilium dye), squarilium dye containing a pyrylium nucleus (also called as pyrylium squarilium dye), thiopyrylium chroconium dye similar to squarilium dye or pyrylium chroconium. The compound containing a squarilium nucleus is a compound having a 1-cyclobutene-2-hydroxy-4one in the molecular structure and the compound containing chroconium nucleus is a compound having a 1-cyclopentene-2-hydroxy,4,5-dione in the molecular structure, in which the hydroxy group may be dissociated. Hereinafter, these dyes are collectively called a squarilium dye.

Further, compounds described in U.S. Pat. No. 5,380,635, JP-A Nos. 8-201959, 2002-040593, 2003-186135 and 2003-195450; U.S. Pat. No. 6,689,547 and U.S. Patent Application publication No. 20040259044 are also preferred as a dye.

Suitable supports used in the photothermographic imaging materials of the invention include various polymeric materials, glass, wool cloth, cotton cloth, paper, and metals (such as aluminum). Flexible sheets or roll-convertible one are preferred. Examples of preferred support used in the invention include plastic resin films such as cellulose acetate film, polyester film, polyethylene terephthalate film, polyethylene naphthalate film, polyamide film, polyimide film, cellulose triacetate film and polycarbonate film, and biaxially stretched polyethylene terephthalate (PET) film is specifically preferred. The support thickness is 50 to 300 μm, and preferably 70 to 180 μm.

To improve electrification properties of photothermographic imaging materials, metal oxides and/or conductive compounds such as conductive polymers may be incorporated into the constituent layer. These compounds may be incorporated into any layer and preferably into a sublayer, a backing layer, interlayer between the light sensitive layer and the sublayer. Conductive compounds described in U.S. Pat. No. 5,244,773, col. 14-20. Specifically, the surface protective layer of the backing layer side preferably contains conductive metal oxides.

The conductive metal oxide is crystalline metal oxide particles, and one which contains oxygen defects or one which contains a small amount of a heteroatom capable of forming a donor for the metal oxide, both exhibit enhanced conductivity and are preferred. The latter, which results in no fogging to a silver halide emulsion is preferred. Examples of metal oxide include ZnO, TiO₂, SnO₂, Al₂O₃, In₂O₃, SiO₂, MgO, BaO, MoO₃ and V₂O₅ and their combined oxides. Of these, ZnO, TiO₂ and SnO₂ are preferred. As an example of containing a heteroatom, addition of Al or In to ZnO, addition of Sb, Nb, P or a halogen element to SnO₂, and addition of Nb or Ta to TiO₂ are effective. The heteroatom is added preferably in an amount of 0.01 to 30 mol%, and more preferably 0.1 10 mol %. To improve particle dispersibility and transparency, a silicon compound may be added in the course of particle preparation.

The metal oxide particles have electric conductivity, exhibiting a volume resistance of 10⁷ Ω·cm or less and preferably 10⁵ Ω·cm or less. The foregoing metal oxide may be adhered to other crystalline metal oxide particles or fibrous material (such as titanium oxide), as described in JP-A Nos. 56-143431, 56-120519 and 58-62647 and JP-B No. 50-6235.

The particle size usable in this invention is preferably not more than 1 μm, and a particle size of not more than 0.5 μm results in enhanced stability after dispersion, rendering it easy to make use thereof. Employment of conductive particles of 0.3 μm or less enables to form a transparent photothermographic material. Needle-form or fibrous conductive metal oxide is preferably 30 μm or less in length and 1 μm or less in diameter, and more preferably 10 μm or less in length and 0.3 μm or less in diameter, in which the ratio of length to diameter is preferably 3 or more. SnO₂ is also commercially available from Ishihara Sangyo Co., Ltd., including SNS10M, SN-100P, SN-100D and FSS10M.

The photothermographic material of this invention is provided with at least one image forming layer as a light-sensitive layer on the support. There may be provided an image forming layer alone on the support but it is preferred to form at least one light-insensitive layer on the image forming layer. For instance, a protective layer may be provided on the image forming layer to protect the image forming layer. Further, to prevent blocking between photothermographic materials or adhesion of the photothermographic material to a roll, a back-coat layer may be provided on the opposite side of the support.

A binder used in the protective layer or the back coat layer can be chosen preferably from polymers having a higher glass transition point (Tg) than a binder used in the image forming layer and exhibiting resistance to abrasion or deformation, for example, cellulose acetate, cellulose butyrate or cellulose propionate.

To control gradation, at least two image forming layers may be provided on one side of the support or at least one image forming layer may be provided on both sides of the support.

It is preferable to prepare the silver salt photothermographic dry imaging material of the present invention as follows. Materials of each constitution layer as above are dissolved or dispersed in solvents to prepare coating compositions. Resultant coating compositions are subjected to simultaneous multilayer coating and subsequently, the resultant coating is subjected to a thermal treatment. “Simultaneous multilayer coating”, as described herein, refers to the following. The coating composition of each constitution layer (for example, a photosensitive layer and a protective layer) is prepared. When the resultant coating compositions are applied onto a support, the coating compositions are not applied onto a support in such a manner that they are individually applied and subsequently dried, and the operation is repeated, but are simultaneously applied onto a support and subsequently dried. Namely, before the residual amount of the total solvents of the lower layer reaches 70 percent by weight, the upper layer is applied.

Simultaneous multilayer coating methods, which are applied to each constitution layer, are not particularly limited. For example, are employed methods, known in the art, such as a bar coater method, a curtain coating method, a dipping method, an air knife method, a hopper coating method, and an extrusion method. Of these, more preferred is the pre-weighing type coating system called an extrusion coating method. The extrusion coating method is suitable for accurate coating as well as organic solvent coating because volatilization on a slide surface, which occurs in a slide coating system, does not occur. Coating methods have been described for coating layers on the photosensitive layer side. However, the backing layer and the subbing layer are applied onto a support in the same manner as above.

In this invention, silver coverage is.preferably from 0.3 to 1.5 g/m², and is more preferably from 0.5 to 1.5 g/m² for use in medical imaging. The ratio of the silver coverage which is resulted from silver halide is preferably from 2% to 18% with respect to the total silver, and is more preferably from 5% to 15%. Further, in the present invention, the number of coated silver halide grains, having a grain diameter (being a sphere equivalent grain diameter) of at least 0.01 μm; is preferably from 1×10¹⁴ to 1×10¹⁸ grains/m², and is more preferably from 1×10¹⁵ to 1×10¹⁷. Further, the coated weight of aliphatic carboxylic acid silver salts of the present invention is from 10⁻¹⁷ to 10⁻¹⁴ g per silver halide grain having a diameter (being a sphere equivalent grain diameter) of at least 0.01 μm, and is more preferably from 10⁻¹⁶ to 10⁻15 g. When coating is carried out under conditions within the aforesaid range, from the viewpoint of maximum optical silver image density per definite silver coverage, namely covering power as well as silver image tone, desired results are obtained.

The photothermographic material of this invention contains solvent preferably at 5 to 1,000 mg/m² when subjected to thermal development, and more preferably 100 to 500 mg/m², thereby leading to enhanced sensitivity, reduced fogging and enhanced maximum density. Examples of such a solvents are described, for instance, in JP-A No. 2001-264936, paragraph [0030] but are not limited to thereto. The solvent may be used singly or in combination.

The solvent content in the photothermographic material can be controlled by adjusting conditions in the drying stage after coating, for example, temperature conditions. The solvent content can be determined by gas chromatography under the condition suitable for detection of contained solvents.

Hereinafter, there will be described techniques for lessening or preventing odor or stains due to volatilization of low molecular weight compounds contained in the photothermographic material, generated in the thermal development apparatus when thermally developing the photothermographic material of the invention.

In the photothermographic material relating to the invention, the protective layer preferably has a function of preventing staining material generated during thermal development from volatilization or adhesion onto the photothermographic material. Accordingly, the protective layer preferably contains, as a protective binder, a cellulose acetate having an acetylation degree of 50% to 58% or a polymer containing a vinyl alcohol unit having a saponification degree of 75% or less. Specifically, a vinyl acetate polymer or a polyvinyl alcohol is preferred. The lower limit of the saponification degree is preferably not more than 40%, and more preferably not more than 60%.

The protective layer may contain a mixture with polymers other than the polymer described above, for example, polymers described in U.S. Pat. Nos. 6,352,819, 6,352,820 and 6,350,561. Te ratio thereof is preferably 0% to 90% by volume, and more preferably 0 to 40%.

Cross-linking agents for the foregoing binder are preferably isocyanate compounds, silane compounds, and an epoxy compounds or their acid anhydride.

The use of an acid group scavenger preferably reduces the amount of volatile material generated from photothermographic material during development. Examples of an acid group scavenger include an isocyanate compound represented by the following formula (X-1), an epoxy compound represented by the following formula (X-2), a phenol compound represented by the following formula (X-3), an amine or diamine compound represented by the following formula (X-4) or a carbodiimide compound by formula (CI) as described later. Of these, a carbodiimide compound is preferred.

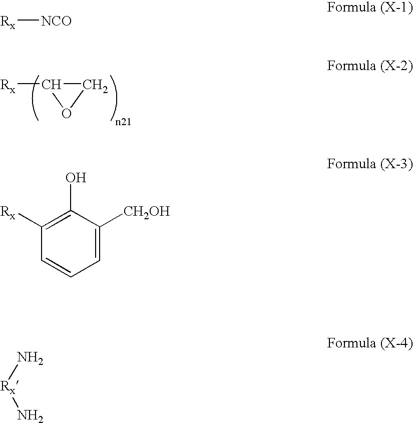

In the foregoing formulas, Rx represents a substituent, Rx′ represents a bivalent linkage group, and n21 represents an integer of 1 to 4.

To prevent density change or fogging with time during storage or to improve curl or roll-set curl, it is preferred to pack the photothermographic material of this invention with a packaging material exhibiting a low oxygen permeability and/or moisture permeability. The oxygen permeability is preferably not more than 50 ml/atm·m²·day, more preferably not more than 10 ml/atm·m²·day, and still more preferably not more than 1.0 ml/atm·m²·day. The moisture permeability is preferably not more than 0.01 g/m²·40° C.·90% RH·day (in accordance with JIS Z0208, Cap Method), more preferably not more than 0.005 g/m²·40° C.·90% RH·day, and still more preferably not more than 0.001 g/m²·40° C.·90%RH·day.

Specific examples of packaging material include those described in JP-A Nos. 8-254793, 2000-206653, 2000-235241, 2002-062625, 2003-015261, 2003-057790, 2003-084397, 2.003-098648, 2003-098635, 2003-107635, 2003-131337, 2003-146330, 2003-226439 and 2003-228152. The free volume within a package is preferably 0.01 to 10%, and preferably 0.02 to 5%, and it is also preferred to fill nitrogen within the package at a nitrogen partial pressure of at least 80%, preferably at least 90%. The relative humidity within the package is preferably 10% to 60%, and more preferably 40% to 55%.

### EXAMPLES

### Example 1

Preparation of Subbed Photographic Support

A photographic support comprised of a biaxially oriented polyethylene terephthalate film with blue tinted at an optical density of 0.135, which had been subjected to corona discharge treatment of 10 W·minute/m² on both sides, was subjected to subbing. Namely, the following backing lower sublayer coating solution was coated and dried at 140° C. to form a 0.06 μm lower sublayer. Subsequently, the following backing upper sublayer coating solution was coated and dried at 140° C. to form a 0.2 μm upper sublayer. On the other side of the support, the following coating solution of a lower sublayer of the light-sensitive layer side was coated and dried at 140° C. to form a 0.25 μm lower sublayer. Further thereon, the following backing upper sublayer coating solution was coated and dried at 140° C. to form a 0.06 μm upper sublayer of the light-sensitive layer side. The thus coated support was thermally treated at 140° C. for 2 min. to obtain a subbed support.

Backing lower sublayer coating solution

| | | |
|---|---|---|
| Copolymer latex of Styrene/glycidyl | 16.0 | g |
| methaacrylate/butyl acrylate | | |
| (20/20/40). 30% solids | | |
| Copolymer latex of Styrene/butyl | 4.0 | g |
| acrylate/hydroxymethyl methacrylate | | |
| (25/45/30). 30% solids | | |
| SnO₂ sol (10% solids), synthesized | 91 | g |
| JP-A No. 10-059720 | | |
| Surfactant A | 0.5 | g |
| Water to make | 1000 | ml |

Backing upper sublayer coating solution

| | | |
|---|---|---|
| Modified aqueous polyester A (18% solid) | 215.0 | g |
| Surfactant A | 0.4 | g |
| Spherical silica matting agent | 0.3 | g |
| Sea Hoster KE-P50 (Produced by | | |
| Nippon Shokubai Co., Ltd.) | | |
| Water to make | 1000 | ml |

Water-Based Modified Polyester A

A mixture consisting of 35.4 parts by weight of dimethyl terephthalate, 33.63 parts by weight of dimethyl isophthalate, 17.92 parts by weight of sodium salt of dimethyl 5-sulfoisophthalate, 62 parts by weight of ethylene glycol, 0.065 part by weight of calcium acetate monohydrate, and 0.022part by weight of manganese acetate tetrahydrate underwent trans-esterification at 170 to 220° C. under a flow of nitrogen while distilling out methanol. Thereafter, 0.04 parts by weight of trimethyl phosphate, 0.04 part by weight of antimony trioxide, and 6.8 parts by weight of 4-cyclohexanedicarboxylic acid were added. The resulting mixture underwent esterification at a reaction temperature of 220 to 235° C. while a nearly theoretical amount of water being distilled away. Thereafter, the reaction system was subjected to pressure reduction and heating over a period of one hour and was subjected to polycondensation at a final temperature of 280° C. and a maximum pressure of 133 Pa for one hour, whereby water-soluble polyester A-1 was synthesized. The intrinsic viscosity of the resulting water-soluble polyester A-1 was 0.33.

Subsequently, 850 ml of pure water was placed in a 2-liter three-necked flask fitted with stirring blades, a refluxing cooling pipe, and a thermometer, and while rotating the stirring blades, 150 g of water-soluble polyester A-1 was gradually added. The resulting mixture was stirred at room temperature for 30 minutes without any modification. Thereafter, the interior temperature was raised to 98° C. over a period of 1.5 hours and at that resulting temperature, dissolution was performed over a period of 3 hr. Thereafter, the temperature was lowered to room temperature over a period of one hour and the resulting product was allowed to stand overnight to obtain a precursor solution having a solid content of 15% by weight.

Into a 3-liter four-necked flask fitted with stirring blades, a reflux cooling pipe, a thermometer, and a dripping funnel was put 1,900 ml of the foregoing precursor solution, and the interior temperature was raised to 80° C., while rotating the stirring blades. Into this was added 6.52 ml of a 24 percent aqueous ammonium peroxide solution, and a monomer mixed liquid composition (consisting of 28.5 g of glycidyl methacrylate, 21.4 g of ethyl acrylate, and 21.4 g of methyl methacrylate) was dripped over a period of 30 minutes, and reaction was allowed for an additional 3 hours. Thereafter, the resulting product was cooled to at most 30° C., and filtrated, whereby water-based modified polyesters solution A having a solid content of 18% by weight was obtained.

Light-sensitive side lower sublayer coating solution

| | | |
|---|---|---|
| Copolymer latex of Styrene/acetoacetoxyethyl | 70.0 | g |
| methacrylate/glycidyl | | |
| methaacrylate/n-butyl acrylate | | |
| (40/40/20/0.5). 30% solids | | |
| Surfactant A | 0.3 | g |
| Water to make | 1000 | ml |

Light-sensitive side upper sublayer coating solution

| | | |
|---|---|---|
| Modified aqueous polyester B (18% solid) | 80.0 | g |
| Surfactant A | 0.4 | g |
| Spherical silica matting agent | 0.3 | g |
| Sea Hoster KE-P50 (Produced by | | |
| Nippon Shokubai Co., Ltd.) | | |
| Water to make | 1000 | ml |

Water-Based Modified Polyester B

Water-based modified polyester B was prepared similarly to the foregoing water-based modified polyester A, except that the composition was replaced by 1800 ml of a precursor solution and a monomer mixture of 31 g of styrene, 31 g of acetoacetoxyethyl methacrylate, 61 g of glydyl methacrylate and 7.6 g of n-butyl acrylate.

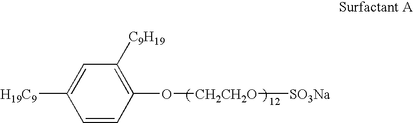

Preparation of Silver Halide Emulsion

Solution A1

| | | |
|---|---|---|
| Phenylcarbamoyl-modified gelatin | 66.2 | g |
| HO(CH₂CH₂O)ₙ(CH(CH₃)CH₂O)₁₇(CH₂CH₂O)ₘH | 10 | ml |
| (M + n = 5-7, 10% methanol solution) | | |
| Potassium bromide | 0.32 | g |
| Water to make | 5429 | ml |

Solution B1

| | |
|---|---|
| 0.67 mol/L aqueous silver nitrate | 2635 ml |
| solution | |

Solution C1

| | | |
|---|---|---|
| Potassium bromide | 51.55 | g |
| Potassium iodide | 1.47 | g |
| Water to make | 660 | ml |

Solution D1

| | | |
|---|---|---|
| Potassium bromide | 154.9 | g |
| Potassium iodide | 4.41 | g |
| Potassium hexacyanoiron (II) | 15 | ml |
| (0.5% aqueous solution) | | |
| Potassium hexachloroiridate (III) | 0.93 | ml |
| (1% aqueous solution) | | |
| Water to make | 1982 | ml |

Solution E1

0.4 mol/L aqueous potassium bromide solution in an amount to control silver potential

Solution F1

| | | |
|---|---|---|
| Potassium hydroxide | 0.71 | g |
| Water to make | 20 | ml |

Solution G1

| | |
|---|---|
| 56% aqueous acetic acid solution | 10.0 ml |

Solution H1

| | | |
|---|---|---|
| Sodium carbonate anhydride | 1.16 | g |
| Water to make | 107 | ml |

Upon employing a mixing stirrer shown in JP-B No. 58-58288, ¼ portion of solution B1 and whole solution C1 were added to solution A1 over 4 minutes 45 seconds, employing a double-jet precipitation method while adjusting the temperature to 35° C. and the pAg to 8.09, whereby nuclei were formed. After one minute, whole solution F1 was added. During the addition, the pAg was appropriately adjusted employing Solution E1. After 6 minutes, ¾ portions of solution B1 and whole solution D1 were added over 14 minutes 15 seconds, employing a double-jet addition method while adjusting the temperature to 35° C. and the pAg to 8.09. After stirring for 5 minutes, the mixture was heated to 30° C., and whole solution G1 was added, whereby a silver halide emulsion was flocculated. Subsequently, while leaving 2000 ml of the flocculated portion, the supernatant was removed, and 10 L of water was added. After stirring, the silver halide emulsion was again flocculated. While leaving 1,500 ml of the flocculated portion, the supernatant was removed. Further, 10 L of water was added. After stirring, the silver halide emulsion was flocculated. While leaving 1,500 ml of the flocculated portion, the supernatant was removed. Subsequently, solution H1 was added and the resultant mixture was heated to 60° C., and then stirred for an additional 100 minutes. Finally, the pH was adjusted to 5.8 and water was added so that the weight was adjusted to 1,161 g per mol of silver, whereby a light-sensitive silver halide emulsion was prepared.

The prepared emulsion was comprised of monodisperse cubic silver iodobromide grains having an average grain size of 0.043 μm and a (100) crystal face ratio of 92 percent. Aliphatic Carboxylic acid Silver salt 1-1 to 1-8

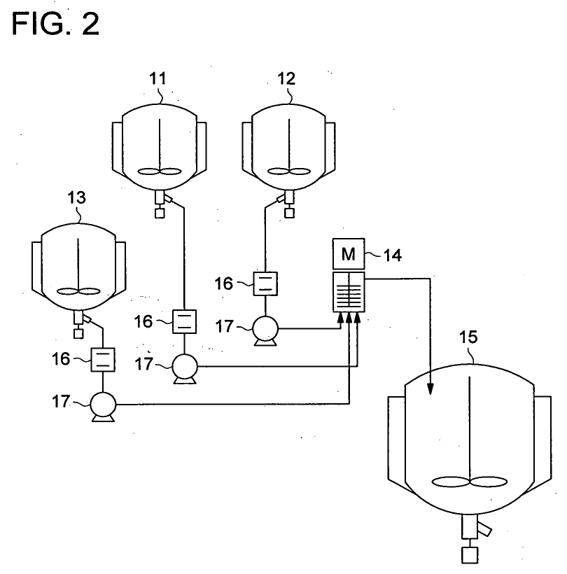

Using an apparatus shown in FIG. 2, aliphatic carboxylic acid silver salt particles 1-1 through 1-8 as follows. While stirring 450 g of aliphatic carboxylic acids (having a molar ratio shown in Table 1) and pure water in an amount of 90% of the amount necessary to adjust the concentration shown in Table 1 at 85° C. in tank 11, 252 ml of aqueous 5 M/L KOH solution was added thereto in 5 min. and reacted for 60 min to obtain an aqueous potassium aliphatic carboxylate solution. Finally, additional pure water was added to make up at a concentration shown in Table 1. An aqueous silver nitrate solution was prepared in tank 12 at a concentration and an amount shown in Table 1 and maintained at 10° C. While stirring by mixing device 14 shown in FIG. 2 (TK pipe line homomixer type M, produced by Tokushu-Kika Kogyo Co., Ltd.) at 10,000 rpm, the aqueous potassium aliphatic carboxylate solution and the aqueous silver nitrate solution were simultaneously added by double-jet addition at a constant flow rate over a period of time shown in Table 1 and the obtained reaction mixture was stocked in tank 15. The tank 15 was kept at 30° C. during addition. Subsequently, solids were filtered by a suction filter and washed with pure water at a temperature shown in Table 1 until the conductivity of permeated water reached 30 μS/cm. The dehydrated cake was dried under conditions shown in Table 1 to obtain dried powdery aliphatic carboxylic acid silver salt particles. There were thus obtained particulate aliphatic carboxylic acid silver salt 1-1 through 1-8. The average sphere equivalent diameter and the standard deviation of grain diameter were determined, as shown in Table 1. In FIG. 1, numerals 13, 16 and 17 designate a tank, a flow meter and a pump, respectively.

Aliphatic Carboxylic Acid Silver salt 2-1 to 2-16

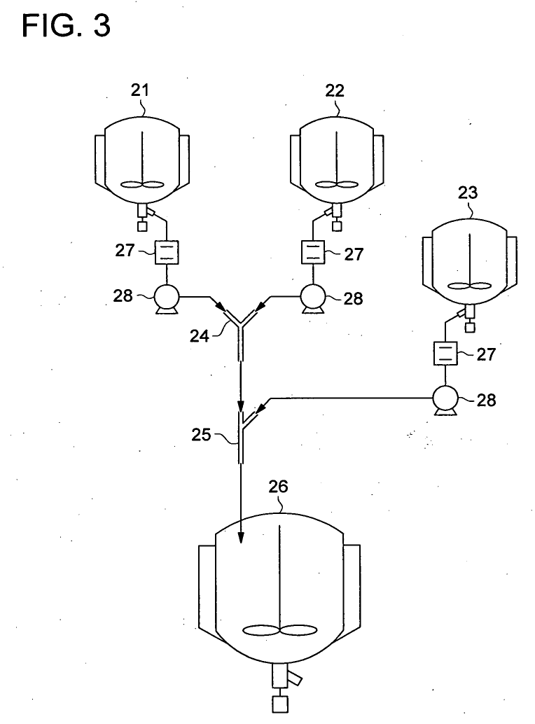

Using an apparatus shown in FIG. 3, aliphatic carboxylic acid silver salt particles 2-1 through 2-16 as follows. While stirring 450 g of aliphatic carboxylic acids (having a molar ratio shown in Table 1) and pure water in an amount of 90% of the amount necessary to adjust the concentration shown in Table 1 at 85° C. in tank 21, 252 ml of aqueous 5 M/L KOH solution was added thereto in 5 min. and reacted for 60 min to obtain an aqueous potassium aliphatic carboxylate solution. Finally, additional pure water was added to make up at a concentration shown in Table 1. An aqueous silver nitrate solution was prepared in tank 22 at a concentration and an amount shown in Table 1 and maintained at 10° C. While stirring by mixing device 24 shown in FIG. 3, the aqueous potassium aliphatic carboxylate solution and the aqueous silver nitrate solution were simultaneously added by double-jet addition at a constant flow rate over a period of time shown in Table 1 and the obtained reaction mixture was stocked in tank 26. The tank 26 was kept at 30° C. during addition. Subsequently, solids were filtered by a suction filter and washed with pure water at a temperature shown in Table 1 until the conductivity of permeated water reached 30 μS/cm. The dehydrated cake was dried under conditions shown in Table 1 to obtain dried powdery aliphatic carboxylic acid silver salt particles. There were thus obtained particulate aliphatic carboxylic acid silver salt 2-1 through 2-16. The average sphere equivalent diameter and the standard deviation of grain diameter were determined, as shown in Table 1. In FIG. 1, numerals 23, 25, 27 and 28 designate a tank, a mixing device, a flow meter and a pump, respectively.

TABLE 1

| | | | | | Silver | | | | | | |
|---|---|---|---|---|---|---|---|---|---|---|---|
| | | | | | Nitrate | | | | | | |
| | | | Addition | | Solution | | Washing | Drying | | | |
| | | | Time | | Conc. | Amount | Temp. | Temp. | *4 | *5 | |
| No. | *1 | *2 | (min) | *3 | (wt %) | (ml) | (° C.) | (° C.) | (μm) | (μm) | Remark |
| 1-1 | (65/25/10) | 65 | 10 | 6 | 20 | 1070 | 25 | 50 | 0.63 | 0.46 | Comp. |
| 1-2 | (70/21/9) | 70 | 10 | 6 | 20 | 1070 | 25 | 50 | 0.58 | 0.38 | Comp. |
| 1-3 | (85/11/4) | 85 | 10 | 6 | 20 | 1070 | 25 | 50 | 0.57 | 0.36 | Comp. |
| 1-4 | (92/6/2) | 92 | 10 | 6 | 20 | 1070 | 25 | 50 | 0.57 | 0.35 | Comp. |
| 1-5 | (65/25/10) | 65 | 10 | 5 | 5 | 4280 | 25 | 50 | 0.48 | 0.28 | Comp. |
| 1-6 | (70/21/9) | 70 | 10 | 5 | 5 | 4280 | 25 | 50 | 0.4 | 0.26 | Inv. |
| 1-7 | (85/11/4) | 85 | 10 | 5 | 5 | 4280 | 25 | 50 | 0.36 | 0.23 | Inv. |
| 1-8 | (92/6/2) | 92 | 10 | 5 | 5 | 4280 | 25 | 50 | 0.35 | 0.22 | Inv. |
| 2-1 | (65/25/10) | 65 | 10 | 6 | 20 | 1070 | 25 | 50 | 0.65 | 0.51 | Comp. |
| 2-2 | (70/21/9) | 70 | 10 | 6 | 20 | 1070 | 25 | 50 | 0.61 | 0.42 | Comp. |
| 2-3 | (85/11/4) | 85 | 10 | 6 | 20 | 1070 | 25 | 50 | 0.61 | 0.4 | Comp. |
| 2-4 | (92/6/2) | 92 | 10 | 6 | 20 | 1070 | 25 | 50 | 0.6 | 0.4 | Comp. |
| 2-5 | (65/25/10) | 65 | 10 | 5 | 5 | 4280 | 25 | 50 | 0.5 | 0.29 | Comp. |
| 2-6 | (70/21/9) | 70 | 10 | 5 | 5 | 4280 | 25 | 50 | 0.42 | 0.27 | Inv. |
| 2-7 | (85/11/4) | 85 | 10 | 5 | 5 | 4280 | 25 | 50 | 0.38 | 0.25 | Inv. |
| 2-8 | (92/6/2) | 92 | 10 | 5 | 5 | 4280 | 25 | 50 | 0.38 | 0.25 | Inv. |
| 2-9 | (85/11/4) | 85 | 10 | 3 | 3 | 7120 | 25 | 50 | 0.35 | 0.22 | Inv. |
| 2-10 | (85/11/4) | 85 | 10 | 3 | 3 | 7120 | 10 | 50 | 0.31 | 0.2 | Inv. |
| 2-11 | (85/11/4) | 85 | 10 | 3 | 3 | 7120 | 50 | 50 | 0.4 | 0.26 | Inv. |
| 2-12 | (85/11/4) | 85 | 10 | 3 | 3 | 7120 | 60 | 50 | 0.48 | 0.3 | Inv. |
| 2-13 | (85/11/4) | 85 | 10 | 3 | 3 | 6410 | 10 | 50 | 0.42 | 0.28 | Inv. |
| 2-14 | (85/11/4) | 85 | 10 | 3 | 3 | 6060 | 10 | 50 | 0.55 | 0.35 | Comp. |
| 2-15 | (85/11/4) | 85 | 10 | 3 | 3 | 7830 | 10 | 50 | 0.43 | 0.28 | Inv. |
| 2-16 | (85/11/4) | 85 | 10 | 3 | 3 | 8190 | 10 | 50 | 0.58 | 0.38 | Comp. |

*1: molar ratio of aliphatic carboxylic acids (behenic acid/arachidic acid/stearic acid)
*2: silver behenate (mol %)
*3: aqueous solution of aliphatic carboxylic acid metal salt (wt %)
*4: average sphere equivalent diameter (μm)
*5: standard deviation (μm)

Preparation of Preliminary Dispersion

In 1457 g of methyl ethyl ketone (hereinafter referred to as MEK) was dissolved 14.57 g of polyvinyl butyral BL-SHP (produced by Sekisui Kagaku Kogyo Co., Ltd.). While stirring by dissolver DISPERMAT Type CA-40M (manufactured by VMA-Getzmann Co.), 500 g of the foregoing powdery aliphatic carboxylic acid silver salt was gradually added and sufficiently mixed, and a preliminary dispersion was prepared.

Preparation of Light-Sensitive Dispersion

The prepared preliminary dispersion was charged into a media type homogenizer DISPERMAT Type SL-C12EX (manufactured by VMA-Getzmann Co.), filled with 0.5 mm diameter zirconia beads (Toreselam, produced by Toray Co.) so as to occupy 80 percent of the interior volume so that the retention time in the mill reached 1.5 minutes and was dispersed at a peripheral rate of the mill of 8 m/second and a temperature of 25° C. to obtain a light-sensitive emulsion dispersed solution.

Synthesis of Polymer A, B and C

Into a 0.5 liter separable four-necked flask fitted with an addition device, a thermometer, a nitrogen gas introducing tube and a stirring device were added 50 g of methyl ethyl ketone, monomers except for NIPAM at aounts shown in Table 2 (expressed in “g”) and 0.12 g of lauryl peroxide and heated at a temperature shown in Table 2. Further, NIPAM monomer at an amount shown in Table 2 (expressed in “g”) was dissolved in 43 g of methyl ethyl ketone and the obtained solution was dropwise added into the flask in 2 hr. Then, the reaction mixture was heated in 1 hr. and when reached a refluxing state, 0.17 g of lauryl peroxide dissolved in 33 g of methyl ethyl ketone was dropwise added into the flask in 2 hr. and reacted further for 3 hrs. at the same temperature. Thereafter, 0.33 g of methylhydroquinone dissolved in 107 g of methyl ethyl ketone was added and cooled to obtain polymer A, B or C solution each having a polymer content of 30% by weight. The molecular weigh was determined and represented by a weight-average molecular weight, equivalent converted to polystyrene.

TABLE 2

| | Polymer A | Polymer B | Polymer C |
|---|---|---|---|
| Monomer | g | g | g |
| DAAM*¹ | 45 | 45 | 55 |
| PSE-400*² | 20 | 20 | 20 |
| PME-400*³ | 20 | 20 | 20 |
| NIPAM*⁴ | 15 | 15 | 5 |
| Temp. | 80° C. | 60° C. | 60° C. |
| M.W. | 50,000-70,000 | 80,000-100,000 | 80,000-100,000 |

*¹diacetone acrylamide (Kyowa Hakko Co., Ltd)
*²methacrylate monomer containing —(EO)ₘ—C₁₈H₃₇ (m = ca. 9, Nippon Yushi Co., Ltd.)
*³methacrylate monomer containing —(EO)ₘ—CH₃ (m = ca. 9, Nippon Yushi Co., Ltd.)
*⁴N-isopropylacrylamide monomer

Polymer-Dispersed Silver Halide Emulsion

33 g of the foregoing polymer A solution was made up to 121 g with methanol and stirred for 30 min at 45° C. Further thereto, the silver halide emulsion (59.2 g) kept at 45° C. was added over a period of 20 min. and stirred for 30 min. Then, the mixture was cooled to 32° C. in 30 min. and 600 g of methyl ethyl ketone was dropwise added over a period of 30 min to obtain polymer-dispersed silver halide emulsion A. Similarly, polymer-dispersed silver halide emulsion B was prepared, except that polymer A solution was replaced by polymer B solution. Similarly, polymer-dispersed silver halide emulsion C was prepared, except that polymer A solution was replaced by polymer C solution.

Preparation of Stabilizer Solution

Stabilizer solution was prepared by dissolving 1.0 g of stabilizer 1 and 0.31 g of potassium acetate in 17.79 g of methanol.

Preparation of Infrared Sensitizing Dye A Solution

Infrared sensitizing dye A solution was prepared by dissolving 30 mg of infrared sensitizing dye 1, 40 mg of infrared sensitizing dye 2, 2.5 g of 2-chloro-benzoic acid, 21.5 g of stabilizer 2, and 130 mg of 5-methyl-2-mercaptobenzimidazole in 140 g of MEK in a dark room.

Preparation of Additive Solution a

Additive solution a was prepared by dissolving 27.98 g of reducing agent A, 2.28 g of 4-methylphthalic acid, 111 mg of infrared dye A. 365 mg of leuco dye YA-10 and 4.83 g of polyvinyl acetal (BL-5Z, produced by Sekisui Kagaku Kogyo Co., Ltd.) in 172 g of MEK.

Preparation of Additive Solution b

Additive solution b was prepared by dissolving 3.31 g of antifoggant 2 in 46.9 g of MEK.

Preparation of Additive Solution c

Additive solution c was prepared by dissolving 3.34 g of phthalazine in 23.0 g of MEK.

Preparation of Light-Sensitive Layer Coating Composition

While stirring, 50 g of the foregoing light-sensitive dispersion and 8.80 g of MEK were mixed and the resultant mixture was maintained at 18° C., then, 23.4 g of polymer-dispersed silver halide emulsion shown in Table 3 was added and stirred for 30 min. After stirred for 30 min., 0.44 g of antifoggant 1 (11% methanol solution) was added thereto and stirred for 1 hr. Further, 0.66 g of calcium bromide (11% methanol solution) was added and stirred for 20 minutes. Subsequently, 0.62 g of the foregoing stabilizer solution was added and stirred for 10 minutes and then, 4.93 g of the foregoing infrared sensitizing dye A solution was added and stirred for 1 hr. Thereafter, the resulting mixture was cooled to 13° C. and stirred for 30 min. While maintaining at 13° C., 12.5 g of polyvinyl acetal (BL-5-Z, produced by Sekisui Kagaku Kogyo Co., Ltd.) was added and stirred for 30 min. Then, 1.26 g of tetrachlorophthalic acid (3.7% MEK solution) was added and stirred for 30 minutes. Further, while stirring, 24.8 g of additive solution a, 2.26 g of Desmodur N3300 (aliphatic isocyanate, manufactured by Mobay Chemical Co. 23.3 wt % MEK solution), 5.03 g of additive solution b and 2.63 g of additive solution c were successively added to obtain light-sensitive layer coating composition. 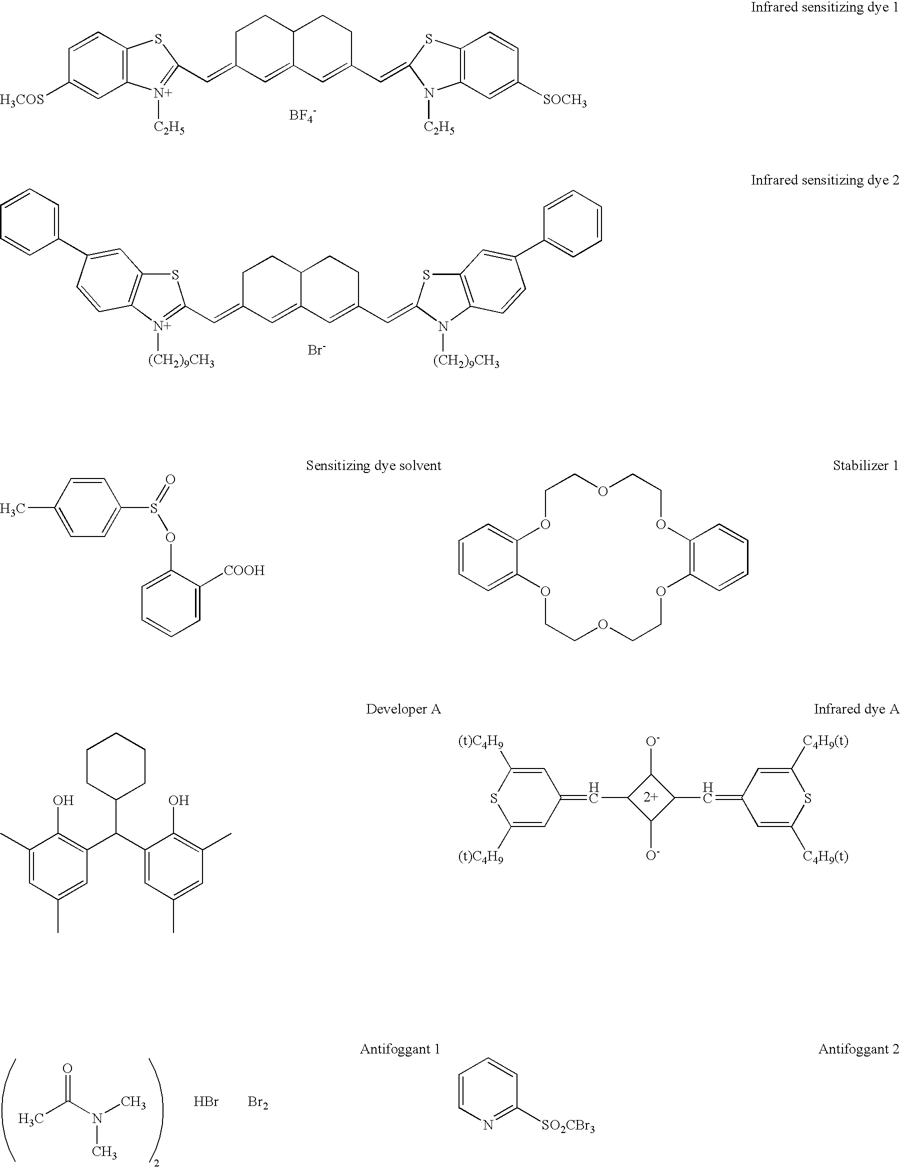 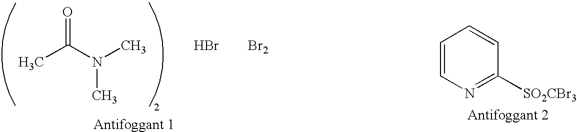
Surface Protective Layer

Similarly to the foregoing the light-sensitive layer coating solution, a coating solution of the following composition was prepared and coated on the light-sensitive layer at a coating amount (per m²), as shown below and dried to form a protective layer for the light-sensitive layer:

| | | |
|---|---|---|
| Cellulose acetate Propionate | 1.15 | g |
| (CAP-141-20, Eastman Chemical Co.) | | |
| Polymethyl methacrylate | 45 | mg |
| (Paraloid, Rohm & Haas Co.) | | |
| Silica matting agent (SYLYSIA 320 | 25 | mg |
| Fuji Sylisia Co.) | | |
| 1,3-bis(vinylsulfonyl)-2-propanol | 20 | mg |
| benzotriazole | 15 | mg |
| C₉F₁₇O(CH₂CH₂O)₂₃C₉F₁₇ | 42 | mg |
| LiO₃S—CF₂CF₂CF₂—SO₃Li | 1 | mg |

Back Layer

A coating solution of the following composition was prepared and coated on the opposite side to the light-sensitive layer at a coating amount (per m²), as shown below and dried to form a back layer:

| | | |
|---|---|---|
| Cellulose acetate Propionate | 1.85 | g |
| (CAP-482-20, Eastman Chemical Co.) | | |
| Polyester (Vitel 2200B, BOSTIC | 95 | mg |
| FINDLET Co.) | | |
| Silica matting agent (SYLYSIA 450 | 15 | mg |
| Fuji Sylisia Co.) | | |
| Ethylene bisstearic acid amide | 60 | mg |
| Infrared dye A | 3.5 | mg |
| C₉F₁₇O(CH₂CH₂O)₂₃C₉F₁₇ | 100 | mg |
| LiO₃S—CF₂CF₂CF₂—SO₃Li | 18 | mg |

Preparation of Photothermographic Material

The coating solution of a light-sensitive layer at a total silver coverage shown in Table 3 and the coating solution of a surface protective layer at a coating amount as above were simultaneously coated on the light-sensitive layer-side sublayer of the support, using a conventional extrusion type coater. Subsequently, the coating solution of a back layer was coated on the opposite side of the support. Then, the coat was dried for 10 min. using drying air at a drying temperature of 75° C. and a dew point temperature of 10° C. to prepare a photothermographic material sample.

Using an aliphatic carboxylic acid silver salt of the light-sensitive layer coating solution shown in Table 3, photothermographic material samples were further prepared.

Exposure and Processing

The thus prepared samples 1 to 44 were each cut to a size of 34.5 cm×43.0 cm, packed with packaging material in an atmosphere 25° C. and 50% R.H. to prepare two bags for each sample. After allowed to stand at ordinary temperature for 2 weeks. One bag was allowed to stand at 5° C. for 4 weeks and the other bag was allowed to stand at 50° C. for 4 weeks. Thereafter, the samples were evaluated as follows.

Packaging Material

There were used a paper tray and a barrier bag composed of 10 μm polyethylene/12 μm PE/9 μm aluminum foil/15 μm nylon/50 μm polyethylene containing 3% carbon and exhibiting an oxygen permeability of 0 ml/atm·m²·25° C.·day and a moisture permeability of 0 g/m²·40° C.-90%RH·day.

Evaluation of Sample

Samples were each exposed and thermally developed using a laser imager, as shown in FIG. 1 (installed with a 810 nm semiconductor laser exhibiting a maximum output of 50 mW and having a setting area of 0.35 m²). Samples were concurrently exposed and developed, in which sections 51, 52 and 53 corresponding to “51”, “52” and “53” designated in FIG. 1 were each adjusted to a temperature, as shown in Table 3 and in contact with the samples for 2 sec, 2 sec and 6 sec, respectively, (10 sec, in total). Herein, the expression, being concurrently exposed and developed means that, in one sheet of a photothermographic material, while one portion is exposed, another portion after having being exposed, is developed at the same time. In other words, exposure and thermal development are concurrently performed in the photographic material. The distance between the exposure section and the development section was 12 cm and the line speed was 30 mm/sec., in which the transport speed of from the photothermographic material-supplying section to the image exposure section, that at the image exposure section and that at the thermal development section were each 30 mm/sec. The position of a stock tray for photothermographic material from the bottom was 45 cm in height from the floor surface. Exposure was conducted in a room conditioned at 23° C. and 50% RH. Exposure was stepwise performed with decreasing exposure energy by 0.05 in logE. Sensitivity, fog density and maximum density

The images obtained as above were subjected to densitometry and characteristic curves were prepared in which the abscissa shows the exposure amount and the ordinate shows the density. Utilizing the resulting characteristic curve, sensitivity (also denoted simply as “S”) was defined as the reciprocal of an exposure amount necessary to give a density higher than the unexpected area by 1.0 (i.e., the density of 1.0 plus the density of the unexposed area). The density of an unexposed area (i.e., minimum density or fog density, also denoted simply as “Fog”) and the maximum density (also denoted as “Dmax”) were also determined. The sensitivity and maximum density were each represented by a relative value, based on the sensitivity and the maximum density of sample 1 each being 100.

TABLE 3

| | | | Silver | Temperature | | | | | | | | | |
|---|---|---|---|---|---|---|---|---|---|---|---|---|---|
| | | | Coverage | (° C.) | | | *3 | | | *4 | | | |
| No. | *1 | *2 | (g/m²) | 51*⁵ | 52*⁶ | 53*⁷ | Fog | Dmax | S | Fog | Dmax | Dmax | Remark |
| 1 | 1-1 | A | 1.2 | — | 123 | 123 | 0.21 | 100 | 100 | 0.31 | 89 | 73 | Comp. |
| 2 | 1-1 | A | 1.2 | 100 | 123 | 123 | 0.21 | 100 | 102 | 0.45 | 91 | 87 | Comp. |
| 3 | 1-2 | A | 1.2 | 100 | 123 | 123 | 0.2 | 98 | 91 | 0.29 | 85 | 61 | Comp. |
| 4 | 1-3 | A | 1.2 | 100 | 123 | 123 | 0.18 | 94 | 88 | 0.25 | 79 | 55 | Comp. |
| 5 | 1-4 | A | 1.2 | 100 | 123 | 123 | 0.17 | 90 | 83 | 0.23 | 71 | 44 | Comp. |
| 6 | 1-5 | A | 1.2 | — | 123 | 123 | 0.2 | 103 | 109 | 0.31 | 93 | 84 | Comp. |
| 7 | 1-5 | A | 1.2 | 100 | 123 | 123 | 0.2 | 104 | 111 | 0.44 | 96 | 99 | Comp. |
| 8 | 1-6 | A | 1.2 | — | 123 | 123 | 0.18 | 107 | 123 | 0.25 | 97 | 96 | Comp. |
| 9 | 1-6 | A | 1.2 | 100 | 123 | 123 | 0.19 | 107 | 125 | 0.25 | 101 | 118 | Inv. |
| 10 | 1-7 | A | 1.2 | — | 123 | 123 | 0.18 | 105 | 119 | 0.24 | 91 | 89 | Comp. |
| 11 | 1-7 | A | 1.2 | 65 | 123 | 123 | 0.18 | 105 | 119 | 0.24 | 92 | 90 | Comp. |
| 12 | 1-7 | A | 1.2 | 70 | 123 | 123 | 0.18 | 105 | 119 | 0.24 | 98 | 112 | Inv. |
| 13 | 1-7 | A | 1.2 | 85 | 123 | 123 | 0.18 | 105 | 120 | 0.24 | 99 | 114 | Inv. |
| 14 | 1-7 | A | 1.2 | 100 | 123 | 123 | 0.18 | 105 | 122 | 0.24 | 101 | 117 | Inv. |
| 15 | 1-7 | A | 1.2 | 110 | 123 | 123 | 0.21 | 104 | 125 | 0.32 | 100 | 116 | Comp. |
| 16 | 1-8 | A | 1.2 | — | 123 | 123 | 0.17 | 101 | 115 | 0.22 | 83 | 79 | Comp. |
| 17 | 1-8 | A | 1.2 | 100 | 123 | 123 | 0.17 | 101 | 117 | 0.22 | 97 | 110 | Inv. |
| 18 | 2-1 | A | 1.2 | — | 123 | 123 | 0.2 | 99 | 98 | 0.3 | 87 | 71 | Comp. |
| 19 | 2-1 | A | 1.2 | 100 | 123 | 123 | 0.2 | 99 | 100 | 0.43 | 91 | 87 | Comp. |
| 20 | 2-2 | A | 1.2 | 100 | 123 | 123 | 0.2 | 98 | 91 | 0.28 | 82 | 58 | Comp. |
| 21 | 2-3 | A | 1.2 | 100 | 123 | 123 | 0.18 | 94 | 87 | 0.24 | 76 | 50 | Comp. |
| 22 | 2-4 | A | 1.2 | 100 | 123 | 123 | 0.17 | 89 | 83 | 0.23 | 68 | 38 | Comp. |
| 23 | 2-5 | A | 1.2 | — | 123 | 123 | 0.2 | 103 | 109 | 0.3 | 91 | 82 | Comp. |
| 24 | 2-5 | A | 1.2 | 100 | 123 | 123 | 0.2 | 104 | 110 | 0.42 | 94 | 97 | Comp. |
| 25 | 2-6 | A | 1.2 | — | 123 | 123 | 0.18 | 105 | 121 | 0.24 | 93 | 93 | Comp. |
| 26 | 2-6 | A | 1.2 | 100 | 123 | 123 | 0.18 | 106 | 123 | 0.24 | 101 | 116 | Inv. |
| 27 | 2-7 | A | 1.2 | — | 123 | 123 | 0.17 | 105 | 118 | 0.23 | 89 | 87 | Comp. |
| 28 | 2-7 | A | 1.2 | 100 | 123 | 123 | 0.17 | 105 | 120 | 0.23 | 102 | 116 | Inv. |
| 29 | 2-7 | B | 1.2 | 100 | 123 | 123 | 0.17 | 105 | 118 | 0.23 | 102 | 115 | Inv. |
| 30 | 2-7 | C | 1.2 | 100 | 123 | 123 | 0.17 | 106 | 124 | 0.23 | 103 | 117 | Inv. |
| 31 | 2-8 | A | 1.2 | — | 123 | 123 | 0.17 | 100 | 113 | 0.21 | 80 | 76 | Comp. |
| 32 | 2-8 | A | 1.2 | 100 | 123 | 123 | 0.17 | 100 | 115 | 0.21 | 96 | 109 | Inv. |
| 33 | 2-9 | A | 1.2 | 100 | 123 | 123 | 0.17 | 104 | 115 | 0.22 | 102 | 112 | Inv. |
| 34 | 2-9 | B | 1.2 | 100 | 123 | 123 | 0.17 | 104 | 114 | 0.22 | 102 | 111 | Inv. |
| 35 | 2-9 | C | 1.2 | 100 | 123 | 123 | 0.17 | 105 | 116 | 0.22 | 103 | 112 | Inv. |
| 36 | 2-10 | A | 1.2 | 100 | 123 | 123 | 0.17 | 103 | 112 | 0.22 | 102 | 110 | Inv. |
| 37 | 2-10 | B | 1.2 | 100 | 123 | 123 | 0.17 | 103 | 110 | 0.21 | 102 | 108 | Inv. |
| 38 | 2-10 | C | 1.2 | 100 | 123 | 123 | 0.17 | 104 | 115 | 0.22 | 103 | 113 | Inv. |
| 39 | 2-11 | A | 1.2 | 100 | 123 | 123 | 0.18 | 104 | 114 | 0.23 | 100 | 109 | Inv. |
| 40 | 2-12 | A | 1.2 | 100 | 123 | 123 | 0.2 | 107 | 119 | 0.27 | 102 | 112 | Inv. |
| 41 | 2-13 | A | 1.2 | 100 | 123 | 123 | 0.21 | 107 | 118 | 0.27 | 101 | 112 | Inv. |
| 42 | 2-14 | A | 1.2 | 100 | 123 | 123 | 0.25 | 112 | 122 | 0.53 | 117 | 102 | Comp. |
| 43 | 2-15 | A | 1.2 | 100 | 123 | 123 | 0.2 | 106 | 116 | 0.26 | 100 | 108 | Inv. |
| 44 | 2-16 | A | 1.2 | 100 | 123 | 123 | 0.24 | 109 | 119 | 0.42 | 104 | 102 | Comp. |

*1: aliphatic carboxylic acid silver salt particles
*2: polymer-dispersed silver halide emulsion
*3: aging at room temperature for 2 weeks and 5° C. for 4 weeks
*4: aging at room temperature for 2 weeks and 50° C. for 4 weeks
*⁵first heating zone 51 (preheating zone) shown in FIG. 1
*⁶second heating zone 52 shown in FIG. 1
*⁷temperature-retaining section 53 shown in FIG. 1

As apparent from Table 3, it was proved that samples according to the invention exhibited enhanced sensitivity, and maximum density and minimized fogging even when subjected to accelerated aging.

### Example 2

Similarly to Example 1, photothermographic material samples were evaluated, provided that the laser imager was modified so that the former portion of the cooling section 54 (shown in FIG. 1) was controlled to a temperature, as shown in Table 4 within a film-contact time of 3 sec. Results thereof are shown in Table 4. The sensitivity and the maximum density were each represented by a relative value, based on the sensitivity and maximum density each being 100.

TABLE 4

| | | | Silver | Temperature | | | | | | | | | | |
|---|---|---|---|---|---|---|---|---|---|---|---|---|---|---|
| | | | Coverage | (° C.) | | | | *3 | | | *4 | | | |
| No. | *1 | *2 | (g/m²) | 51*⁵ | 52*⁶ | 53*⁷ | 54*⁸ | Fog | Dmax | S | Fog | Dmax | S | Remark |
| 1 | 1-1 | A | 1.2 | — | 123 | 123 | — | 0.21 | 100 | 100 | 0.31 | 89 | 73 | Comp. |
| 2 | 1-1 | A | 1.2 | — | 123 | 123 | 108 | 0.22 | 100 | 104 | 0.49 | 92 | 91 | Comp. |
| 3 | 1-2 | A | 1.2 | — | 123 | 123 | 108 | 0.21 | 99 | 93 | 0.35 | 87 | 66 | Comp. |
| 4 | 1-3 | A | 1.2 | — | 123 | 123 | 108 | 0.19 | 96 | 91 | 0.3 | 82 | 61 | Comp. |
| 5 | 1-4 | A | 1.2 | — | 123 | 123 | 108 | 0.19 | 93 | 88 | 0.27 | 75 | 53 | Comp. |
| 6 | 1-5 | A | 1.2 | — | 123 | 123 | — | 0.2 | 103 | 109 | 0.31 | 93 | 84 | Comp. |
| 7 | 1-5 | A | 1.2 | — | 123 | 123 | 108 | 0.21 | 105 | 113 | 0.47 | 100 | 102 | Comp. |
| 8 | 1-6 | A | 1.2 | — | 123 | 123 | — | 0.18 | 107 | 123 | 0.25 | 97 | 96 | Comp. |
| 9 | 1-6 | A | 1.2 | — | 123 | 123 | 108 | 0.19 | 107 | 128 | 0.26 | 102 | 122 | Inv. |
| 10 | 1-7 | A | 1.2 | — | 123 | 123 | — | 0.18 | 105 | 119 | 0.24 | 91 | 89 | Comp. |
| 11 | 1-7 | A | 1.2 | — | 123 | 123 | 100 | 0.18 | 105 | 119 | 0.24 | 92 | 91 | Comp. |
| 12 | 1-7 | A | 1.2 | — | 123 | 123 | 103 | 0.18 | 105 | 119 | 0.24 | 99 | 113 | Inv. |
| 13 | 1-7 | A | 1.2 | — | 123 | 123 | 108 | 0.19 | 105 | 121 | 0.24 | 100 | 115 | Inv. |
| 14 | 1-7 | A | 1.2 | — | 123 | 123 | 113 | 0.19 | 105 | 124 | 0.25 | 102 | 119 | Inv. |
| 15 | 1-7 | A | 1.2 | — | 123 | 123 | 115 | 0.21 | 104 | 126 | 0.36 | 100 | 116 | Comp. |
| 16 | 1-8 | A | 1.2 | — | 123 | 123 | — | 0.17 | 101 | 115 | 0.22 | 83 | 79 | Comp. |
| 17 | 1-8 | A | 1.2 | — | 123 | 123 | 108 | 0.18 | 101 | 118 | 0.22 | 97 | 111 | Inv. |
| 18 | 2-1 | A | 1.2 | — | 123 | 123 | — | 0.2 | 99 | 98 | 0.3 | 87 | 71 | Comp. |
| 19 | 2-1 | A | 1.2 | — | 123 | 123 | 108 | 0.2 | 99 | 101 | 0.46 | 92 | 89 | Comp. |
| 20 | 2-2 | A | 1.2 | — | 123 | 123 | 108 | 0.2 | 98 | 93 | 0.29 | 83 | 61 | Comp. |
| 21 | 2-3 | A | 1.2 | — | 123 | 123 | 108 | 0.19 | 95 | 89 | 0.26 | 78 | 55 | Comp. |
| 22 | 2-4 | A | 1.2 | — | 123 | 123 | 108 | 0.18 | 90 | 86 | 0.25 | 71 | 44 | Comp. |
| 23 | 2-5 | A | 1.2 | — | 123 | 123 | — | 0.2 | 103 | 109 | 0.3 | 91 | 82 | Comp. |
| 24 | 2-5 | A | 1.2 | — | 123 | 123 | 108 | 0.21 | 104 | 112 | 0.46 | 95 | 101 | Comp. |
| 25 | 2-6 | A | 1.2 | — | 123 | 123 | — | 0.18 | 105 | 121 | 0.24 | 93 | 93 | Comp. |
| 26 | 2-6 | A | 1.2 | — | 123 | 123 | 108 | 0.19 | 106 | 125 | 0.25 | 102 | 119 | Inv. |
| 27 | 2-7 | A | 1.2 | — | 123 | 123 | — | 0.17 | 105 | 118 | 0.23 | 89 | 87 | Comp. |
| 28 | 2-7 | A | 1.2 | — | 123 | 123 | 108 | 0.18 | 105 | 121 | 0.24 | 102 | 117 | Inv. |
| 29 | 2-7 | B | 1.2 | — | 123 | 123 | 108 | 0.18 | 105 | 120 | 0.25 | 102 | 116 | Inv. |
| 30 | 2-7 | C | 1.2 | — | 123 | 123 | 108 | 0.17 | 105 | 126 | 0.25 | 102 | 119 | Inv. |
| 31 | 2-8 | A | 1.2 | — | 123 | 123 | — | 0.17 | 100 | 113 | 0.21 | 80 | 76 | Comp. |
| 32 | 2-8 | A | 1.2 | — | 123 | 123 | 108 | 0.18 | 100 | 116 | 0.22 | 96 | 110 | Inv. |
| 33 | 2-9 | A | 1.2 | — | 123 | 123 | 108 | 0.18 | 105 | 116 | 0.22 | 103 | 113 | Inv. |
| 34 | 2-9 | B | 1.2 | — | 123 | 123 | 108 | 0.18 | 104 | 114 | 0.22 | 102 | 111 | Inv. |
| 35 | 2-9 | C | 1.2 | — | 123 | 123 | 108 | 0.18 | 107 | 118 | 0.22 | 105 | 114 | Inv. |
| 36 | 2-10 | A | 1.2 | — | 123 | 123 | 108 | 0.18 | 104 | 114 | 0.21 | 102 | 113 | Inv. |
| 37 | 2-10 | B | 1.2 | — | 123 | 123 | 108 | 0.18 | 104 | 112 | 0.21 | 102 | 110 | Inv. |
| 38 | 2-10 | C | 1.2 | — | 123 | 123 | 108 | 0.18 | 104 | 118 | 0.22 | 103 | 117 | Inv. |
| 39 | 2-11 | A | 1.2 | — | 123 | 123 | 108 | 0.18 | 104 | 116 | 0.23 | 101 | 112 | Inv. |
| 40 | 2-12 | A | 1.2 | — | 123 | 123 | 108 | 0.2 | 108 | 122 | 0.28 | 104 | 117 | Inv. |
| 41 | 2-13 | A | 1.2 | — | 123 | 123 | 108 | 0.21 | 109 | 123 | 0.28 | 103 | 117 | Inv. |
| 42 | 2-14 | A | 1.2 | — | 123 | 123 | 108 | 0.27 | 113 | 128 | 0.61 | 119 | 109 | Comp. |
| 43 | 2-15 | A | 1.2 | — | 123 | 123 | 108 | 0.2 | 108 | 120 | 0.27 | 102 | 112 | Inv. |
| 44 | 2-16 | A | 1.2 | — | 123 | 123 | 108 | 0.25 | 110 | 124 | 0.47 | 106 | 109 | Comp. |

*1: aliphatic carboxylic acid silver salt particles
*2: polymer-dispersed silver halide emulsion
*3: aging at room temperature for 2 weeks and 5° C. for 4 weeks
*4: aging at room temperature for 2 weeks and 50° C. for 4 weeks
*⁵first heating zone 51 (preheating zone) shown in FIG. 1
*⁶second heating zone 52 shown in FIG. 1
*⁷temperature-retaining section 53 shown in FIG. 1
*⁸cooling section (slow-cooling zone) 54 shown in FIG. 1

As shown in Table 4, it was proved that the invention maintained enhanced sensitivity and maximum density without fogging, even when allowed to stand under accelerated aging conditions, compared to the comparison.

What is claimed is:

1. A method of processing a photothermographic material comprising light-insensitive aliphatic carboxylic acid silver salt particles, light-sensitive silver halide grains, a reducing agent for silver ions and a binder, the method comprising the steps of:
(a) exposing the photothermographic material, and
(b) developing the exposed photothermographic material at a development temperature of at 110 to 150° C. to form an image,
wherein the aliphatic carboxylic acid silver salt particles are comprised of 70 to 99 mol % of silver behenate and exhibit an average sphere equivalent diameter of 0.05 to 0.5 μm and a standard deviation of particle size of 0.3 μm or less, and the method further comprising
(c) heating the photothermographic material at a temperature lower than the development temperature.

2. The method of claim 1, wherein the method comprises the steps of:
(a) exposing the photothermographic material,
(b) developing the exposed photothermographic material at a development temperature of at 110 to 150° C. or more to form an image, and
(c1) heating the exposed photothermographic material at a temperature of 70 to 100° C. immediately before step (b).

3. The method of claim 2, wherein in step (b), the exposed photothermographic material is developed over a development time of 5 to 10 sec.

4. The method of claim 2, wherein in step (c1), the exposed photothermographic material is heat over a period of 0.5 to 7 sec.

5. The method of claim 2, wherein the photothermographic material is processed using a processing machine comprising a preheating zone to heat the photothermographic material at a temperature of 70 to 100° C. immediately before developing the exposed photothermographic material.

6. The method of claim 2, wherein the photothermographic material is processed using a processing machine comprising a heat-retaining zone to maintain the development temperature to develop the photothermographic material.

7. The method of claim 1, wherein the method comprises the steps of:
(a) exposing the photothermographic material,
(b) developing the exposed photothermographic material at a development temperature of at 110 to 150° C. or more to form an image, and
(c2) heating the developed photothermographic material at a temperature lower than the development temperature by 10 to 20° C. immediately after step (b).

8. The method of claim 7, wherein in step (b), the exposed photothermographic material is developed over a development time of 5 to 10 sec.

9. The method of claim 8, wherein in step (c2), the developed photothermographic material is kept over a period of at least 0.25 times the development time.

10. The method of claim 7, wherein the photothermographic material is processed using a processing machine comprising a slow-cooling zone to keep the developed photothermographic material at a temperature lower than the development temperature by 10 to 20° C. immediately after developing the exposed photothermographic material.

11. The method of claim 7, wherein the photothermographic material is processed using a processing machine comprising a heat-retaining zone to maintain the development temperature to develop the photothermographic material.

12. The method of claim 1, wherein a total silver amount of the aliphatic carboxylic acid silver salt particles and the silver halide grains is 0.8 to 1.5 g/m².
